(19) United States
(12) Patent Application Publication
(10) Pub. No.: US 2004/0207836 A1
(43) Pub. Date: Oct. 21, 2004

(54) High dynamic range optical inspection system and method

(76) Inventors: Rajeshwar Chhibber, San Jose, CA (US); David Willenborg, Pleasanton, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/672,056

(22) Filed: Sep. 25, 2003

Related U.S. Application Data
(60) Provisional application No. 60/414,511, filed on Dec. 27, 2002.

(51) Int. Cl. G01N 21/00

(52) U.S. Cl. 356/237.4

(57) ABSTRACT

A high dynamic range and high precision broadband optical inspection system and method are provided. The system provides capability of optical inspection of patterned and unpatterned substrates in which a very large dynamic range with very high precision is desirable to provide detection of light scattering defects from sub micron to hundreds of microns in size. The system permits high throughput substrate inspection in which the sides, bevels and edges of the substrate may be rapidly or simultaneously inspected for defects.

### PRIORITY CLAIM/RELATED APPLICATIONS

This application claims priority, under 35 USC §§ 119(e) and 120, from U.S. Provisional Patent Application Serial No. 60/414,511, filed on Sep. 27, 2002 and entitled “Optical Inspection System and Method” which is owned by the same assignee as the present application and is incorporated herein by reference.

### FIELD OF THE INVENTION

This invention relates generally to an optical inspection system and method and in particular to a system and method for simultaneously optically inspecting both sides of a substrate with high dynamic range and high precision.

### BACKGROUND OF THE INVENTION

One application of a high dynamic range optical inspection system is for inspecting semiconductor wafer substrates. Semiconductor line widths are continually shrinking with leading edge manufacturing currently at 0.13 um and will soon be below 0.10 um. As these geometries shrink, semiconductor wafer yield loss increases due to pattern defects. Pattern defects can be classified as pattern mis-registration, extra features and missing features in patterns. Pattern defects of 0.1 um and above, can be detected by known optical imaging methods. Smaller pattern defects can be detected using slower, more expensive, more complex electron beam imaging systems, but where possible, optical systems are preferred. Both optical and electron imaging techniques require image comparison of “good, known” patterns with patterns being evaluated. This comparison process is very sophisticated and is capable of detecting very small defects, but is very slow. Laser scanning systems are faster and can detect light scattering defects down to 0.035 um on bare wafers, but laser scanning is not as sensitive for patterned wafers. Laser scanning is sensitive to light scatter and can detect a sub-set of defects such as particulates, scratches, bumps, pits, and very limited types of pattern defects. The smallest defects (below 0.1 um) are only detectable on smooth surfaces such as bare wafers and wafers with blanket films and at very slow scan speeds to provide sufficient signal to noise. Defects can also be quite large (tens of microns to a sizeable portion of the wafer) and laser scanning systems in general cannot readily detect these large defects. Optical imaging systems, optimized to detect the smallest pattern defects, are not effective at detecting large defects. Large area defects are best detected by optical imaging systems optimized for larger defects that are incapable of detecting the smallest defects. The semiconductor industry has settled on an arbitrary but useful distinction between Macro greater than 50 um) and Micro (smaller than 50 um) defects. Thus, inspection systems generally fall into two distinct categories—either Macro or Micro inspection.

Visual Macro inspection has been utilized since the beginning of the semiconductor industry. An example of a Visual Macro inspection system is shown in FIG. 1 wherein a visible light source is directed towards a substrate and a particle on the surface of the substrate scatters light from the light source. The diffracted light from the particle is detected by the naked eye of a technician. Human observation of particle scatter is fast and very inexpensive, but suffers from the following limitations: 1) no ultraviolet (UV) sensitivity; 2) only large macro defects can be detected; 3) inconsistency of results due to differences in observers; 4) the results are not quantitative; 5) the results cannot be mapped and compared to each other; and 6) there is no data recording capability. IBM first demonstrated a more repeatable, recordable and less subjective approach with the use of film as a sensor in the late 1960s. FIG. 2 illustrates an example of a typical film based Macro inspection system. The IBM system consisted of a visible light source, light source collimating optics, a wafer holder with an X, Y and theta stage, an imaging lens to image the scatter defects onto the film, a beam dump for collecting the unwanted light and a simple film holder with a mechanical shutter and timer. The exposure time of the IBM system depended upon sensitivity and throughput requirements, which in turn depended on the film dynamic range. Film based systems have the following limitations: 1) non linearity due to differences in film quality; 2) the process is extremely slow; 3) the data is not “computer ready”, i.e. not digital, 4) film non-linearity makes particle size calibration difficult, and 5) the film must be reviewed by a technician. In the early 1970's, solid-state image sensors using charge-coupled device (CCD) or complementary metal on silicon (CMOS) technologies were developed providing a significant cost reduction over film with an easily digitized electronic output suitable for computer manipulation. These solid-state sensors soon replaced film.

A typical solid-state sensor Macro inspection system, shown in FIG. 3, consists of one or more light sources (a combination of dark and bright field illumination), a substrate handler (usually with X,Y theta stage), a beam dump, an imaging lens assembly and a CCD/CMOS sensor. Bright Field and Dark Field refer to the light collection angles relative to the specular reflected light. A technique is “Bright-Field” if the light collection is essentially on the same axis as the specular reflected light and “Dark-Field” if the light collection is essentially away from the axis of the reflected light. Others terms have been used to describe light collection, such as “Gray Field” and “Double Dark Field”, which describe the various angles from the specular reflected light. The Macro inspection illumination source is typically an incoherent broad-spectrum beam; however, scanned laser beams can also be used, but are more often seen in Micro inspection systems. The light sources illuminate the field of view (FOV) for the imaging optics that image onto the CCD/CMOS sensor. The imaging lens assembly may have multiple lenses thus providing multiple magnifications to the sensor with field of views ranging from the entire side of the wafer to a millimeter portion of the wafer. The wafer holder may have X, Y theta motion, especially if the imaging optics field of view is small. Partial to full wafer illumination may be done depending on the sensitivity and throughput requirements of the system. The amount of time to integrate the image depends, on the dynamic range of the sensor, which in turn determines the throughput and the size range of particle sizes that can be identified and categorized (e.g., binned) accurately. Today, Macro defect inspection systems inspect relatively large portions of the wafer (up to an entire side of the wafer) in one pass. Macro defect inspection throughput is acceptable because defect resolution is relatively coarse (greater than 50 um) so the wafer surface can be processed quickly. There are numerous companies (e.g., KLA, Leica, Rudolph, Nanometrics, Nova Instruments, August, etc.) that have developed Macro inspection systems for the semiconductor industry. Micro defects are much more difficult to detect and categorize. There are currently two types of Micro inspection: imaging and laser scanning detection.

Micro defect imaging employs very high resolution imaging optics combined with image analysis hardware and software. The image is acquired with CCD/CMOS sensors through microscope objective lenses that magnify the wafer patterns so that the field of view that the CCD/CMOS sensor images is on the order of a few tens of microns to hundreds of microns. Multiple microscope lenses are often used to vary the magnification in order to maximize throughput with respect to the size of the defect being detected. An example of a typical CCD/CMOS sensor Micro imaging inspection system is shown in FIG. 3A. Similar to the Macro inspection system, FIG. 3, the CCD sensor Micro imaging inspection system consists of a light source, a wafer holder with X, Y theta motion, a beam dump, an imaging lens assembly and a CCD/CMOS sensor. Broadband incoherent source lighting is typically used and can be normal incidence (bright field) or oblique incidence (dark field) or a combination of both. Dark field operation is provided using dark field microscope objectives. Other image contrast enhancement techniques such as phase contrast Nomarski imaging may also be used. If the illumination source has short wavelength UV light, defects on the order of tenth micron can be detected. The illumination is typically directed onto the wafer through the microscope objectives. Typically the wafer is moved to position the wafer patterns into the field of view seen by the CCD\CMOS sensor, however, the photodetector/optics could be moved instead. Because these systems must use high magnification optics, typically microscope objectives are used to resolve the small features. Microscope objectives require an auto focus mechanism to continually focus the lens at each field of view thus adding to the complexity of the system. The large reflectivity range of pattern wafers is also difficult for available CCD/CMOS detectors to image without either underexposure or partial saturation (overexposure). To inspect the wafer, Micro defect imaging inspection systems must compare and analyze up to thousands of images resulting in throughput ranging from wafers per minute to tens of minutes per wafer depending on the defect sizes. Micro defect imaging is powerful and can find virtually all types of optical defects, but is very slow, very expensive, very large and currently limited to defects with a size of a tenth of a micron or larger. There are numerous companies (e.g., KLA, AMAT, TSK, Hitachi-Deco, Negevtec, Lasertec, etc.) that have developed Micro defect imaging inspection systems for the semiconductor industry.

Laser scanning Micro defect detection has higher throughput and can detect smaller light scattering defects than Micro defect imaging on non-patterned wafers. On patterned wafers, laser scanning is not capable of detecting defects as small as Micro defect imaging, is unable to effectively detect pattern mis-registration, missing patterns, some types of extra pattern defects and large macro defects. An example of a laser scanning Micro defect inspection system is shown in FIG. 3B. These systems generally consist of a laser light source; laser beam focusing optics; photodetector collection optics; a substrate holding device; a mechanism for scanning the laser beam across the wafer surface (either a mechanical stage for wafer scanning and stationary laser beam or laser beam wafer scanning optics and stationary wafer); and photodetectors in various locations and combinations of bright and dark field, to collect scattered laser light from light scattering events. Imaging systems do not rely purely on light scatter, but also use image contrast and optical phase information to further augment defect detection. Because there is no imaging in laser scanning systems, throughput (150 wafers per hour for 200 mm diameter wafers) and sensitivity (0.05 um and below) on bare and blanket wafers are much improved over imaging techniques. Laser scanning systems detect defect scatter, they do not resolve or image the defect. Even though laser scanning systems have much higher throughput than imaging system, their throughput is still inadequate. Throughput for a 300 mm wafer is half of a 200 mm wafer because a 300 mm wafer has over 2 times the area of a 200 mm wafer, with resulting throughput less than 80 wafers per hour. Throughput drops further when detecting the smallest particles (0.1 um and below) and drops again for patterned wafers.

Laser scanning systems have other limitations and weaknesses. The laser beam is typically focused onto the wafer with spot sizes under ten microns to hundreds of microns. The smallest spots are used for the smallest defects, but at a significant throughput penalty. As the laser spot is scanned over the wafer surface, scattered light is collected by one or more photodetectors. The size and shape of the focused spot affects the amount of scatter and the actual location of the scatter site. The position, size and shape of the laser spot must all be carefully calibrated and controlled so the location and size of defects can be consistently determined. This makes laser scanning system-to-system matching problematic. The laser beam is also not scanned all the way to the wafer edge (a 1 to 3 mm edge exclusion is typical) because laser scatter from the edge introduces extraneous scatter signal although the semiconductor industry would like to scan to the wafer edges. Laser scanning systems are also limited in the range of light scattering defects sizes that can be detected in a single wafer measurement pass. As the defect sensitivity (the minimum size defect detected) is being driven down to 0.050 um and below, the requirement for large dynamic range has become difficult to address. Laser scanning systems use photo-multiplier sensors because the sensor must be both very sensitive and very high speed. The 10 um spot laser spot must be scanned very quickly to cover an entire wafer in tens of seconds, forcing the detector bandwidth to be several MHz. High speed photo-multipliers have limited dynamic range, hence a limited range of particle sizes can be detected per wafer measurement pass. Laser scanning photodetectors set for high sensitivity are set for very high gain (smaller defect sizes) and become blind (saturated) to larger defects which are equally as important as smaller defects. A laser scanning system set to a lower detection limit of 0.10 um would have a maximum detection limit of less than 1.0 um. There are numerous companies (e.g., KLA, AMAT, Hitachi-Deco, Inspex, Topcon, etc.) that have developed Micro defect laser scanning inspection systems for the semiconductor industry.

Finished wafers can have very high value. For example, a 300 mm wafer finished value can be thousands of dollars. One way to increase semiconductor fab process yield is to increase wafer inspection to detect problems as early as possible so they can be corrected quickly. Ideally, every wafer would be inspected since the loss of even a single wafer can be so costly, but this is only practical if the inspection if fast and low cost. Laser scanning and imaging inspection systems are typically large, expensive stand-alone packages. Stand-alone systems today are used to monitor the manufacturing process by wafer sampling and are kept near the process equipment so feedback from the stand-alone systems can be used to control the process. Since the wafers have to be transferred from the process tool to the stand-alone system, the time (dead time) before a problem is discovered can be tens of minutes to several hours. If a problem occurs during this dead time, the semiconductor manufacturer can lose many wafers. To reduce dead time, the semiconductor industry is driving towards integrating inspection (metrology) systems directly onto process equipment. Integrated inspection can only be practical if it is cost effective, reliable, has high throughput to keep up with the process tools and small enough to be integrated onto the process tool. Laser scanning systems are smaller, less expensive and less complex than imaging systems, but are still too large, too costly and too complex for extensive proliferation in the fabs and cannot be integrated onto the process tool. Integrated defect inspection performance needs to be nearly equal in sensitivity to standalone tools, but not necessarily have the multi-functionality that exists in the today's stand-alone tools to completely characterize a problem. In other words, integrated metrology system must detect, but not necessarily characterize a problem. Currently, integrated particle inspection products (AMAT, Nanometrics and Nano-Photonics) are either too slow, too costly or do not provide adequate detection sensitivity.

The semiconductor industry is also driving towards wafer backside and edge inspection to increase yield. For 0.10 um patterns, a 0.10 um particle on the back surface of a wafer in a critical location can cause the substrate to be unusable. Metrology manufacturers, such as KLA-Tencor, are beginning to respond to this request, but systems so far do front and backside inspection serially, i.e. first one side is measured then the wafer is flipped over and the other side is measured. This reduces throughput significantly. The throughput of a 300 mm laser scanning inspection system doing both sides of a non-patterned wafer would fall to less than 40 wafers per hour and if pre and post process inspection is performed, throughput would fall to less than 20 wafers per hour. Particles on wafer edges are also becoming a significant yield loss mechanism as these particles are often large and migrate toward the center of the wafer causing pattern defects. There are no commercial systems that inspect the wafer edge as well as the top and bottom surfaces of the wafer simultaneously. Thus, it is desirable to provide an optical inspection system that simultaneously inspects the wafer edges as well as the top and bottom surfaces of the wafer.

An integrated inspection system should also preferably detect both Macro and Micro defects. There are no commercial defect inspection systems that provide this capability with sufficient small defect sensitivity. Nanometrics has developed a system with Macro and Micro capability, but is not sensitive to particles below 0.15 um. The Nanometrics system only inspects a quadrant of the wafer at a time, requires complex wafer movement during measurement and cannot do both sides of the wafer simultaneously. Attempts have been made to develop systems using whole wafer inspection to rapidly detect light scatter on an entire side of a wafer at one time, but sensitivity to small particles has not been good enough (limited to greater than 0.3 um). These systems also did not inspect both sides of the wafer simultaneously and had limited defect size dynamic range. Inspection of a whole side of a wafer at one time is compelling. Whole wafer illumination and detection eliminates both beam and wafer motion needed to scan the wafer surface, thus reducing complexity, cost and size, improving reliability and accuracy of locating defects.

Commercially successful semiconductor industry inspection systems today all have limitations described above. These systems do not have adequate detection dynamic range, do not provided both Macro and Micro detection, do not have adequate throughput (especially for 300 mm wafers), do not provide simultaneous front and backside inspection, cannot be packaged small enough for integration onto a process tool (and meet particle sensitivity requirements), do not perform edge inspection, are complicated and expensive. Thus, it is desirable to provide a high dynamic range optical inspection system and method that overcomes the above limitations and it is to this end that the present invention is directed.

### SUMMARY OF THE INVENTION

The optical inspection system in accordance with the invention is a high dynamic range, high precision, large area, broadband, high photon flux optical inspection system and method. The optical inspection system may be used to inspect semiconductor wafers (both patterned and unpatterned), disk drive substrates, compact disk substrates and the like. The system is capable of very high throughput optical inspection of patterned and unpatterned wafers in which a very high dynamic range, very high precision photodetector is desirable to provide detection of particles from sub micron size to many hundreds of microns in size simultaneously on high contrast substrates. The system permits high throughput wafer inspection in which the top, bottom and edges of the wafer may be rapidly or simultaneously inspected for defects. The system is relatively compact, low cost and simple, thus enabling integration onto process equipment. The system may be used to optically inspect various types of substrates including an unpatterned semiconductor wafer substrate, a patterned semiconductor wafer substrate, a disk drive substrate and a compact disk substrate.

Thus in accordance with the invention, an optical inspection system is provided. The system comprises an illumination source that generates electromagnetic radiation that illuminates a first side and a second side of a substrate inserted into the optical inspection system. The system further comprises a detector that receives the illumination scattered from a light scattering feature on the first side of the substrate and detects light scattering features on the first side of the substrate and that receives the illumination scattered from a light scattering feature on the second side of the substrate and detects light scattering features on the second side of the substrate wherein light scattering features on both sides of the substrate are simultaneously detected.

In accordance with another aspect of the invention, an optical inspection method is provided. In the method, illumination is generated that illuminates a first side and a second side of a substrate inserted into the optical inspection system and a detector receives illumination scattered from a light scattering feature on the first side of the substrate and illumination scattered from a light scattering feature on the second side of the substrate. The light scattering features are detected on the first side of the substrate corresponding to, the illumination scattered from the light scattering feature on the first side of the substrate and light scattering features on the second side of the substrate corresponding to the illumination scattered from the light scattering feature on the second side of the substrate are detected wherein light scattering features on both sides of the substrate are simultaneously detected.

In accordance with yet another aspect of the invention, an optical inspection system and method are provided. The system comprises an illumination source that generates electromagnetic radiation that illuminates a first side and a second side of a substrate inserted into the optical inspection system. The system further comprises a detector that receives the illumination scattered from a light scattering feature on the first side of the substrate and detects light scattering features on the first side of the substrate and that receives the illumination scattered from a light scattering feature on the second side of the substrate and detects light scattering features on the second side of the substrate wherein light scattering features from below 0.1 micron to 100 microns are simultaneously detected.

In accordance with another aspect of the invention, an illumination Source is provided that comprises an electromagnetic energy radiation source that produces broadband electromagnetic radiation including deep ultraviolet radiation. The source further comprises a dichroic mirror that removes the infrared electromagnetic radiation from the generated electromagnetic radiation, and a parabolic light collection reflector that collects the electromagnetic radiation from the electromagnetic energy radiation source and focuses the electromagnetic energy in a particular direction.

Thus, in accordance with the invention, a digital image detector is provided. The detector comprises a plurality of pixels arranged in an array wherein each pixel detects electromagnetic radiation that impinges on that pixel. The detector further comprises each pixel having a pre-amplifier that amplifies the signal from each pixel.

Furthermore, a substrate handler is provided. The substrate handler comprises a substrate holder that holds a substrate so that a first side and a second side of a substrate are capable of being illuminated simultaneously. The substrate handler may further comprise a moving mechanism that rotates the substrate.

### BRIEF DESCRIPTION OF THE DRAWINGS

FIG. 1 is a diagram illustrating a conventional Visual Macro defect inspection process;

FIG. 2 is a diagram illustrating a conventional film detection Macro defect inspection process;

FIG. 3 is a diagram illustrating a conventional CCD/CMOS sensor Macro defect inspection process;

FIG. 3A is a diagram illustrating a conventional Micro defect imaging inspection process;

FIG. 3B is a diagram illustrating a conventional Micro defect laser scanning inspection process;

FIG. 4A is a diagram illustrating the scattering detection range of conventional laser scanning technology compared to the high dynamic range optical inspection system in accordance with the invention;

FIGS. 4B-4G illustrate detection advantages of a high dynamic range and high precision optical inspection system in accordance with the invention;

FIG. 5 is a block diagram illustrating a preferred embodiment of a broadband optical inspection system in accordance with the invention;

FIG. 5A is a block diagram illustrating an alternative preferred embodiment of a broadband optical inspection system in accordance with the invention;

FIG. 6 is a flowchart illustrating an example of an optical inspection system initialization process in accordance with the invention;

FIG. 7 is a flowchart illustrating a single substrate optical inspection process in accordance with the invention;

FIG. 8 is a diagram illustrating the dual side optical inspection method in accordance with the invention;

FIG. 9 is a diagram illustrating an example of the problems associated with a backside particle;

FIG. 10 is a diagram illustrating an example of the edge and bevel optical inspection process in accordance with the invention;

FIG. 11 is a diagram illustrating an example of ring source illumination in accordance with the invention for illuminating an edge and bevel of a substrate;

FIG. 12 is a diagram illustrating an example of dual ring source illumination in accordance with the invention for illuminating a top and bottom edge and bevel of a substrate;

FIG. 13A is a diagram illustrating an example of an optical inspection sub-system in accordance with the invention;

FIG. 13B is a diagram illustrating an example of a stand-alone optical inspection system in accordance with the invention;

FIG. 13C is a diagram illustrating an example of a bench top optical inspection system in accordance with the invention;

FIG. 13D is a diagram illustrating an example of an optical inspection system in accordance with the invention integrated with a process tool;

FIG. 13E is a diagram illustrating an example of an optical inspection system in accordance with the invention integrated with an equipment front-end module (EFEM);

FIG. 14 is a diagram illustrating an example of a multiple light source illumination system in accordance with the invention that may be used as a light source for the optical inspection system in accordance with the invention;

FIG. 15 is a diagram illustrating another example of a multiple light source illumination system in accordance with the invention;

FIG. 16 is a diagram illustrating an example of the light source in accordance with the invention;

FIG. 16A is a diagram illustrating deep ultraviolet (DUV) illumination in accordance with the invention;

FIG. 16B is a diagram illustrating illumination angle of incidence in accordance with the invention.

FIG. 16C is a diagram illustrating elliptical beam shape illumination in accordance with the invention;

FIG. 17 is a diagram illustrating another example of the light source in accordance with the invention;

FIG. 17A is a diagram illustrating another example of the light source in accordance with the invention;

FIG. 18 is a diagram illustrating an example of refractive collection optics in accordance with the invention;

FIG. 19 is a diagram illustrating another example of collection optics using a combination of a reflective modified Schwarzschild lens and refractive corrector lens in accordance with the invention;

FIG. 20 is a diagram illustrating another example of collection optics in accordance with the invention that uses micro lenses for each pixel;

FIG. 21A is a diagram illustrating the light scattering that occurs using a longer wavelength light in accordance with the invention;

FIG. 21B is a diagram illustrating the light scattering that occurs using a shorter wavelength-light in accordance with the invention;

FIG. 22 is a series of images illustrating images with and without anti-blooming using CID and CCD photodetector sensors in accordance with the invention;

FIG. 22A is a chart illustrating the quantum efficiency of the sensor in accordance with the invention;

FIG. 22B is a chart illustrating the quantum efficiency of a back-thinned sensor in accordance with the invention;

FIG. 23 is a diagram illustrating examples of photodetector configurations in accordance with the invention that includes one or more butt-able photodetector sensor chips;

FIGS. 23A1 and 23A2 are diagrams illustrating a typical photodetector sensor;

FIGS. 23B1 and 23B2 are diagrams illustrating a photodetector sensor having integrated pixel pre-amplifiers in accordance with the invention;

FIG. 24 is a flowchart illustrating a random access integration method in accordance with the invention;

FIG. 25 is a diagram illustrating an example of a CID photodetector smart sensor configuration in accordance with the invention;

FIG. 26A illustrates an optical system in accordance with the invention that includes a second photodetector and a second broadband light source;

FIG. 26B illustrates an optical system in accordance with the invention that includes a moveable photodetector;

FIG. 26C illustrates an optical system in accordance with the invention that includes a modulated light source;

FIG. 26D illustrates an optical system in accordance with the invention that includes a movable light source.

FIG. 26E is a diagram illustrating bright field and dark field combination illumination in accordance with the invention;

FIG. 27A is a top view of a first embodiment of a substrate handler in accordance with the invention;

FIG. 27B is a side view of a first embodiment of a substrate handler in accordance with the invention;

FIG. 28A is a top view of a second embodiment of a substrate handler in accordance with the invention;

FIG. 28B is a side view of a second embodiment of a substrate handler in accordance with the invention;

FIG. 28C is a diagram illustrating a first embodiment of a substrate edge gripper in accordance with the invention;

FIG. 28D is a diagram further illustrating a first embodiment of a substrate edge gripper in accordance with the invention;

FIG. 28E is a diagram further illustrating a first embodiment of a substrate edge gripper in accordance with the invention;

FIG. 28F is a diagram illustrating a second embodiment of a substrate edge gripper in accordance with the invention;

FIG. 29 is a flowchart illustrating a differential substrate defect measurement method in accordance with the invention;

FIG. 30 is a diagram illustrating a first example of a process problem signature in accordance with the invention;

FIG. 31 is a diagram illustrating a second example of a process problem signature in accordance with the invention;

FIG. 32 is a diagram illustrating a third example of a process problem signature in accordance with the invention;

FIG. 33 is a flowchart illustrating an image processing method in accordance with the invention;

FIG. 34 is a diagram illustrating a calibrated wafer that was used to test the optical inspection system in accordance with the invention;

FIG. 35 is a diagram illustrating wafer-mapping coordinates for the calibration wafer;

FIG. 36 is a diagram illustrating the results of the optical inspection system for 0.155 μm particles;

FIG. 37 is a diagram illustrating the results of the optical inspection system for 0.304 μm particles;

FIG. 38 is a diagram illustrating the results of the optical inspection system for 0.494 μm particles;

FIGS. 39-42 illustrate the inspection results for the same calibration wafer using a conventional system.

FIG. 43 is a diagram illustrating a disk drive substrate inspection method in accordance with the invention;

FIG. 44 is a diagram illustrating another disk drive substrate inspection method in accordance with the invention;

FIG. 45 is a diagram illustrating another disk drive substrate inspection method in accordance with the invention;

FIG. 46 is a diagram illustrating the results of a disk drive substrate inspection method in accordance with the invention showing disk texture;

FIG. 47 is a diagram illustrating the results of a disk drive substrate inspection method in accordance with the invention showing a laser scribe line and particles on the disk texture; and

FIG. 48 is a diagram illustrating the results of a disk drive substrate inspection method in accordance with the invention showing a scratch and irregular disk texture.

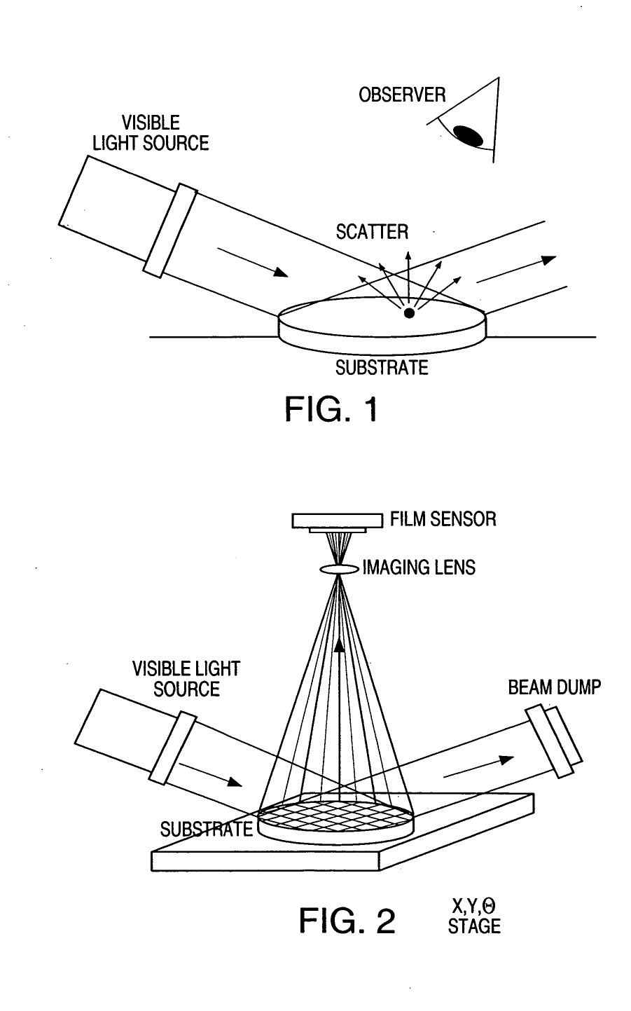

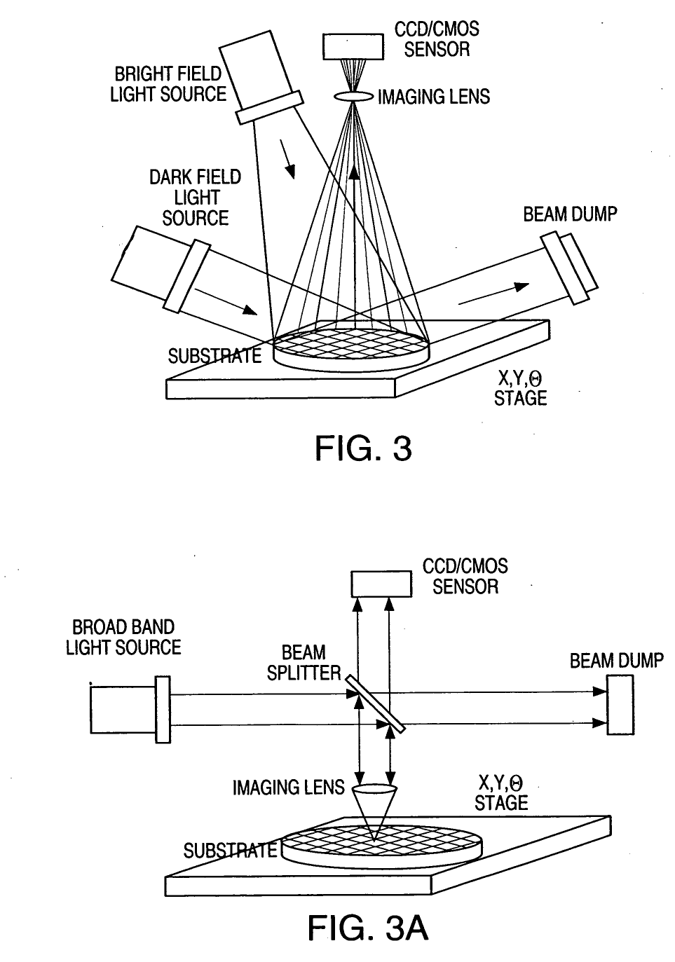

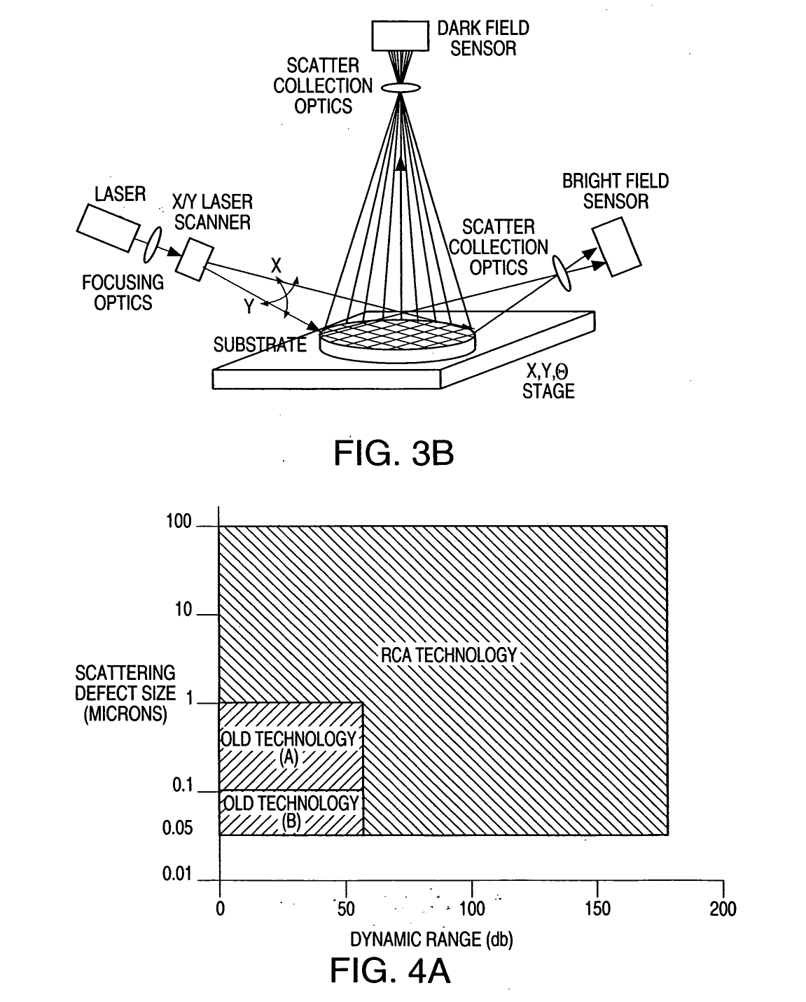

### DETAILED DESCRIPTION OF A PREFERRED EMBODIMENT

The invention is particularly applicable to semiconductor wafer substrate and disk drive substrate optical inspection systems and it is in these contexts that the invention will be described. It will be appreciated, however, that the optical inspection system and method in accordance with the invention has greater utility since the system can be used to detect and measure particles, defects, etc. on any type of substrate, such as flat panel display substrates and the like.

The optical inspection system in accordance with the invention is a high dynamic range, high precision, large area, broadband, high photon flux optical inspection system and method. The system provides optical inspection of patterned and unpatterned substrates in which a very wide dynamic range and very high precision is desirable to provide detection of particles from sub micron size to hundreds of microns in size with a single substrate measurement pass to maximize throughput. The system also permits high throughput substrate inspection in which the top and bottom and the edges of the substrate may be rapidly or simultaneously inspected for defects and features. The system is also relatively compact, low cost and simple, thus enabling integration onto process or any other equipment. The utility of high dynamic range and high precision in accordance with the invention will now be described in more detail.

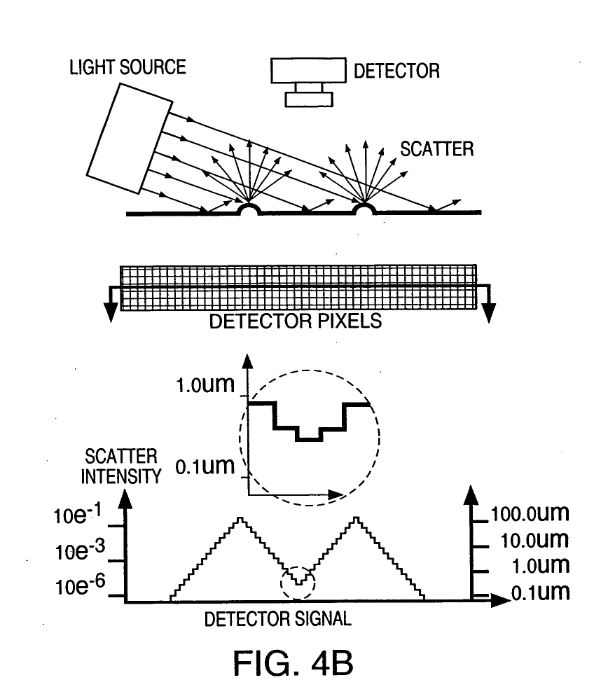

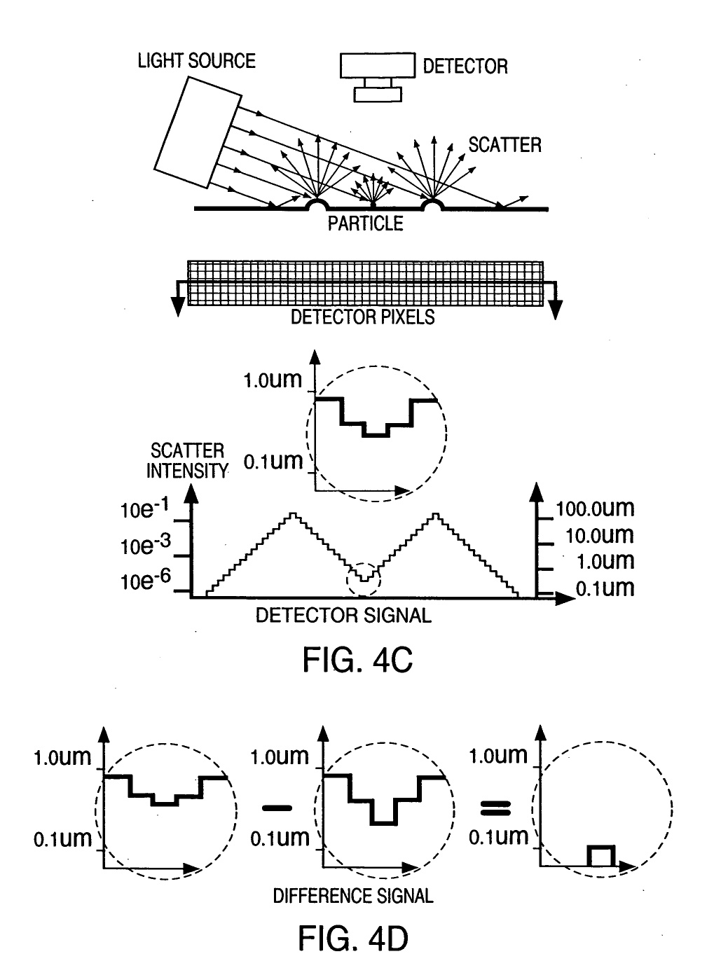

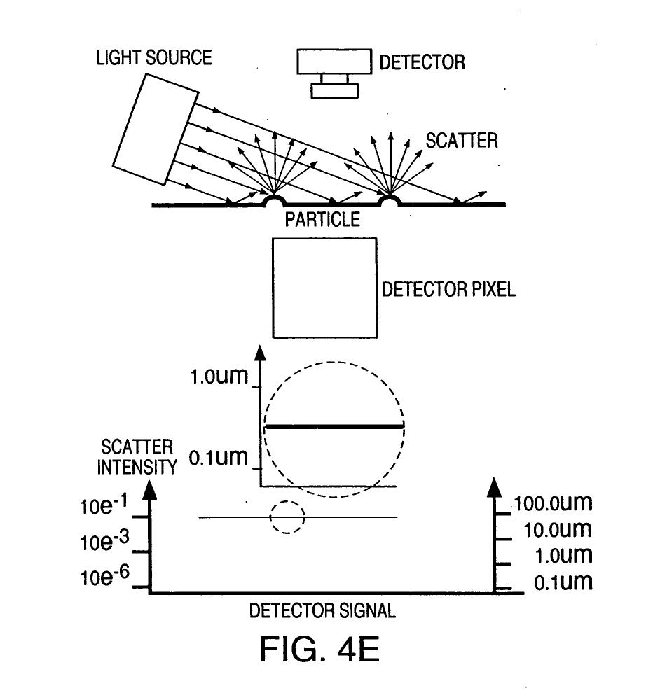

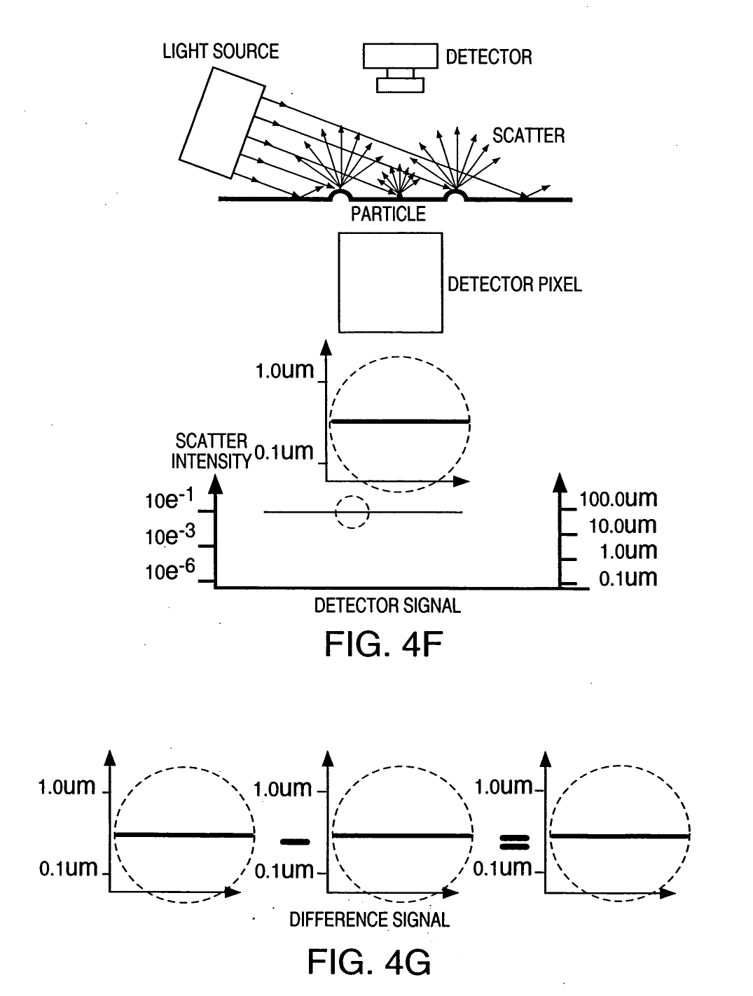

FIG. 4A is a chart illustrating the dynamic range of the optical inspection system in accordance with the invention for a single pass substrate measurement as compared to the same measurement using a typical laser scanning Micro inspection system. As shown, typical “old technology” laser scanning systems have a dynamic range of approximately 72 db and measure scattering features of limited range per substrate measurement pass, for example ranges (a) and (b). When a laser scanning inspection system is set up for the smallest particles, it can measure from 0.05 to 0.15 um, range (b). When a laser scanning system is set up for somewhat larger particles, it can measure from 0.1 to 1.0 um, range (a). A laser scanning system, however, cannot measure from 0.05 to 1 um in one substrate measurement pass. In contrast, the optical inspection system in accordance with the invention (as described below in more detail) has a dynamic range of over 170 db and can detect and measure particles ranging from below 0.10 microns to 100 microns in size in a single substrate measurement pass due to a much wider dynamic range. This increase in dynamic range improves throughput significantly because the entire detection range is covered in one pass.

FIGS. 4B through 4G are illustrations of the advantages of both very high dynamic range and very high precision detection in accordance with the invention. At the top of FIG. 4B, a high dynamic range and high precision detector in accordance with the invention is shown detecting scatter from a surface with two large light scattering features separated by many pixels. The light scattering features are spaced far enough apart that the detector is able to resolve the light scattering features. A representative gray scale image is depicted in the middle of FIG. 4B. The signal output from the detector along the center row of pixels is shown at the bottom of FIG. 4B. The scatter is shown ranging over 5 orders of magnitude. The signal in the region between the light scattering features does not go to zero because scatter from the light scattering features flares into this region raising the detected signal floor. The signal at the bottom of FIG. 4B is the baseline signal. FIG. 4C is similar to FIG. 4B, but a small particle has been added between the light scattering features. The detector signal at the bottom of FIG. 4C shows a slight increase between the large scattering features due to the particle scatter. FIG. 4D shows the result when the baseline signal at the bottom of FIG. 4B is subtracted from the signal at the bottom of FIG. 4C. The result is a signal difference due to the added particle. As shown in FIG. 4C, the particle scatter signal is much weaker than the scatter signal from the large scattering features. A detector with both high dynamic range and high precision is required to detect the added particle.

The top of FIG. 4E shows a high dynamic range and high precision detector in accordance with the invention, detecting scatter from a surface with two large scattering features that are so close together on the substrate that their scatter is detected by a single detector pixel. The scattering features are so close to each other that the detector is not able to resolve them. The middle of FIG. 4E depicts a detector pixel with a uniform gray scale. The signal output for this pixel is shown at the bottom of FIG. 4E. The total scatter signal at the bottom of FIG. 4E is very large and is the baseline signal. FIG. 4F is similar to FIG. 4E, but a small particle has been added between the two large light scattering features. The detector pixel signal at the bottom of FIG. 4F shows a very slight increase due to the particle. FIG. 4G shows the result when the baseline signal 4E is subtracted from the added particle signal 4F. The result is a signal equal to the scatter from the added particle detected by a high dynamic range high precision detector.

A detector with high dynamic range, but low precision, would be able to detect both the particle scatter and the large feature scatter only if the large scattering features were far enough apart that their scatter did not overshadow the particle scatter. When the light scattering features are closer together, the particle is hidden unless the detector has high precision (resolution) to resolve the particle from the difference signal. An example of a high dynamic range detector with limited precision is a detector with logarithmic photon conversion at each pixel. A High Dynamic Range Camera (HDRC) sensor has been developed composed of a matrix of photodiodes each with its own logarithmic amplifier and switching electronics. The HDRC technology is capable of a dynamic range up to 170 db (>3×10⁸), but the precision of the output is still limited to the A/D conversion resolution, typically less than 16 bits (96 db). The HDRC sensor has adequate small signal resolution, but inadequate large signal resolution and noise levels. Even though the HDRC sensor has high dynamic range, it cannot detect very small particles near large scattering features as in FIGS. 4B-4E. The optical inspection system and method in accordance with the invention with the high dynamic range, high precision detector will now be described in more detail.

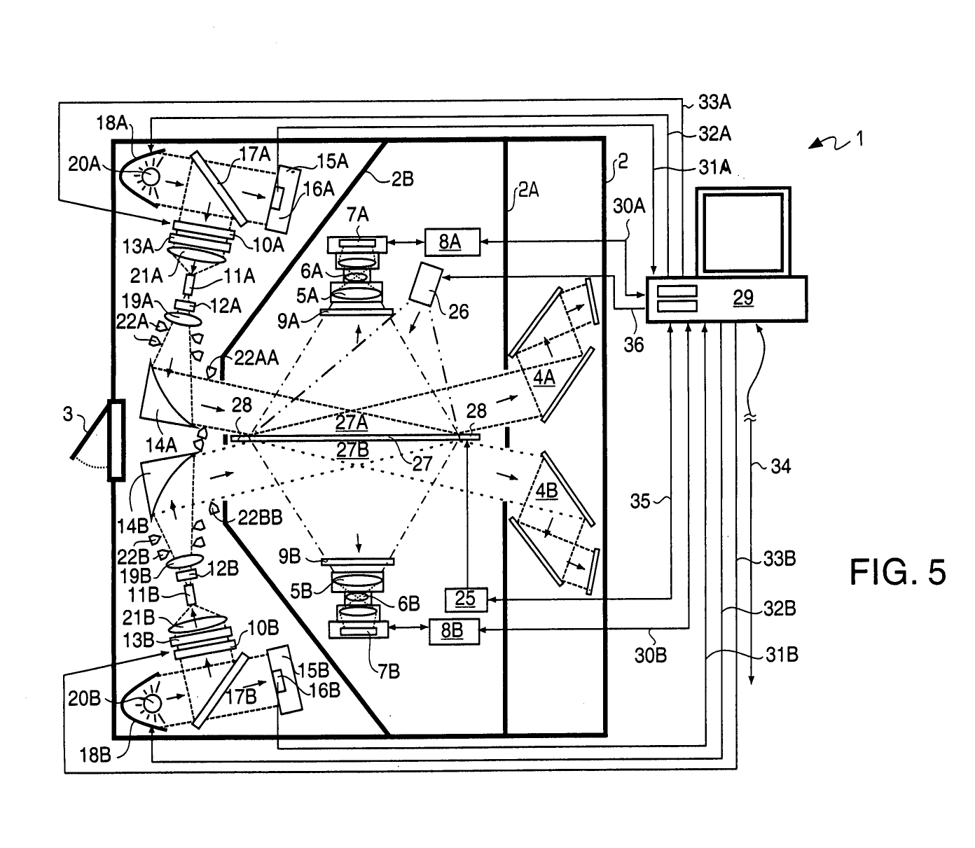

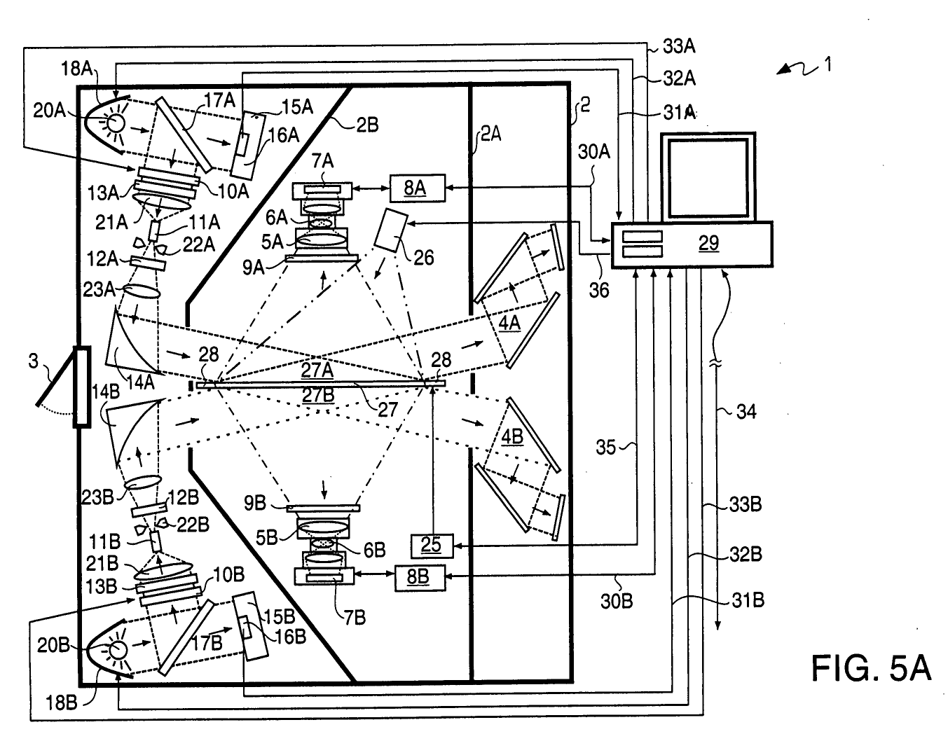

FIG. 5 is a block diagram illustrating a preferred embodiment of a broadband optical inspection system 1 in accordance with the invention. The optical inspection system provides simultaneous illumination of the top and bottom surface of a substrate 27. The scatter from scattering features that scatters light in the illuminated area is detected across the entire area simultaneously by high dynamic range and high precision array photodetectors. The scattering features may include, but are not limited to, defects in the substrate, scratches, pits, particles, device patterns and pattern anomalies, etched regions, polish roughness and texture on the surface of the substrate; embedded particles in films on a surface of the substrate and any aspect of the surface of the substrate that scatters light. In accordance with the invention, the light may include electromagnetic radiation energy from less than 200 nm in wavelength to more than 1100 nm in wavelength and preferably from deep ultraviolet electromagnetic radiation to visible electromagnetic radiation energy. Since each array photodetector pixel integrates scattered light individually, scatter signals can be acquired in parallel, thus significantly increasing measurement throughput. Further, neither the substrate nor the sources are scanned/moved and there are no moving parts during image acquisition thus further increasing throughput and system reliability. Since the optical inspection system provides simultaneous front and backside particle inspection, throughput is further improved by at least a factor of two. The system has very high dynamic range and high precision scatter detection such that particles ranging from sub tenth micron diameter through tens of microns diameter are detected in a single measurement pass in accordance with the invention, thus further improving throughput. The system is very compact, low cost and simple and thus can readily be integrated onto process or other tools. Because the whole substrate is illuminated and imaged simultaneously and the substrate is not in motion during the measurement, system-to-system matching is greatly improved over existing commercial defect inspection systems. The elements of the system will be described generally with respect to FIG. 5. Each element of the system will then be described in greater detail below.

The system may include an enclosure 2 that preferably may be light tight to keep unwanted light from entering into the enclosure. The internal surfaces of enclosure 2 are treated to minimize reflected light so as to reduce stray light getting into the collection/imaging optics of the photodetectors. Another source of background stray light in the enclosure is Rayleigh scatter caused by the illumination light beam interacting with air and other molecules inside the enclosure. Scatter from particles much smaller than the wavelength of the illuminating light is Rayleigh scatter. For air, the dominant scattering particles are suspended particulates and water vapor. In a semiconductor fab, particulate levels are virtually zero, so water vapor is the major contributor. Rayleigh scatter can be virtually eliminated by drying the air in the measurement enclosure, filling the enclosure with a gas such as dry nitrogen or optimally evacuating the enclosure to less than a few torr. The enclosure may also be vacuum tight to maintain a vacuum within the enclosure for integration onto a vacuum chamber and for reduction of Rayleigh scatter. The enclosure may also be gas tight to maintain a controlled pre-determined gas mixture within the enclosure primarily for reduction of Rayleigh scatter. The enclosure may further include bulkheads 2A, 2B separating beam dump optics and illumination optics respectively from the measurement region to further reduce stray light. The system may further include a load port 3, which permits a substrate 27 (having one or more surfaces to be inspected and analyzed) to be placed into and removed from the enclosure 2. The load port 3 is located such that the substrate can be loaded/unloaded without interfering with any components inside the enclosure. The load port 3 may include a light tight door that can be opened to provide access to the inside of the enclosure. If the enclosure is vacuum tight, then the load port 3 may also be vacuum tight. If the enclosure is gas tight, then the load port 3 may also be gas tight.

The system may further include one or more beam dumps (such as a substrate backside beam dump 4B and a substrate frontside beam dump 4A as shown in FIG. 5) that are positioned as shown in FIG. 5 opposite from the respective illumination light energy source. The beam dumps absorb the specular light energy reflected off of frontside 27A and backside 27B of the substrate 27 to reduce the unwanted light within the enclosure. The beam dumps absorb virtually all the light that impinges on them to minimize stray light to a pair of high dynamic range and high precision scatter photodetectors 7A, 7B. Beam dumps may be implemented with very dark light absorbing plates, such as used for welder's goggles, tilted so the incident light strikes the first glass plate between 30 and 60 degrees, the reflected light is directed to a second glass plate, and so on. The reflecting surface of the dark light absorbing plates should have a very smooth finish to minimize scatter. Any light that passes through the plates is so heavily attenuated that it is of no concern. The remaining beam reflected from the second dark glass plate impinges on a dark flat black surface roughly perpendicular to the beam, which is sufficient to fully absorb the remaining light. Minimizing stray light is desirable to allow detection of the weakest scatter by the detectors 7A, 7B. The positioning of the beam dump and light source shown in FIG. 5 may be changed without departing from the scope of the invention.

The system further comprises one or more photodetector imaging lenses (such as a frontside imaging lens 5A and a backside imaging lens 5B as shown in FIG. 5) that capture the light energy from the backside and frontside of the substrate, respectively, that is scattered by the topology on the substrate (including scattering features) on each surface of the substrate and image the scattered light energy onto the respective detector 7A, 7B. The light energy may also pass through polarizers (such as a frontside polarizer 9A and a backside polarizer 9B as shown in FIG. 5) that filter scatter according to the polarization orientation. By adjusting the image sensor polarizer axis perpendicular to the illumination polarization, the only light that passes to the detector is called cross-polarized light. Cross polarization filtering is a way to further reduce background scatter because scatter from some scattering features, such as particle scatter, causes preferential polarization rotation while surface scatter is more random and the random scatter will be blocked by the cross polarizer configuration. The invention may also be implemented without the polarizers. The system may further comprise one or more field lenses (such as a frontside field lens 6A and a backside field lens 6B as shown in FIG. 5) in combination with the respective imaging lenses which significantly increase the light energy imaged onto the photodetector as is well known. The invention may also be implemented without the field lenses. As used herein, the imaging lenses and the field lenses together may be referred to as light collection optics so that the system shown in FIG. 5 includes backside collection optics and frontside collection optics. In accordance with the invention, the frontside and backside collection optics light path may be folded using, for example, mirrors and the like.

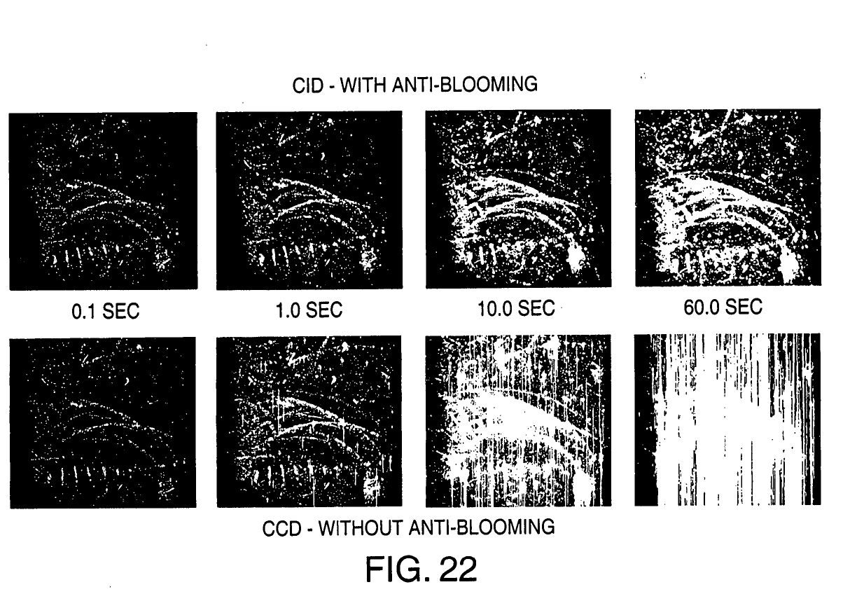

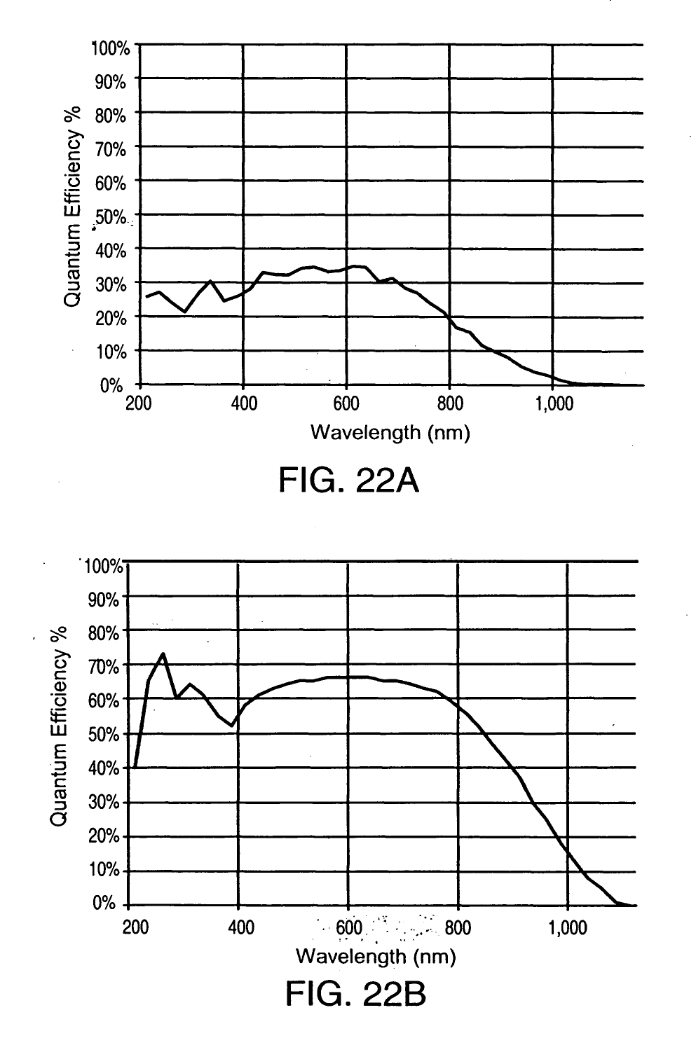

The system may further comprise one or more high dynamic range and high precision photodetectors (such as a frontside photodetector 7A and a backside photodetector 7B as shown in FIG. 5), which detect the scattered light from each respective side of the substrate that is imaged onto the photodetector by the respective light collection optics. Various aspects of frontside and backside detectors 7A, 7B are described in more detail below with reference to FIGS. 22-25. In a preferred embodiment, each photodetector may be a charge injection device (CID) photodetector array, which has very high dynamic range and very high precision and can image short wavelength light below 200 nm, which includes deep ultraviolet (DUV) light. The system further comprises one or more CID controllers (such as frontside CID controller 8A and backside CID controller 8B as shown in FIG. 5) that are connected to the respective CID array and may provide power, chip control and TEC control for the respective CID array. The controller's 8A, 8B may also each include analog to digital converters (digitizers) which convert the analog signals from the CID array pixels into digital signals. Furthermore, the controllers 8A, 8B may accept high level commands over a high-speed connection. As used herein, the frontside photodetector and the frontside controller may be referred to collectively as a frontside detector and the backside photodetector and the backside controller may be referred to collectively as a backside detector.

The system may further comprise a broadband bright field light energy source 26 as shown in FIG. 5. The bright field source illuminates the entire frontside of the substrate for viewing by the frontside detector. The bright field source can be turned off and on by the control computer using control line 36. This illumination, in conjunction with the frontside photodetector 5A-7A, may be used for substrate alignment and to detect if a substrate is loaded onto the wafer substrate handler 28 as shown in FIG. 5, described further below. This illumination, in conjunction with the frontside photodetector 5A-7A, may be used for substrate identification by detecting bar codes and/or alphanumeric characters laser scribed on the substrate. This illumination may also be used for brightfield scattering feature inspection using the high dynamic range and high precision photodetector 5A-7A.

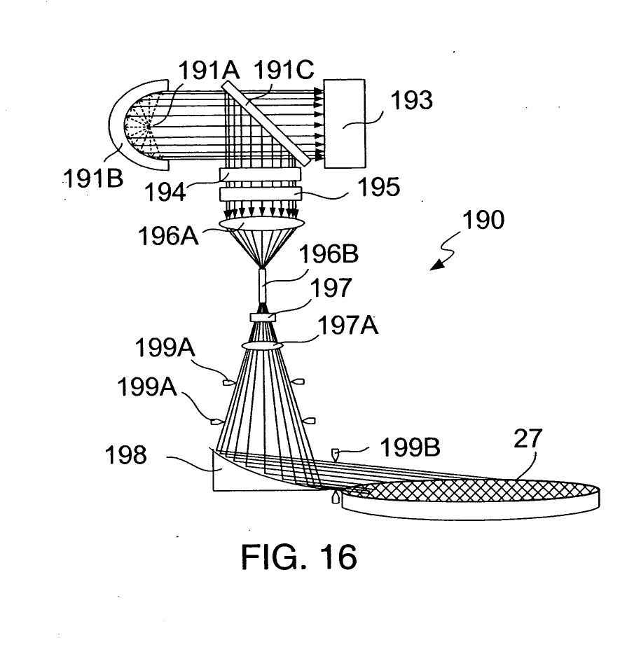

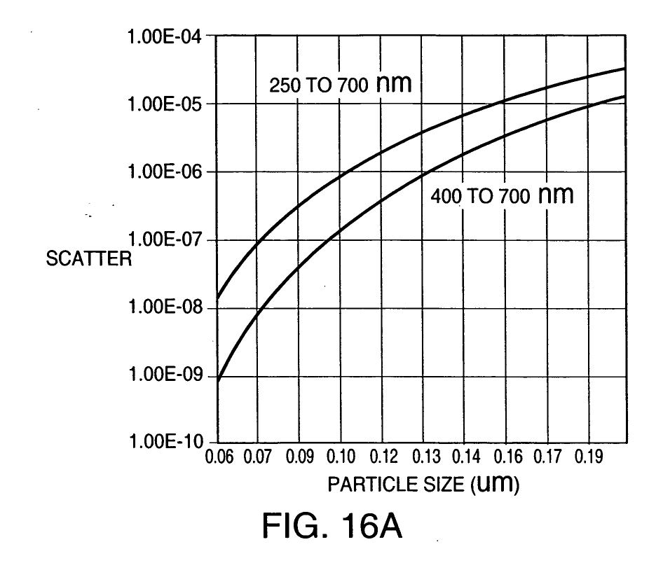

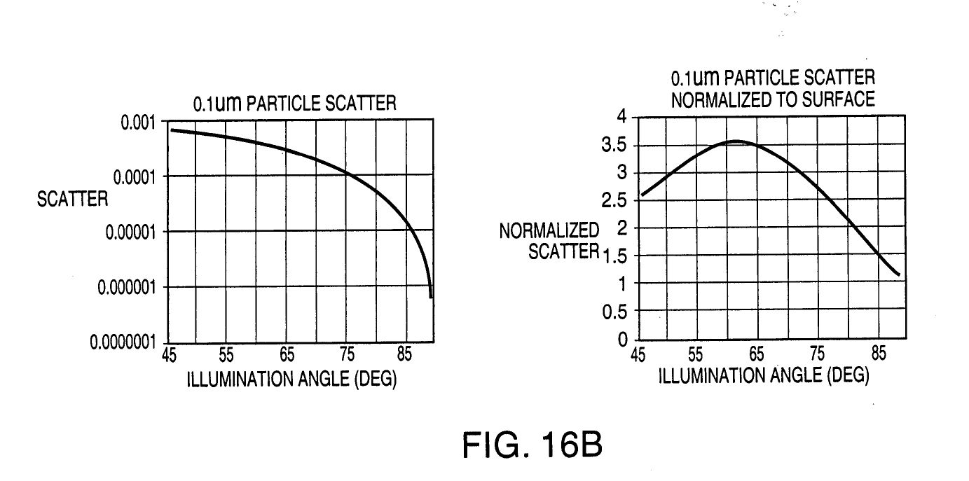

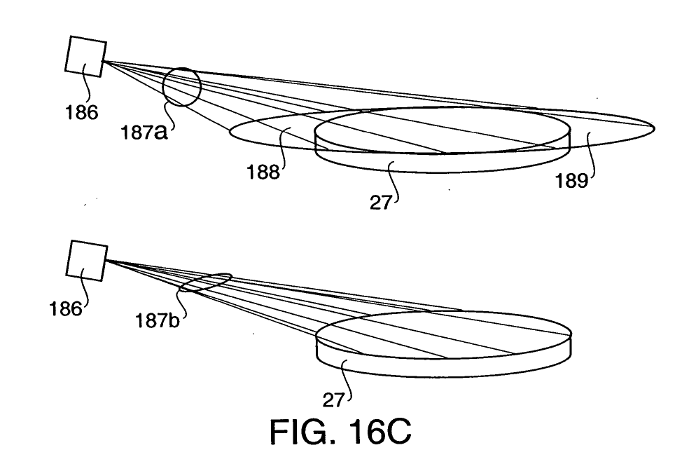

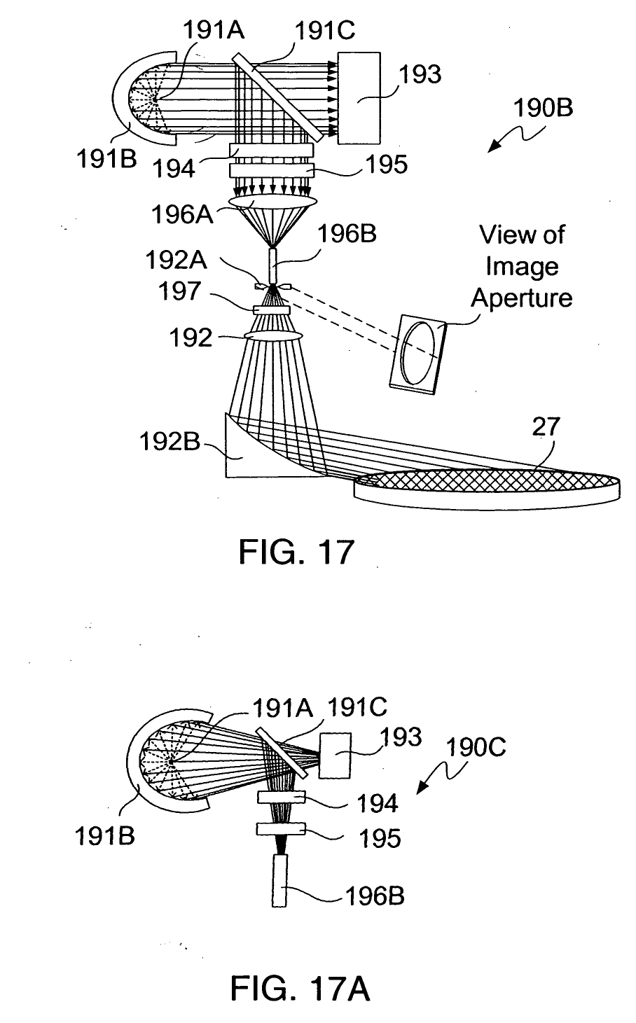

The system may further comprise one or more dark field broadband light energy sources (such as a frontside broadband light source 20A and a backside broadband light source 20B as shown in FIG. 5) that direct broadband light (light having a wide range of wavelengths) towards the frontside 27A of the substrate 27 and the backside 27B of a substrate 27, respectively. Various aspects of frontside and backside detector illumination are described in more detail below with reference to FIGS. 16-17A below. Broadband light sources may be, for example, Xenon or Mercury vapor, Metal Halide, a combination of Xenon and Mercury vapor or a combination of other gaseous materials or sources such as combining light from Tungsten and Deuterium sources which results in a broad wavelength spectrum with reasonable DUV content. The source could also be a combination of one or more lasers or light emitting diodes (LEDs). The preferred light energy source is a Xenon high-pressure arc, which emits light from below 200 nm to well past 1100 nm. The system may further comprise one or more light source reflectors (such as a frontside source reflector 18A and a backside source reflector 18B as shown in FIG. 5) that receive the light energy output that would normally be lost from the source and direct the light energy towards a respective dichroic mirror 17A, 17B.

The dichroic mirror (a frontside dichroic mirror 17A and a backside dichroic mirror 17B as shown in FIG. 5) preferably reflects DUV through visible wavelengths and transmits longer infrared (IR) wavelengths. The dichroic mirror acts as an effective wavelength separator so that IR wavelength light does not impinge on the substrate 27. The dichroic mirror transmits IR light that is collected and absorbed by source beam dumps (such as a frontside source beam dump 15A and a backside source beam dump 15B as shown in FIG. 5). A portion of the IR light is also directed to source light intensity sensors (such as a source light intensity sensor 16A and a source light intensity sensor 16B as shown in FIG. 5). The source light intensity sensors provide feedback to the system regarding light intensity of the broadband light source through control lines 31a and 31b. The source light intensity sensors are needed especially for differential measurements to normalize illumination intensity variations but also provides other information, for example, to allow prediction of the remaining lifetime of the source. Also, scatter signals can be normalized by the source light intensity to correct for variation in the source light output over time.

The dichroic mirror also reflects the DUV through visible light onto one or more light beam shutters (such as a frontside shutter 10A and a backside shutter 10B as shown in FIG. 5) that receive the light energy output from the dichroic mirrors and either pass or block the light. The shutters are controlled by control lines 33A, 33B respectively. The light energy exiting the shutters impinges on one or more optical band pass filters (such as a frontside band pass filters 13A and backside band pass filters 13B as shown in FIG. 5). These band pass filters allow the illumination to the substrate surface to be limited in wavelength range. By limiting the illumination wavelength range, wavelength dependent particle scatter can be analyzed to discriminate material properties and particle sizes. The invention may also be implemented without the band pass filters. The output of the band pass filters passes to focusing lens assembly (such as a frontside focusing lens assembly 21A and a backside focusing lens assembly 21B as shown in FIG. 5). The focusing lens assembly has good transmission in the DUV, is optimized to efficiently collect the light from the CERMAX source and focuses the light at the optimum numerical aperture for the light beam homogenizer. The output of the focusing lens assembly is focused into a respective light beam homogenizer. (such as a frontside light beam homogenizer 11A and a backside light beam homogenizer 11B as shown in FIG. 5). The homogenizers improve the uniformity of the light energy directed onto the front and backsides of the substrate 27. The light beam homogenizers are well known optical components and often used with arc sources. The homogenizers are made from high quality optical quartz and have good DUV transmission. The homogenizers could also be a hollow structure with highly polished sides or a collection of closely packed micro-lenses called a “fly's eye integrator”. The light energy exiting the homogenizers impinges on one or more polarizers (such as a frontside polarizer 12A and backside polarizer 12B as shown in FIG. 5) that affect the light energy such that the light exiting the polarizers is uniformly polarized. The polarizers also have good DUV transmission. Wire grid polarizers are an example of a polarizer with good broadband transmission including DUV. The invention may also be implemented without the polarizers.

The light energy exiting the polarizers impinges on a light conditioning lens assembly (such as a frontside light conditioning lens assembly 19A and a backside light conditioning lens assembly 19B as shown in FIG. 5). The light conditioning lens assembly may have an internal limiting aperture that provides control of the collimation of the substrate illumination. The output of the light conditioning lens assembly is directed to one or more sets of beam conditioning apertures (such as a frontside beam conditioning apertures 22A and a backside beam conditioning apertures 22B as shown in FIG. 5). The beam conditioning apertures 22A, 22B truncate the beam to eliminate light rays that would not produce collimated illumination onto the substrate 27. The light conditioning lens assembly 19A modifies the beam so that more rays will pass through the conditioning apertures to become collimated illumination onto the substrate 27. The light energy exiting the beam conditioning apertures impinges on one or more parabolic section mirrors (such as a frontside parabolic section mirror 14A and a backside parabolic section mirror 14B as shown in FIG. 5). The parabolic surfaces of the parabolic section mirrors convert the diverging beam incident on the mirrors to a collimated beam. In order to shape the collimated light reflected from the parabolic section mirrors 14A, 14B to illuminate only the substrate, the beam directed onto the mirrors should be kidney shaped. The beam conditioning apertures 22A, 22B are therefore kidney shaped. The homogenizer has a pentagonal cross section, which helps pre-shape the beam to a kidney shape. The light energy reflects from the parabolic collimating mirror onto a shadow casting apertures (such as frontside shadow casting apertures 22AA and backside shadow casting apertures 22BB as shown in FIG. 5). The shadow casting apertures are elliptical in shape and further shape and limit the beam that falls onto the substrate to essentially the edge of the substrate. As used herein, the light energy source, the source reflector, the shutter, the dichroic mirror, the light beam homogenizer, the polarizer, the light conditioning lens assembly, the beam conditioning apertures, the projection mirror and the shadow-casting aperture may be referred to as a light source. The output of the light source falls uniformly and collimated onto substrate front and backsides 27A, 27B respectively, of the substrate as shown. In accordance with the invention, the optics and the light path of the frontside and backside light source may be folded using, for example, mirrors and the like.

Thus, in the system shown in FIG. 5, there may be a backside light source that directs light energy towards the backside of the substrate and a frontside light source that directs light energy towards the frontside of the substrate. In accordance with the invention, the frontside and backside dark field light sources may be operated simultaneously so that the frontside and backside of the substrate are simultaneously illuminated and imaged. The frontside dark field illumination, in conjunction with the frontside photodetector 5A-7A, may also be used for substrate identification by detecting bar codes and/or alphanumeric characters laser scribed on the substrate. The frontside and backside light sources may also be used for darkfield scattering feature inspection using the high dynamic range and high precision photodetector 5A-7A.

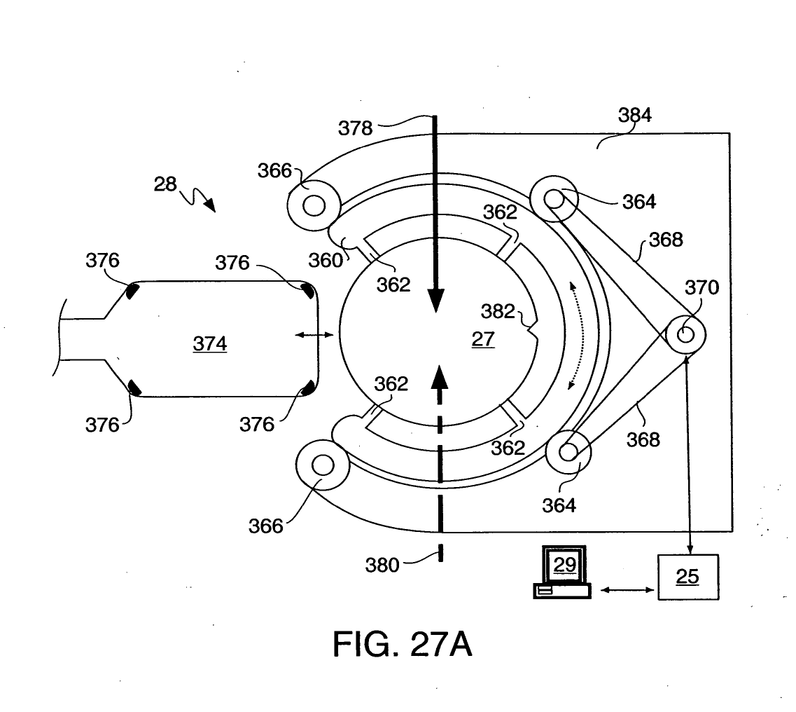

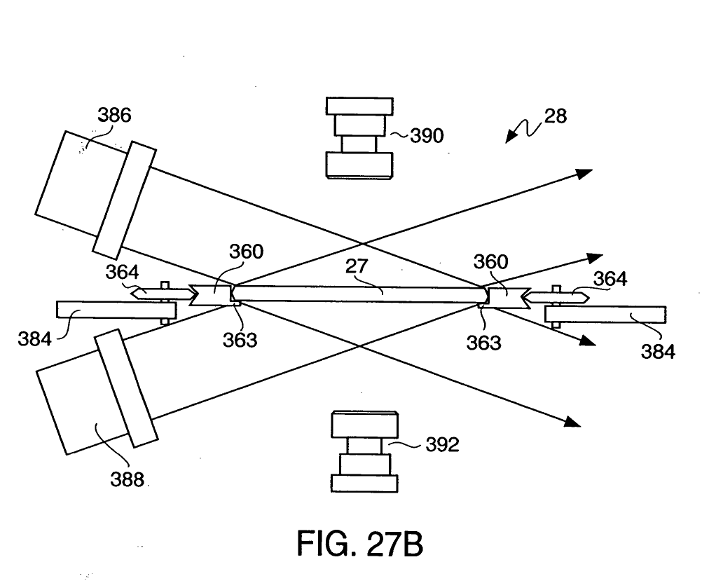

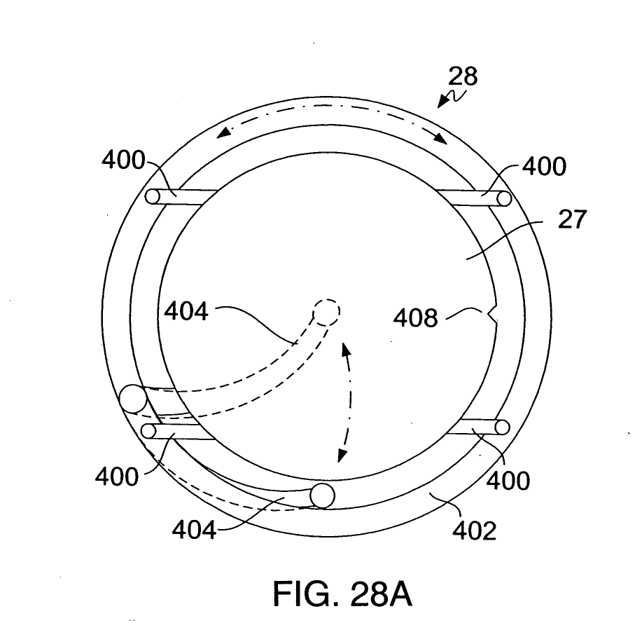

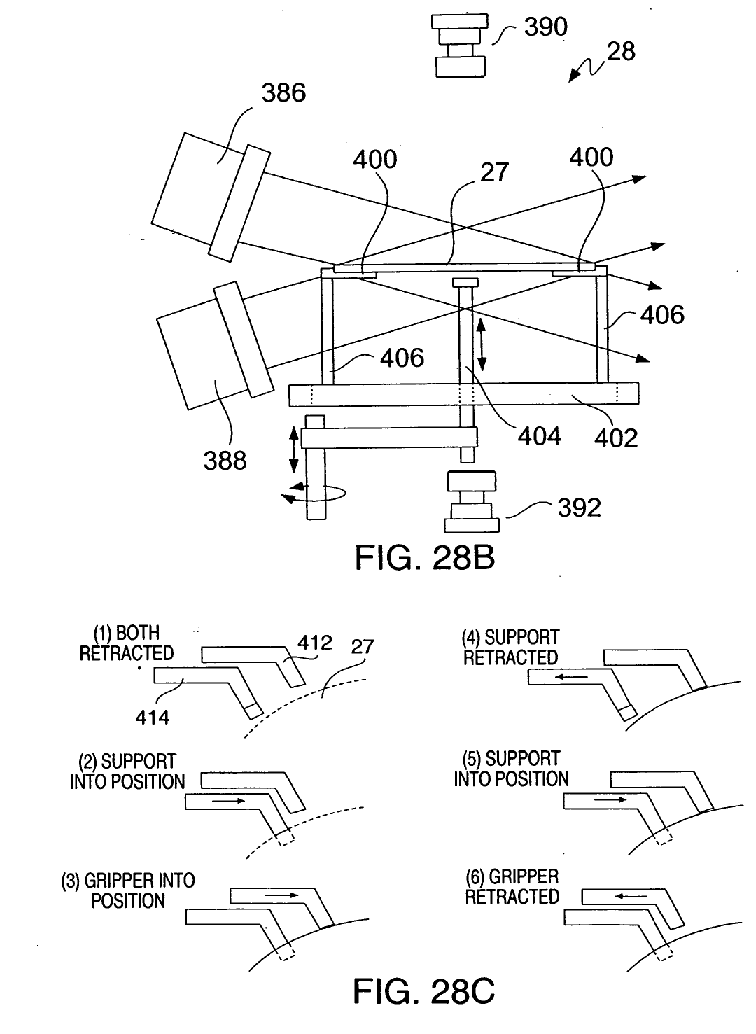

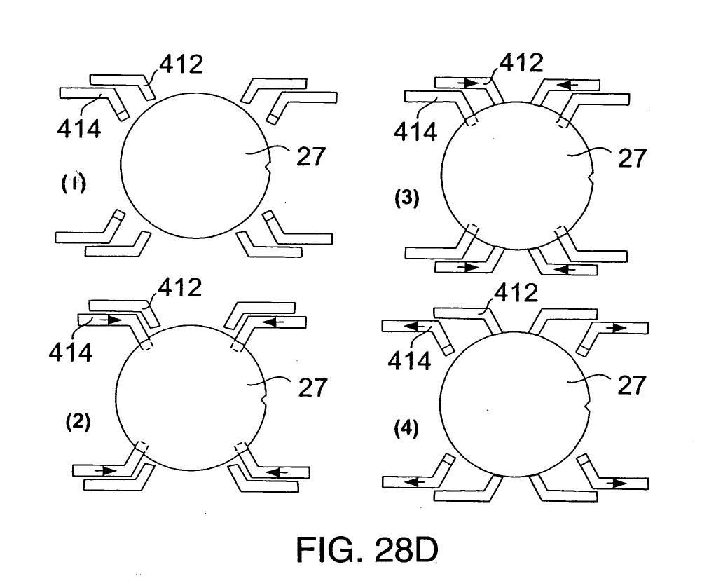

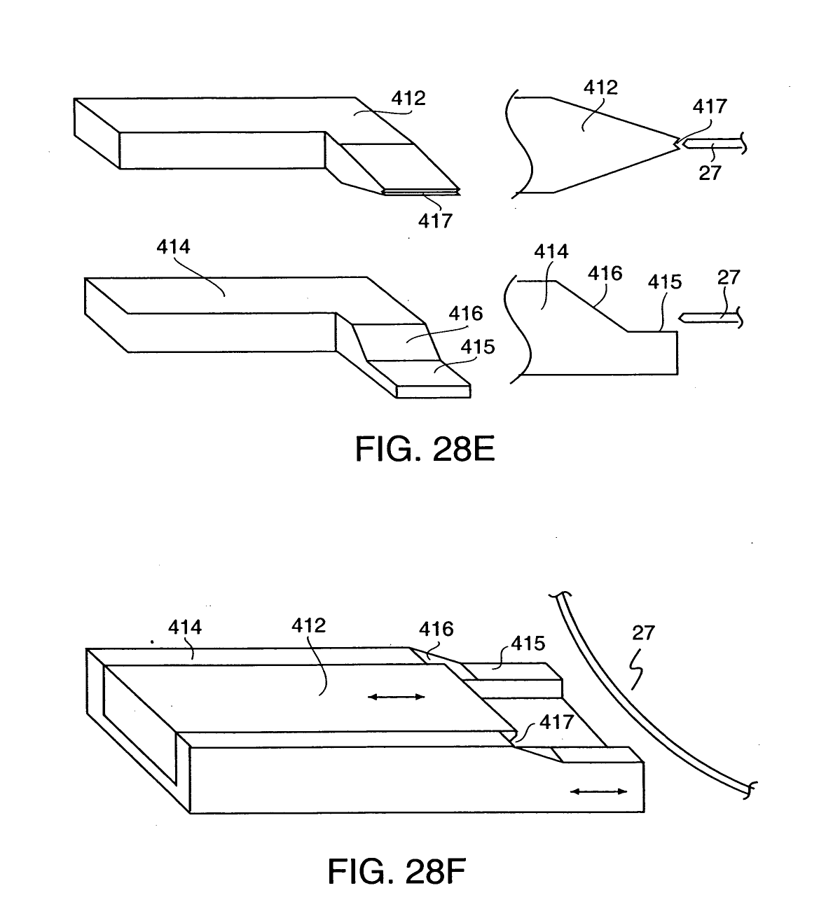

The system may further comprise a substrate handler motor/controller 25, which controls the operation and motion of a substrate handler 28 that aligns the substrate prior to substrate measurement. Once the substrate has been loaded onto the substrate handler 28, the orientation of the substrate may be aided by illuminating the entire frontside of the substrate with the brightfield source 26. The frontside photodetector images the whole substrate including the edges. A wafer substrate with a notch or flat will have a distinct edge pattern and the bright field image can be processed to determine the orientation of the notch or flat as well as substrate center. Once the notch or flat is found, the substrate handler may orient the substrate to a pre-defined orientation if the substrate has not already been externally pre-aligned. The substrate may be pre-aligned before the substrate is loaded, in which case, the substrate handler 28 does not need to orient the substrate. If the substrate has identification marks, such as engraved alpha-numeric characters or a bar code, then the substrate would first be oriented to a position to enhance the identification marks in the frontside detector image using either darkfield illumination from the broadband source discussed above, the brightfield source 26 or both. The high dynamic range and high precision detector will provide robust images enabling substrate identification detection for high contrast substrate surfaces. The resulting frontside detector image can be processed using known optical character recognition (OCR) or Barcode detection software algorithms. Once the substrate identification has been determined, the substrate can be rotated to the measurement orientation. The OCR or barcode detection are optional processes. Since the system images both sides and the edges of the substrate simultaneously, the handler does not interfere significantly with these inspections. Interference with the illumination beams is minimized with an edge gripping substrate handler. Repeatable substrate orientation with respect to the substrate notch or flat is needed for differential measurements and to minimize periodic pattern scatter to the frontside and backside detectors. The substrate can be oriented either by the substrate handler or by an external substrate pre-aligner before the substrate is loaded. If the substrate is pre-aligned before loading, then the substrate handler can be an edge gripper mechanism only without rotation capability. Two different embodiments of the substrate handler and edge gripper details are described in more detail below with reference to FIGS. 27A-28F. The system may further include controls lines 35 that connect the substrate handler controller to a control computer 29 that controls the operation of the substrate handler.

The control computer 29 may further comprise a database (not shown) for storing the measurement and inspection results as well as other information such as images of the substrate scatter. The control computer 29 also controls the other operations of the other elements of the optical inspection system in accordance with the invention. For example, the system may include control lines 30A, 30B which connect the control computer to the CID controllers 8A, 8B so that the computer controls the operation of the CID controllers and receives the digital signals from the CID controller corresponding to the outputs from the respective CID array high dynamic range and high precision detectors. The system may further include control lines 32A, 32B which connect the control computer to the light energy sources 20A, 20B and control the operation of those light energy sources. The system may further include control lines 32A, 32B that connect the control computer to the light shutters 10A, 10B and control the operation of those shutters. The control computer may also have an interface line 34 which connects to other computer systems within a wafer substrate fabrication plant or to a computer network so that the control computer may output data to the computer network or wafer substrate fabrication system and may receive instructions. As is well known, the control computer may have the typical computer components such as one or more CPUs, persistent storage devices (such as a hard disk drive, optical drive, etc), memory (such as DRAM or SRAM) and input/output devices (such as a display, a printer, a keyboard and a mouse) which permits a user to interact with the computer system. These components of the control computer are not shown. To control the operation of the optical inspection system in accordance with the invention, the control computer may include one or more software modules/pieces of software that are executed by the CPU. These modules may cause the control computer to control the elements of the optical inspection system connected to the control computer. For example, one software module may monitor the temperature of each CID array through the CID controller and may provide control commands to the CID controller to maintain the temperature of the CID array. As another example, another software module being executed by the CPU of the control computer may control the movement and operation of the substrate handler. It is also possible for the control computer functions to be implemented within the CID controllers 8A, 8B and not require separate system controller hardware.

In operation, a substrate is placed into the system through the load port 3. The substrate is placed into the substrate handler 28, which then moves the substrate from a loading position to a substrate inspection position (shown in FIG. 5). Next, the front and backside shutters are opened (under control of the control computer) to produce light that simultaneously strikes the backside and frontside of the substrate at an angle other than normal incidence. In accordance with the invention, the entire frontside and backside surface of the substrate are illuminated. The light energy directed at the backside of the substrate is scattered by scattering features on the backside of the substrate and the light energy directed at the frontside of the substrate is scattered by scattering features on the frontside of the substrate. Light scattered by backside scattering features is gathered by the backside collection optics and detected by the backside high dynamic range and high precision detector. Similarly, the light scattered by frontside scattering features are gathered by the frontside collection optics and detected by the frontside detector. In this manner, scattering features on the frontside and backside of the substrate 27A, 27B are simultaneously imaged and detected. The results detected by the photodetectors are converted into digital signals and are forwarded to the control computer. The control computer may include one or more pieces of analysis software that analyze the digital signals from the photodetectors and generate results and data.

FIG. 5a show an alternative illumination method of the optical inspection system. The method in FIG. 5 is a shadow casting method. In general, the image relay optics are more costly and have a longer optics path length than the shadow casting method. The image relay method, however, produces substrate illumination with more sharply defined edges than the shadow casting method thus more effectively limiting extraneous substrate edge scatter. The method in FIG. 5a is an image relay method. FIG. 5a is identical to FIG. 5 except for changes between the front and backside homogenizers' 11A, 11B and the front and backside substrate surfaces 27A, 27B. In FIG. 5A, the light energy exiting the homogenizers 11A, 11B impinges on an image aperture (such as a frontside image aperture 22A and a backside image aperture 22B as shown in FIG. 5). These image apertures define the shape of the beam that falls onto the substrate surfaces 27A, 27B and are roughly elliptical. The light energy exiting the apertures impinges on one or more polarizers (such as a frontside polarizer 12A and backside polarizer 12B as shown in FIG. 5) that affect the light energy such that the light exiting the polarizers is uniformly polarized. The invention may also be implemented without the polarizers. The output of the polarizers impinges on image relay lens assemblies (such as a frontside image relay lens assembly 23A and a backside image relay lens assembly 23B as shown in FIG. 5A) that relay the image of the image apertures 22A, 22B in combination with spherical mirrors 14A and 14B onto substrate surfaces 27A, 27B. The image aperture edges projected onto the substrate correspond to the edges of the substrate 27, thereby limiting the beam to essentially the edge of the substrate. These image relay lens assemblies, 23A, 23B transmit well into the DUV. The light energy exiting the lens assemblies impinges on one or more spherical mirrors (such as a frontside spherical mirror 14A and a backside spherical mirror 14B as shown in FIG. 5A). The light energy is directed by the mirrors 14A, 14B onto substrate front and backsides 27A, 27B respectively, of the substrate as shown. The mirrors 14A, 14B act not only as mirrors but also as reflecting lenses to collimate the relayed image and project a sharp image of the image apertures onto the substrate front and backsides. The spherical mirrors 14A, 14B could also be replaced by a combination of flat mirror surfaces and a refractive lens between the mirrors and the substrate, however, the refractive lens has to be as wide as the substrate which adds to the overall cost of the system. Now, the initialization of the optical inspection system in accordance with the invention will be described in more detail.

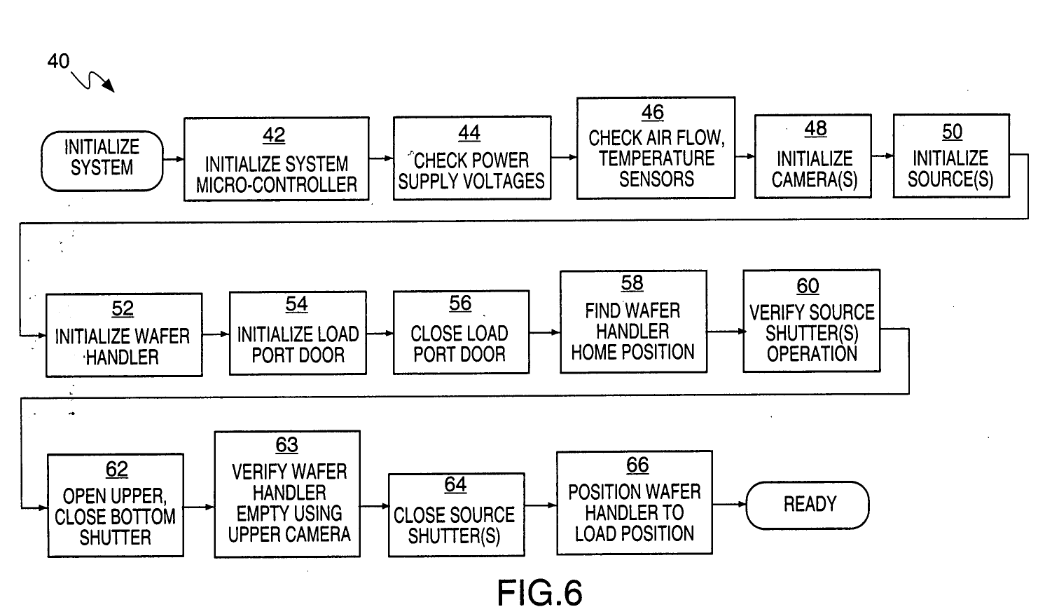

FIG. 6 is a flowchart illustrating an example of an optical inspection system initialization process 40 in accordance with the invention. In particular, the process prepares the optical inspection system for operation when the optical inspection system is first energized. In step 42, the control computer is initialized. The system may further comprise other computers located in various elements of the system, such as a substrate handler controller, a CID controller, a light source controllers, etc. In step 44, the power supply voltages of the system are checked to make sure that correct regulated voltages are being generated. In step 46, the airflow and temperature sensors within the enclosure are tested. In step 48, the high dynamic range and high precision photodetectors are initialized. In step 50, the light sources are initialized. In step 52, the controller and mechanical drive components for the substrate handler are initialized. In step 54, the load port door is initialized and the load port door is closed in step 56. In step 58, the home position of the substrate handler is determined and the substrate handler is moved to the home position. In step 60, the system checks the light source shutter operation and opens the upper light source shutter (and closes the bottom light source shutter) in step 62. In step 63, the system verifies that the substrate handler is currently empty using the frontside detector and the frontside bright field light source 26. In step 64, the shutters of both sources are closed. In step 66, the substrate handler is moved to a load position so that a first substrate may be optically inspected in accordance with the invention. Now, the operation of the system for a single substrate will be described.

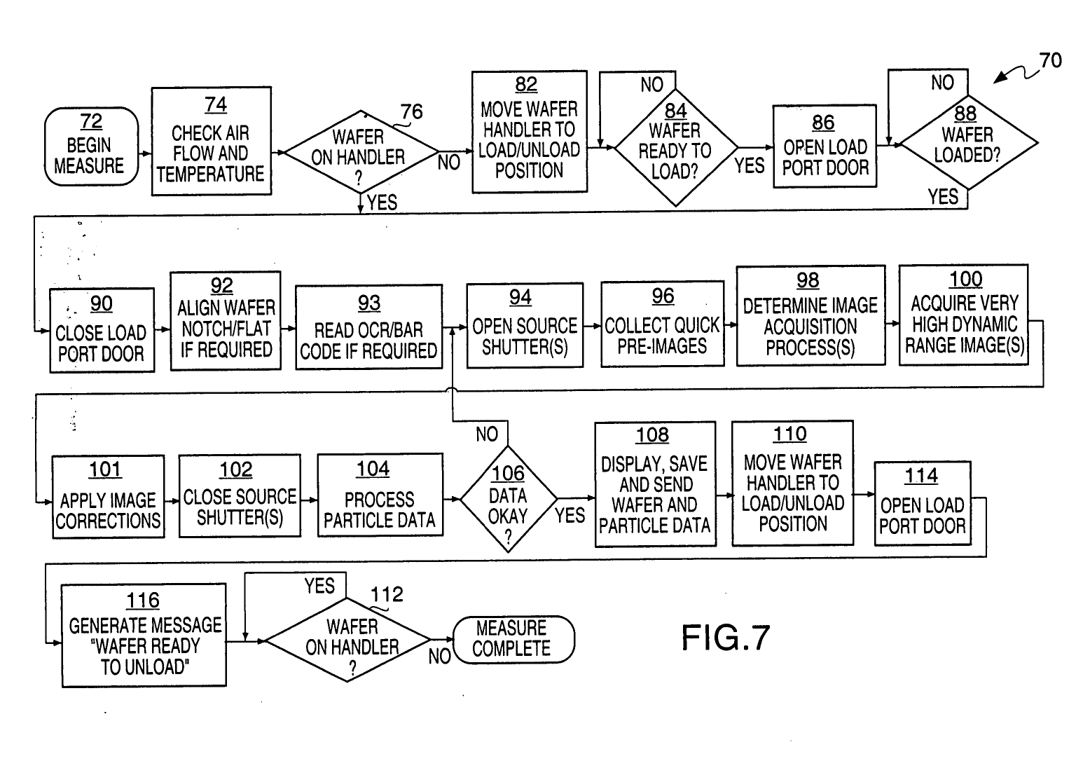

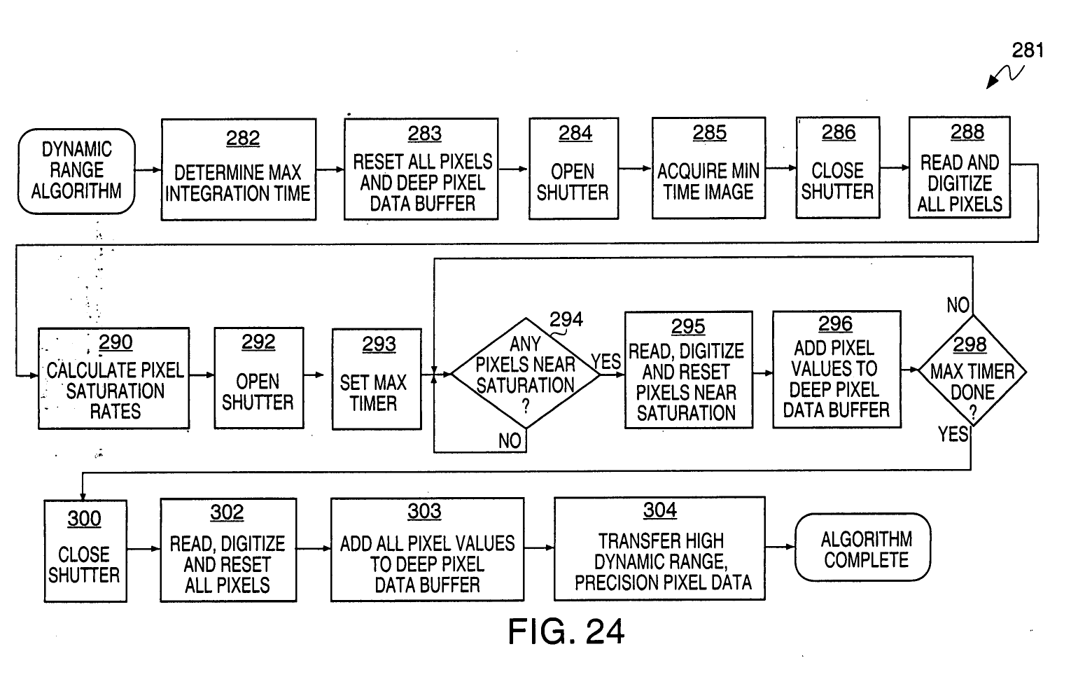

FIG. 7 is a flowchart illustrating a single substrate optical inspection method 70 in accordance with the invention. The method are the steps taken to measure and optically inspect a single substrate, such as a semiconductor wafer substrate, and those steps would be repeated for each substrate being inspected by the system. In step 74, the system checks the temperature and airflow in the enclosure and generates an alarm as necessary. In step 76, the system determines if there is currently a substrate on the substrate handler using the brightfield source 26 and frontside detector as described above. If there is currently a substrate on the substrate handler, then the method jumps to step 90. Returning to step 76, if there is no substrate in the system currently, then in step 82, the substrate handler is moved to the substrate load/unload position. Next, the system determines if a substrate is ready for loading in step 84. If there is no substrate ready for loading, the method loops back to step 84 until a substrate is ready to load. If there is a substrate ready to load, then in step 86, the load port door is opened so that the substrate may be loaded onto the substrate handler. In step 88, the system determines if the substrate has been loaded and loops until the substrate is loaded. In step 90, once the substrate is loaded onto the substrate handler, the load port door is closed and the substrate is optionally rotated to align the substrate notch/flat in step 92. If substrate alignment is not required, step 92 is skipped. In step 93, the substrate bar-code or alphanumeric pattern is optionally read. If a bar code or OCR read is required, the substrate may be repositioned to locate the bar code or alphanumeric pattern in the optimum position relative to frontside darkfield and brightfield sources. If a bar code or alphanumeric read is not required, step 93 is skipped. In step 94, the frontside and backside darkfield light, source shutters are opened and a quick pre-image is collected in step 96. In step 98, based on the pre-image, the image acquisition process(s) to be used are determined. For example, if the image has very large range in scatter levels, a random access integration method, as described with reference to FIG. 24 may be used. If the range in scatter levels is small, all pixels in the image may simply be integrated for the same time period without random access being employed. In step 100, very high dynamic range and high precision image(s) are captured by the frontside and backside photodetectors simultaneously. In step 101, image corrections are applied. These corrections include but are not limited to detector fixed pattern noise correction, illumination light level normalization, detector dark level corrections and flat field correction. In step 102, the light source shutters are closed. In step 104, the computer system (by running a particular scattering feature analysis program) may calculate the scattering feature, such as a particle, data. In step 106, the computer system compares the resultant scattering feature data to a standard to determine if the data is acceptable (e.g., sufficient clarity, sufficient brightness of scattering feature scatter, etc.). If the data is not acceptable, the method loops back to step 94 and reacquires the pre-images and the scattering feature images. If the data is acceptable, then the computer system may display, save and send the current substrate and scattering feature data to another computer system in step 108. In step 110, the substrate handler moves the substrate to the load/unload position. In step 114 the load port door is opened. A message is generated in step 116 indicating that the substrate may be unloaded from the system. In step 112, the system determines if the substrate is on the substrate handler and the method is completed if the substrate has been removed. If the substrate is still positioned on the substrate handler, then the method loops until the substrate is removed. The above method may then be repeated for each substrate being measured by the system. Now, the dual side optical inspection in accordance with the invention will be described in more detail.

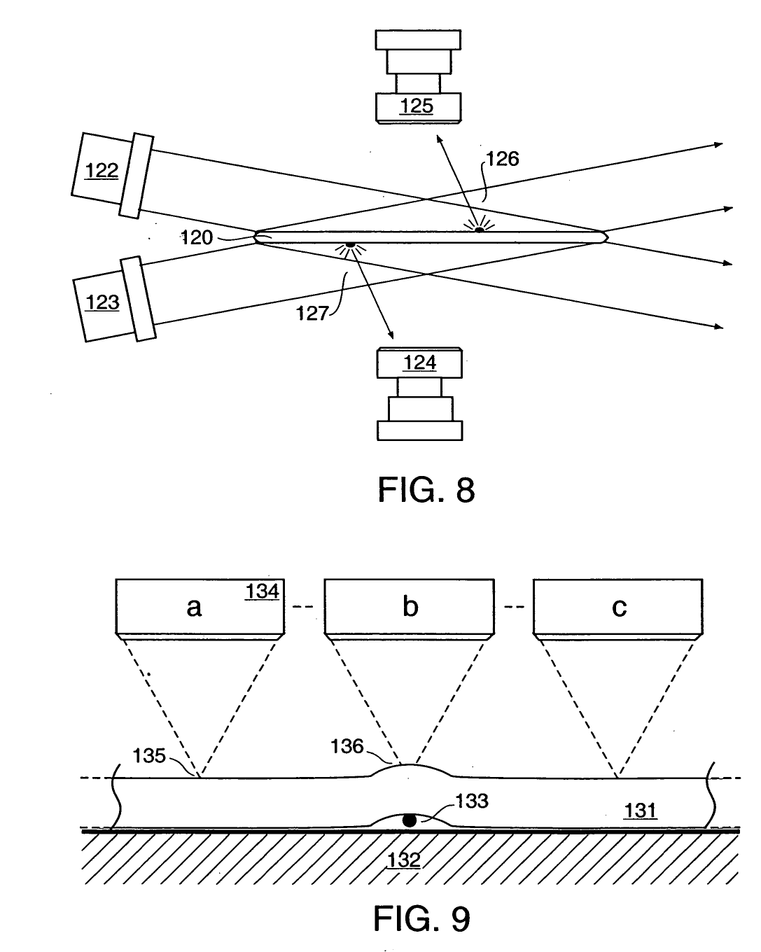

FIG. 8 is a diagram illustrating the simultaneous dual side optical inspection system in accordance with the invention wherein a substrate 120, such as a semiconductor wafer substrate, is being analyzed. As described above, the system and method in accordance with the invention may be used with various different types of substrates and is not limited to the optical inspection of any particular type of substrate. As shown in FIG. 8, the system may include a frontside illumination source 122, such as the frontside light source described above, and a backside illumination source 123, such as the backside light source described above, wherein the frontside light source illuminates the entire top surface of the substrate and the backside light source illuminates the entire bottom surface of the substrate. In accordance with the invention, both surfaces of the substrate are simultaneously illuminated. The system further comprises a backside detector 124, such as the backside detector described above, and a frontside detector 125, such as the frontside detector described above, that gather the light energy scattered from scattering features on the front and back surface, respectively, of the substrate. In particular, the frontside detector may receive scattered light energy from a frontside scattering feature 126 and the backside detector may receive scattered light energy from a backside scattering feature 127. In accordance with the invention, simultaneous front and backside scattering feature measurement is provided since both sources and cameras operate simultaneously to collect scattered light from both surfaces simultaneously so that both surfaces are measured simultaneously. The result is twofold; higher measurement throughput and detection of backside scattering features. Light scattering features on the edge bevel of the substrate, typically shaped from the flat surface to a bevel to a sharp edge, will be illuminated from the incident source, and their scatter detected accordingly. Both backside and frontside edge bevels therefore will be analyzed by the optical inspection system for scattering features.

FIG. 9 is a diagram illustrating an example of problems associated with a backside scattering feature, such as a particle 133, which may be detected rapidly by the optical inspection system in accordance with the invention. In particular, a portion of a substrate 131, such as a wafer, is shown that has a backside particle 133. In this example, the substrate is affixed to a chuck surface 132, typically a vacuum chuck, which draws the substrate firmly onto the chuck surface. A lithography system 134 is shown which prints patterns onto substrates as is well known. It is also well known that as the patterns become smaller, the depth of focus of the lithography pattern-generating lens becomes smaller. At a typical point 135, the lithography system is in position (a) and would properly focus on the surface of the substrate. However, at a point 136, the lithography system is in position (b) and there is a backside particle 133 underneath the substrate, the lithography printing lens is out of focus due to the deformation of the substrate surface caused by the particle 133. In particular, the particle deforms the surface by roughly the thickness of the particle. In general, the vacuum chuck pulls down on the substrate so that it conforms to the chuck surface and, if there is a defect on the chuck or a particle between the chuck and the substrate, the surface distorts. This distortion of the surface due to the particle becomes critical when printed patterns go much below a 0.18 um feature size. Therefore, the measurement and detection of backside particles on a substrate is becoming increasingly important to ensure high wafer processing yield. Now, the optical inspection process for an edge of a substrate will be described in more detail.

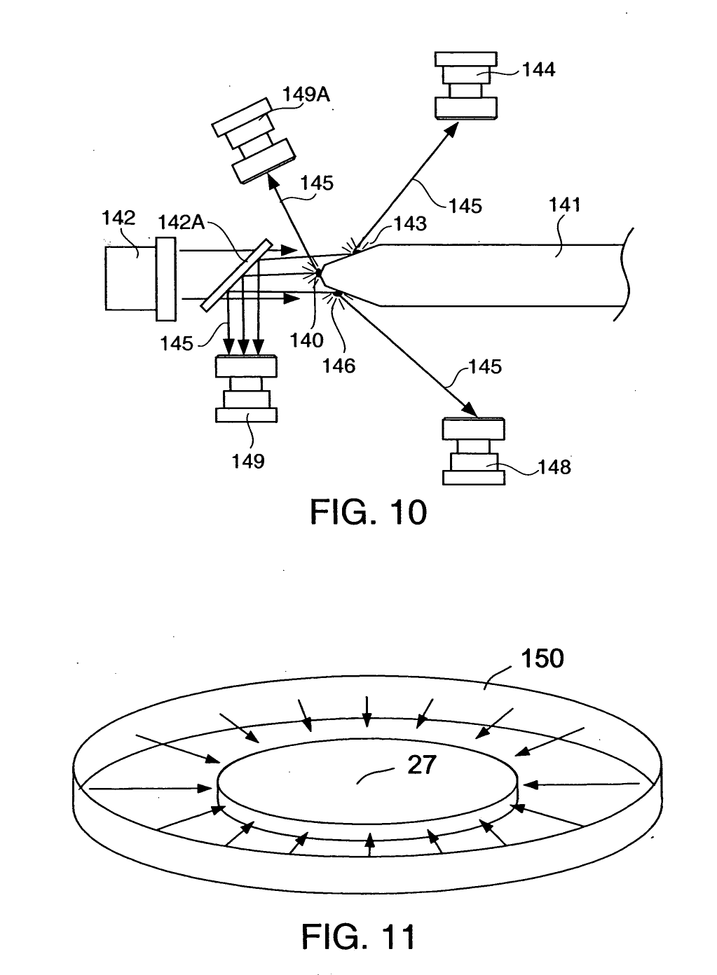

FIG. 10 is a diagram illustrating an example of the edge bevel optical inspection process in accordance with the invention. In particular, a portion of a substrate 141, such as a wafer, is shown. As shown, the substrate edge bevel has particles 140, 143, 146 adhered thereto. An edge bevel illumination source 142 directs light energy towards a beam splitter 142A. Beam splitter 142A passes light toward the substrate edge bevel and reflects light from the substrate edge toward detector 149. The transmitted light strikes particles on the edge bevel of the substrate, which scatter light 145 to a high dynamic range and high precision frontside detector 144, high dynamic range and high precision backside detector 148 and an edge detector 149 respectively, as shown so that the particles on both edge bevels and the edge of the substrate are detected in accordance with the invention. The systems shown in FIGS. 5, 5A are capable of detecting scatter from scattering features on the bevel region of the substrate using the frontside detector 144 and backside detector 148. The invention may also be implemented without the beam splitter 142A and edge detector 149. The invention may also be implemented with an edge detector 149A positioned off axis from the edge illumination source 142. In accordance with the invention, the top and bottom photodetectors 144, 148 have a field of view that includes the edge bevel of the substrate so that light scattered by the edge bevels (as well as the top and bottom substrate surfaces) are collected by each photodetector. In accordance with the invention, the edge photodetectors 149, 149A have a field of view that includes the edge and the edge bevel of the substrate so that light scattered by the edge and edge bevels are collected by the edge photodetectors. In accordance with the invention, the light source 142 could be broadband white light such as from a Xenon arc, one or more light emitting diodes (LEDs) with one or more wavelengths including one or more white light LEDs, one or more lasers with one or more wavelengths including one or more white light lasers. The light source may also be the broadband frontside and backside sources discussed above in FIG. 5. It is preferred that the complete edge of the substrate be exposed simultaneously using a ring light source as described in more detail below. The light source could also be a single beam of light and the substrate could be rotated so the entire substrate edge rotates through the source and frontside detector 144, backside detector 148 and edge detector 140, respectively, simultaneously detect scatter from scattering features on the edges of the substrate as the substrate is rotated. By synchronizing the substrate rotation with detection, the locations of edge scattering features can be easily determined. Now, an example of a ring light source in accordance with the invention will be described in more detail.

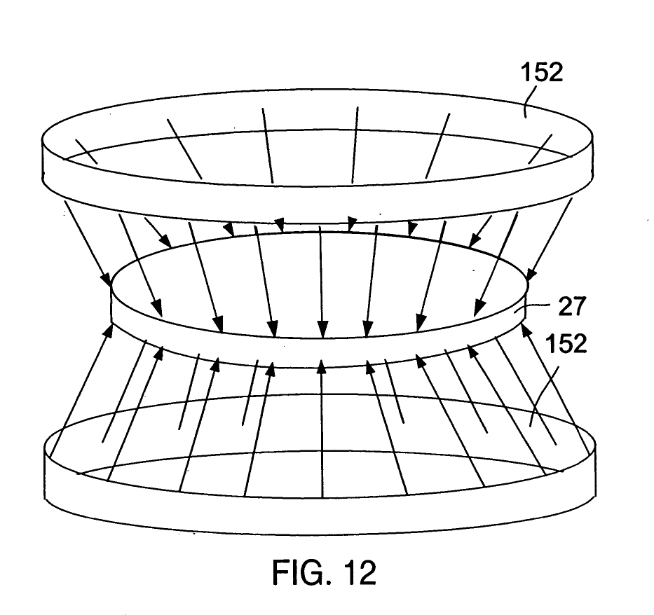

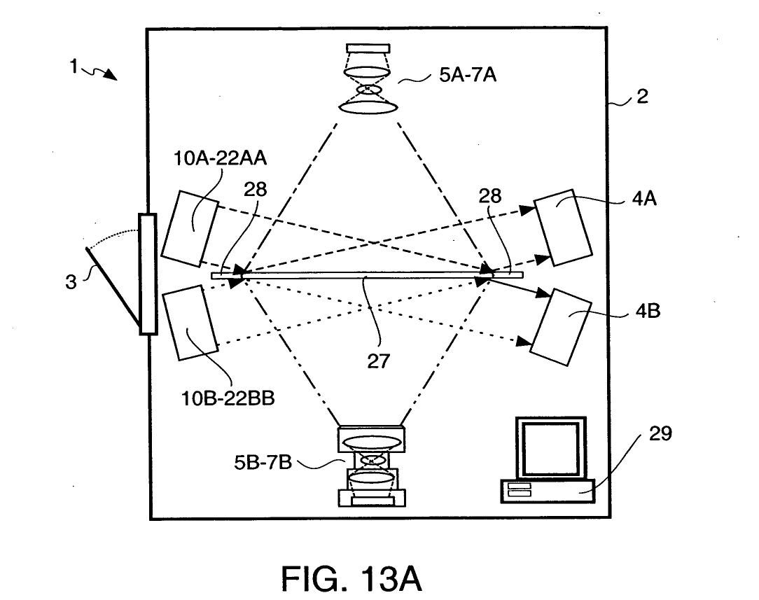

FIG. 11 is a diagram illustrating an example of a ring source illumination 150 in accordance with the invention for illuminating an edge of a substrate 27. As described above, the ring illuminator permits the entire edge of the substrate to be simultaneously illuminated and imaged so that scattering features along the entire edge of the substrate may be simultaneously measured. FIG. 12 is a diagram illustrating an example of dual ring source illumination 152 in accordance with the invention for illuminating a top and bottom edge of a substrate 27. The configuration is FIG. 12 may be user for substrate handler implementations that do not allow direct edge-on illumination. Now, one or more optical inspection system configurations will be described.

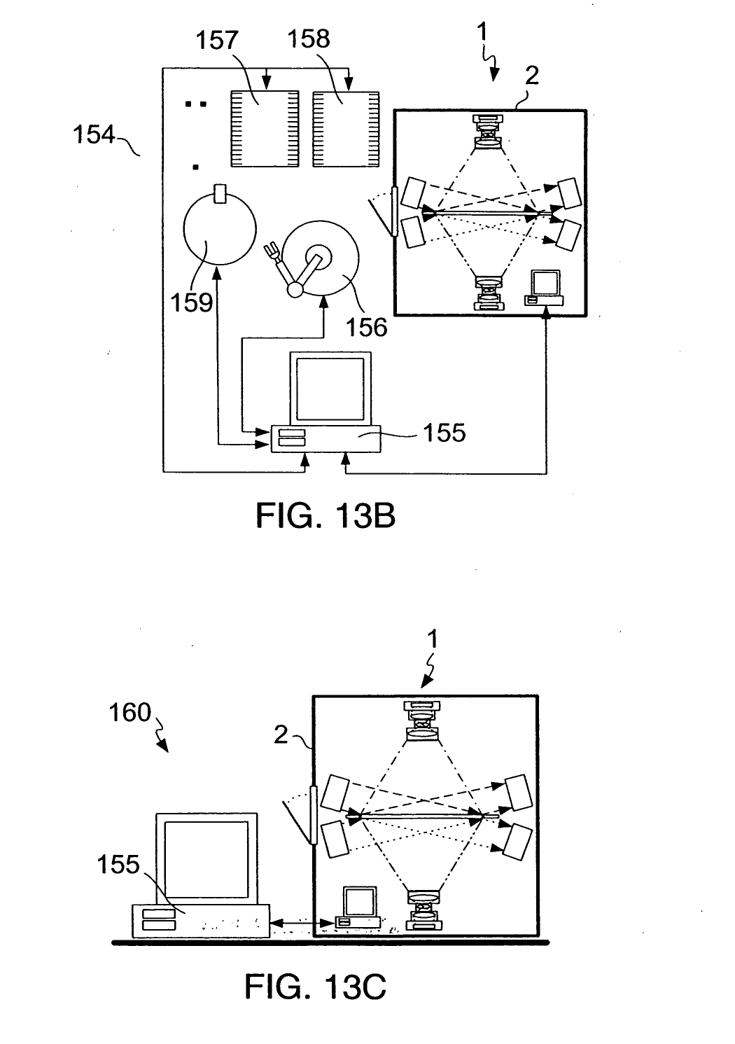

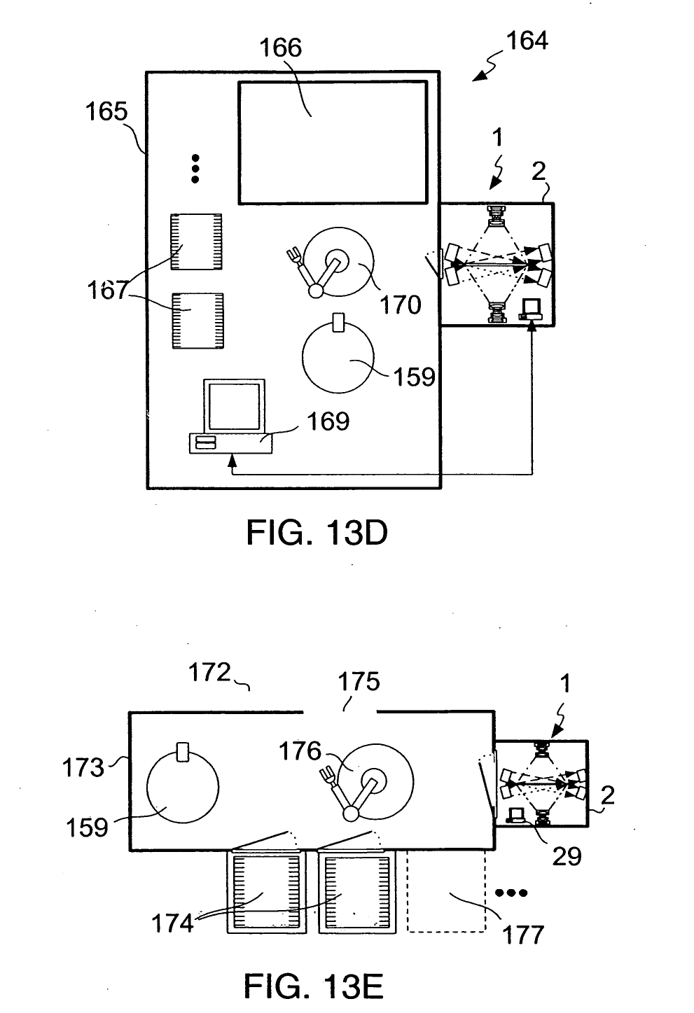

FIG. 13A is a diagram illustrating an example of the optical inspection system 1 in accordance with the invention as shown in FIG. 5. In this configuration, the optical inspection system in accordance with the invention is a sub-system, which may be incorporated into other systems within a semiconductor fabrication facility. The system shown in FIG. 13A has the same elements as shown in FIG. 5 although all those elements are not shown in FIGS. 13A-E. FIG. 13B is a diagram illustrating an example of a stand-alone optical inspection system 154 in accordance with the invention wherein the optical inspection system 1 forms a part of the stand-alone system. Stand-alone optical inspection systems in semiconductor fabrication facilities are self-contained. Operators or automatic delivery systems transport wafer substrates to stand-alone systems in substrate carriers called Cassettes, Standard Mechanical Interface (SMIF) enclosures or Front Opening Unified Pods (FOUP's). Once the substrate carrier is placed in the stand-alone system, a substrate is removed from the substrate carrier by a robot substrate handler and may be placed on an optional substrate pre-aligner 159. The pre-aligner 159 determines the center and notch/flat orientation and repositions the substrate to a pre-set orientation for subsequent pick up by the robot substrate handler and placement into the optical inspection sub-system 1 for scattering feature inspection. The external pre-aligner may not be needed if the optical inspection sub-system 1 has an internal rotating substrate handling assembly. If the substrate is not externally pre-aligned, then substrate is taken directly from the substrate carrier and placed into the optical inspection sub-system 1 where it may be internally pre-aligned. Once the inspection is completed, the substrate is transferred back to the substrate carrier. For this diagram, the individual elements of the optical inspection sub-system 1 are not shown for clarity. The stand alone system 154 comprises the optical inspection sub-system 1, a system computer and user interface 155, which may be a typical computer system of any type, that is connected to the sub-system control computer of the optical inspection system, a substrate handling robot 156, an optional substrate pre-aligner 159, a first substrate platform 157 and a second substrate platform 158 although the optical inspection system may be used with a variable number of substrate platforms. The system computer 155 may provide a graphical user interface for operator interaction. The system computer 155 may control the operation of the robot, the substrate platforms and the optical inspection system in order to perform optical inspection. In particular, the system computer 155 may provide instructions to the robot to retrieve or place substrates into the substrate platforms 157, 158, provide instructions to the robot 156 to move substrates between the optical inspection system and the substrate platforms and provide instructions to the optical inspection system to control its operation and receive data from the optical inspection system. The system computer may also be connected with a factory automation computer system and/or internal network as well as the optical inspection sub-system control computer.

FIG. 13C is a diagram illustrating an example of a bench top optical inspection system 160 in accordance with the invention. In particular, the bench top inspection system may comprise the optical inspection sub-system 1 and the system computer and user interface 155, which control the operation of the optical inspection sub-system 1 as described above. The bench top inspection system is less expensive than the stand-alone system because substrate loading is not automated. The bench top system requires a human operator to manually load and unload individual wafer substrates. The bench top system computer may be connected with a factory automation computer system and/or internal network.

FIG. 13D is a diagram illustrating an example of an optical inspection system 164 in accordance with the invention integrated with a process tool. In particular, the integrated system comprises the optical inspection sub-system 1 and a process tool module 165 interconnected through the substrate handling sub-system. The process tool module 165 may further comprise a process chamber 166, a robot 170, an optional substrate pre-aligner 159, a process tool system computer and user interface 169 (which may be any typical computer system) and one or more substrate platforms 167. In this integrated system, a substrate optionally may be measured frontside and backside by the optical inspection sub-system 1 (pre-inspection), the substrate may then immediately be inserted into the process chamber 166, a process step may be performed in the process chamber 166 and the substrate may then immediately be re-measured for front and backside scattering features added by the process using the optical inspection sub-system 1 (post-inspection). The pre-inspection is an optional part of the measurement process. In this configuration, the substrates do not have to leave the process tool for inspection, but are inspected “in-line”. The optical inspection sub-system 1 may be bolted directly to a substrate handling vacuum chamber that is also bolted to the process chamber. In this case, the optical inspection sub-system 1 is vacuum tight. Thus, the optical inspection system in accordance with the invention may be incorporated into various known wafer process systems to provide in-line inspection.

FIG. 13E is a diagram illustrating an example of an Equipment Front End Module (EFEM) 172 combined with an optical inspection system in accordance with the invention. An EFEM is a term used in the semiconductor industry for a module that incorporates an ultra clean enclosure; an air handling/cleaning sub-system to clean the air inside the enclosure; wafer enclosure platforms; a robot to transport substrates to and from the substrate carriers; an optional substrate pre-aligner; optional substrate identification bar code or alphanumeric readers; and optional metrology tools. The EFEM is a modular self-contained ultra-clean environment with integrated substrate handling. A 300 mm fabrication plant typically use EFEM's. The 300 mm substrates are typically transported in self-contained ultra-clean FOUP enclosures that are moved between process tools. Almost all fab tools in 300 mm fabs have EFEM's that open the FOUP's and limit substrate exposure to the ultra-clean air inside the EFEM. The FOUP's, in combination with EFEM's allow 300 mm fabs to operate with less restrictive air cleanliness. The modular EFEM concept is also used in 200 mm fabs, but the 200 mm substrates are not transported in FOUP's. An EFEM may have one or more substrate platforms, but two platforms are typical. The semiconductor industry has developed a detailed mechanical interface specification for mounting FOUP's. This interface is called BOLTS. An EFEM combined with an optical inspection system 172 is shown with the optical inspection system 1 attached to the end of an EFEM opposite an optional substrate pre-aligner 159. The inspection system 1 could also be mounted in a substrate carrier position 177 using the Box Opener/Loader to Tool Standard (BOLTS) interface. The inspection system 1 with an internal rotating substrate handler could also be mounted in the location where a substrate pre-aligner 159 may be located and would replace the pre-aligner function. An EFEM is typically mated to a process or metrology tool where the EFEM robot 176 loads/unloads substrate through an opening 175 to the process or metrology tool. An EFEM, however, does not have to be integrated to a process or metrology tool. An EFEM with an integrated optical inspection system could also be used in a stand-alone configuration as an optical inspection system. A stand-alone EFEM could also be used as a substrate sorter or substrate buffer unit.

In particular, the combined system 172 comprises the optical inspection sub-system 1 and an EFEM module 173. The EFEM 173 may further comprise a robot 176; one or more substrate platforms (typically a FOUP) 174; one or more extra BOLTS locations 177; fab tool substrates pass through port 175 and an optional pre-aligner 159. The integrated inspection system 1 may incorporate a rotating substrate handler, which can serve as a substrate pre-aligner; as well as substrate bar code or OCR reader capability. The defect inspection system 1 then may take the place of an existing EFEM pre-aligner, substrate identification bar code or alphanumeric reader and may be installed in place of these components. This is a very cost effective package. It does not increase overall EFEM footprint significantly yet provides additional capability of detecting frontside and backside light scattering features by the optical inspection system 1. Inspection can be either pre-process, post-process or both if the combined system 172 is mated to a fab tool. If the optical inspection system 1 does not incorporate a rotating substrate handler, then the external pre-aligner 159 is incorporated in the EFEM 173 and the optical inspection system 1 is incorporated elsewhere. The combined system 172 has the advantage that substrates do not have to leave the process tool integrated assembly for inspection, but are inspected “in-line”. The robot 176, FOUP's 174 and optional-pre-aligner 159 could also be controlled by the optical inspection system controller 29 for further cost savings Thus, the optical defect inspection system in accordance with the invention may be incorporated into an EFEM which in turn may be mated to various fab tools or may operate in a stand-alone configuration. Now, a multiple light source embodiment of the invention will be described.

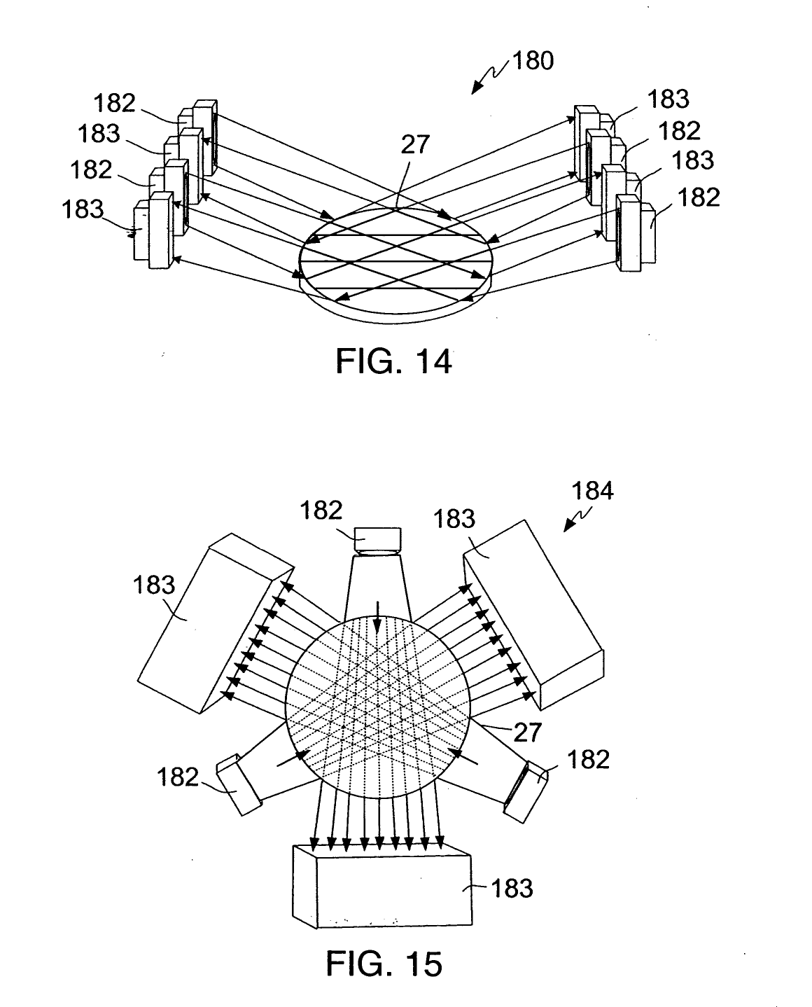

FIG. 14 is a diagram illustrating an example of a multiple light source illumination system 180 in accordance with the invention that may be used as a light source for the optical inspection system in accordance with the invention. In particular, the optical inspection system in accordance with the invention may be used with multiple light sources (more than the frontside and backside light sources shown in FIG. 5) to illuminate the entire substrate 27 frontside or backside or both sides simultaneously. Multiple sources may have improved illumination uniformity. As shown in FIG. 14, there may be multiple light sources 182 and multiple light beam dumps 183 wherein each light source corresponds to a beam dump as is well known. In the example shown in FIG. 14, the light sources are arranged so that they provide parallel stripes of light energy to the substrate. In FIG. 14, the light sources and beam dumps are located on both sides of the substrate. The multiple light source illumination system may also have all of the light sources on the same side of the substrate with all of the beam dumps on the opposite side of the substrate. There are four light sources and beam dumps shown, but there could be more or less. In contrast, FIG. 15 is a diagram illustrating another example of a multiple individual light source illumination system 184 wherein the light sources 182 and beam dumps 183 are located around the periphery of the substrate 27. There are three light sources and beam dumps shown, but there could be more or less. The number of sources and beam dumps could be increased to the point where the source could be considered a ring light. Now, more details of the light source in accordance with the invention will be described.

FIG. 16 is a diagram illustrating an example of a dark field broadband light source 190 in accordance with the invention shown in FIG. 5. The light source may comprise a light energy source 191A, parabolic light collecting reflector 191B, a dichroic mirror 191C, a beam dump 193, a shutter 194, a optional wavelength band pass filter 195, a focusing lens 196A, a homogenizer 196B, a polarizer 197, a light conditioning lens assembly 197A, beam conditioning apertures 199A, a parabolic collimating reflector 198, and beam shadow casting aperture 199B as shown. The light energy source could be any source or source combination that produces useable wavelengths from DUV through Visible. Preferably, the broadband light energy source is relatively inexpensive, generates a significant amount of DUV and visible light, has stable emission spectra over the lifetime of the source, is very intense and has a reasonable operating life. Preferably the broadband illumination intensity onto the substrate is at least 0.25 watts/inch² in order to provide adequate small scattering feature scatter signal to noise with substrate illumination time of approximately ten seconds. For example, 30 watts of illumination beam power level is needed to provide 0.25 watts/inch² onto the surface of a 300 mm substrate. Broadband light energy sources may include, but are not limited to, arc lamps such as Xenon or Mercury vapor, Metal Halide, a combination of Xenon and Mercury vapor or a combination of other gaseous materials. Broadband light energy sources may also be a combination of individual sources such as Tungsten and Deuterium that when combined produce a broad wavelength spectrum with significant DUV content. The arc lamps may also be high pressure and/or pulsed to enhance the DUV content of the light emission spectrum. The broadband light energy source could also be a combination of one or more LED's. LED's are more easily collimated than incoherent sources such as arc lamps and are relatively inexpensive. The Broadband light energy source could also be a combination of one or more lasers. DUV lasers are available and are more easily collimated than incoherent sources such as arc lamps but they are very inexpensive, especially at the high power levels needed for the invention. In accordance with the invention, the light path of the light source and its optics shown in FIG. 16 as well that shown in FIGS. 5 and 5A may be folded using, for example, a mirror.

FIG. 16A is a diagram illustrating the advantage of including DUV wavelengths in the broadband illumination spectra. FIG. 16A contains a graph showing two sets of scatter calculation data. The top data set is for wavelengths ranging from 250 nm to 700 nm (visible plus DUV), the bottom data set is for wavelengths from 400 nm to 700 nm (visible only). The data is calculated for particles ranging from 0.06 um to 0.2 um. The data clearly shows DUV greatly enhances scatter for smaller particles, with an increase of over 20× at 0.06 um. The preferred light energy source is a Xenon high-pressure arc that emits light from below 200 nm in the DUV to well past 1100 nm in the IR, such as a 1500W Perkin-Elmer 1500D-UV Cermax arc lamp.

The DUV emitted from this source is very desirable, but the IR emission is problematic. Silicon substrates become transmissive for IR wavelengths longer than 1 um. There is sufficient IR above 1 um from Cermax high pressure Xenon arc lamps to illuminate measurement chamber structures on the opposite side of the silicon substrate and the high dynamic range and high precision imaging photodetector is sufficiently sensitive in the IR to see the IR scatter from those structures through the substrate. The invention is designed so a beam dump collects illumination reflecting specularly from the substrate. The IR light passing through the substrate is not well collected by beam dumps designed to absorb specular reflection and so the transmitted IR is not absorbed causing extraneous scatter to be imaged by the photodetectors. In order to eliminate this extraneous scatter, IR wavelengths are eliminated by the dichroic mirror 191C, which allows the IR to pass through and riot reflect to the substrate surface. However, if IR wavelengths were transmitted to the substrate, IR imaging of the substrate could be performed. Substrate characteristics such as film thickness, substrate structure; thickness and uniformity could be analyzed using the IR image.

Referring again to FIG. 16, the Xenon arc source 191A radiates in all directions. In order to collect and use as much light as possible, a parabolic reflector 191B is positioned behind the source to reflect that light which would have been lost. The output of the reflector 191B directs light onto the dichroic mirror 191C. The IR wavelengths pass through the dichroic mirror while the DUV and visible wavelengths are reflected toward the substrate surface. The dichroic mirror should reflect energy from the DUV through as much of the visible wavelengths as possible. The DUV and visible wavelengths are reflected to the shutter 194. The beam intensity is reduced by more than 50% after reflection from the dichroic mirror due to removal of the IR wavelengths, and so the shutter does not need to absorb as much energy if it is placed after the dichroic mirror. The shutter could also be positioned between the source and the dichroic mirror. The output of the shutter is directed to an optional wavelength band pass filter assembly 195 that limits the transmitted wavelength range. This filter assembly can have one or more wavelength band pass filters that can be individually selected. By limiting the illumination wavelength range, wavelength dependent particle scatter can be analyzed to discriminate particle material properties and sizes. The output of the wavelength band pass filter assembly is directed to a focusing lens assembly 196A. The focusing lens collects and optimally focuses the beam into the homogenizer 196B. The focusing lens assembly 196A has good transmission in the DUV. The homogenizer randomizes the beam intensity removing hot spots and structure in the beam. Arc sources, such as used in this invention, have convection currents in the arc gas region causing the beam to shimmer with a frequency of a few hertz. The homogenizer eliminates this shimmer. The output of the homogenizer can be considered a uniform source. The homogenizer 196B has good transmission in the DUV. The light that exits the homogenizer passes through an optional polarizer 197, which has good transmission in the DUV. The polarizer may be needed for some types of samples, but not all samples. The beam conditioning lens assembly 197A collects the output of the homogenizer and conditions the light to make the output of the homogenizer look more like a point source to the collimating parabolic reflector 198. The output of the light conditioning lens assembly is directed to the collimating parabolic reflector. A parabola will convert a point light source into a collimated beam when the point source is at the focal point of the parabola. Since the beam conditioning lens assembly 197A effectively translates the output of the homogenizer to a point source at the focal point of the parabolic mirror 198, the light reflected from the parabolic mirror is essentially collimated. The output of the beam conditioning lens assembly passes through one or more beam conditioning apertures 199A. These apertures remove light exiting the homogenizer that would be poorly collimated by the parabolic reflector 198. The light reflected from the parabolic reflector 198, passes through one or more shadow casting apertures 199B. The apertures 199B cast a shadow onto the substrate plane such that the edges of the shadow correspond to the edges of the substrate with the shadow falling outside the substrate. The intensity roll off of the shadow should be very steep (preferably 1 part in 1000 roll off within 1 mm of the edge) for the portion of the substrate edge facing the illumination beam. The most critical region is the edge directly facing the illumination beam. The shape of the shadow casting apertures 199B is elliptical. Thus the substrate alone is illuminated with uniform intensity collimated light, but light beyond the substrate edges is shadowed.

The light source, composed of elements 191A-191C, 193-199B, should produce an illumination light beam with reasonable spectral uniformity (95%), spatial uniformity (50%) and collimation (+/−2 degrees spread). Small scattering feature scatter varies roughly as 1/λ⁴, so spectral uniformity is desired to allow detection of the same size light scattering features across the entire substrate. Tight collimation is desired as a beam angle variation of +/−2 degree from the nominal illumination angle can change 0.10 um particle scatter by +/−50%. Collimation sensitivity is even greater for angles over 75 degrees. The illumination beam preferably should also not extend beyond substrate edges and is elliptical in shape as discussed further in FIG. 16C below. The light source impinges on the substrate 27 at an angle less than normal incidence, preferable between 50 and 75 degrees from normal. Angles greater than 75 degrees cause significant reduction in light scattering feature scatter to the detectors while angles less than 60 degrees increase the background surface scatter more than scattering feature scatter.

FIG. 16B is a diagram illustrating the importance of illumination angle of incidence in accordance with the invention. FIG. 16B contains two graphs showing scatter as a function of illumination angle of incidence. The graph on the left shows scatter from a 0.1 um particle illuminated by 200 to 700 nm wavelength light at angles of incidence ranging from 45 to 89 degrees from normal incidence. The scatter intensity falls off by about a factor of 8 from 45 to 75 degrees, but falls much more quickly below 75 degrees. The graph further shows that the closer the illumination angle is to normal incidence, the higher the particle scatter. The light reaching the detector, however, is also composed of scatter from the substrate that the particle is resting on. The graph on the right takes into account light reaching the detector from a substrate with roughness equivalent to a typical polished silicon wafer substrate. For illumination angles below 60 degrees, the surface scatter as a function of incidence angle increase more quickly than 0.1 um particle scatter. The graph on the right shows 0.1 um particle scatter divided by surface scatter as a function of the angle of incidence. From the graph, an optimum illumination angle exists at 62 degrees from normal. It is thus desirable to increase the absolute scatter signal level while keeping the surface scatter below the particle scatter and the preferred illumination angle is between 50 and 75 degrees. Calculations with other particle sizes, wavelength ranges and substrate materials lead to a similar conclusion.

FIG. 16C is a diagram illustrating the advantage of elliptical beam illumination in accordance with the invention. In particular, the top figure shows a darkfield broadband light source 186 with a circular beam shape 187A directed towards substrate 27 and the bottom figure shows a darkfield broadband light source 186 with an elliptical shape 187B directed towards substrate 27. As shown, the circular beam 187A overflows the substrate 27 in front 188 and back 189, whereas the elliptical beam 187B is limited to only the substrate surface. Illumination overflow in back of the substrate is tolerable since the back of the substrate edges face away from the illumination (no edge scatter) and beam dumps can absorb the overflow. Optimized beam shapes are desired to minimize illumination that may contribute to unwanted scattered light. Optimal beam shapes can be determined for any substrate size or shape and the optical beam in accordance with the invention may be appropriately shaped.

FIG. 17 is a diagram illustrating an example of a dark field broad band light source 190B in accordance with the invention shown in FIG. 5A. FIG. 17 is identical to FIG. 16 up to and including the homogenizer 196B. In particular, FIG. 16 is a shadow casting illumination system, while FIG. 17 is an image relay illumination system. The beam is conditioned as per FIG. 16 through the homogenizer. The output of the homogenizer is uniform spatially and spectrally. An image aperture 192A is located immediately after the homogenizer. This aperture defines the shape of the beam that falls on the substrate 27 and is elliptical in shape. An optional polarizer 197 is positioned after the image aperture. Image relay lens assembly 192 in combination with spherical mirror 192B directs an image of the image aperture onto the substrate. The spherical mirror acts not only as a mirror but also as a reflecting lens, which collimates the aperture image. A flat mirror followed by a collimating refractive lens could optionally replace the spherical mirror. This illumination system has the advantage that by changing the image aperture, the illumination area can be easily modified. For example, illumination of a computer disk drive substrate (a disk with a hole in the middle) could be implemented using an image aperture shaped like an elliptical washer.

FIG. 17A is a diagram illustrating an example of a dark field broadband light source 190C in accordance with the invention. This source is similar to source in FIGS. 16 and 17, except the source reflector 191B is elliptical and therefore the output of the reflector is focused. The beam reflected from the dichroic mirror 191C is converging and focuses at the input to the homogenizer 196B without the need for the focusing lens assembly 196A in FIGS. 16 and 17. The focused source has the advantage of simpler optics, but the dichroic mirror is less efficient due to the spread in angles of incidence. Now, the collection optics for gathering the scattered light from the substrate and imaging it onto the detectors will be described in more detail.

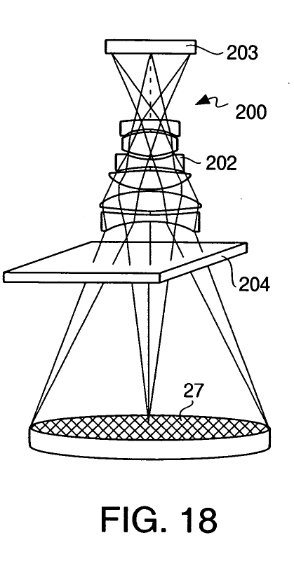

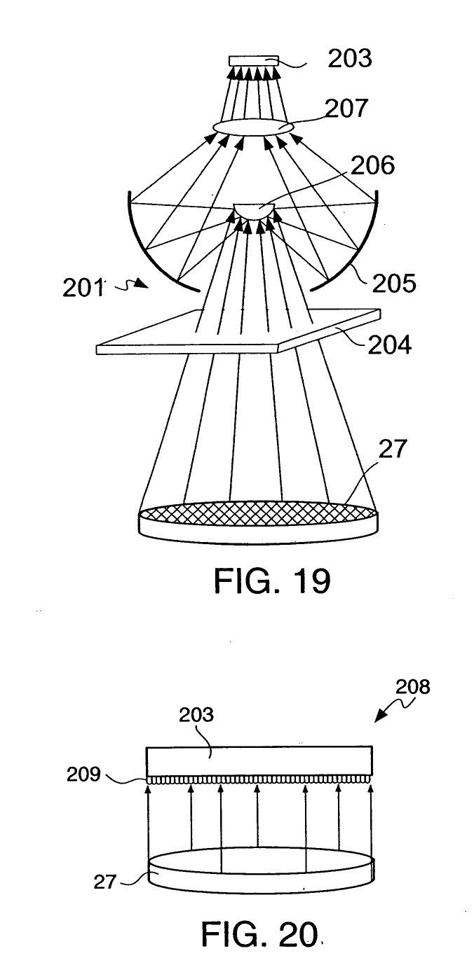

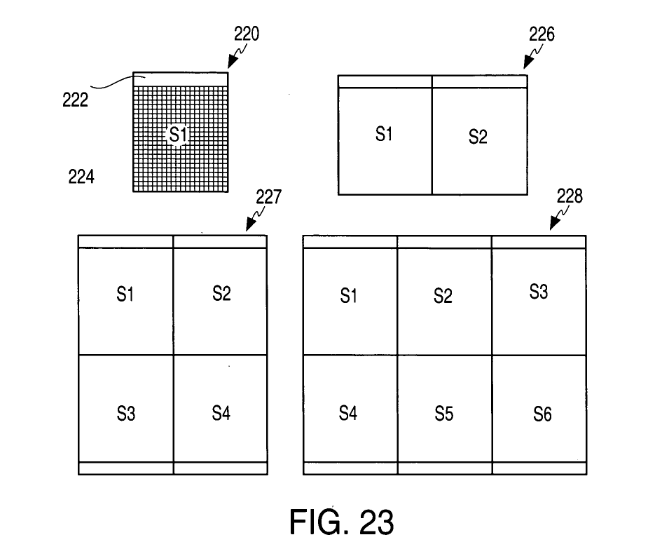

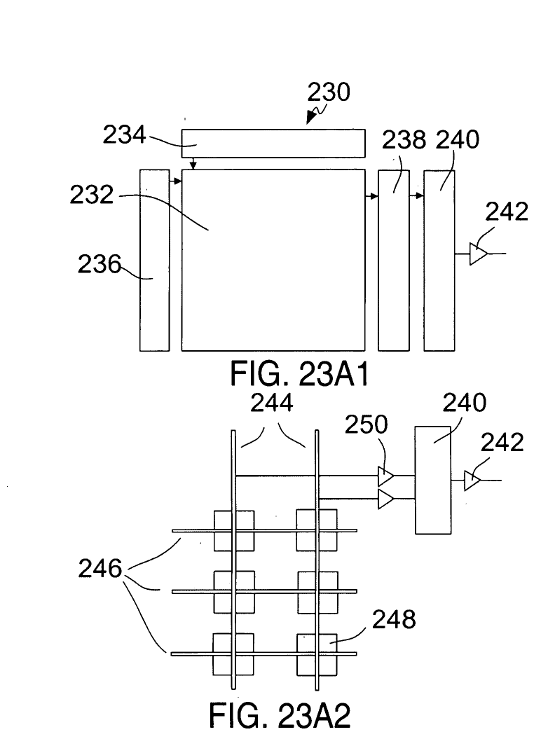

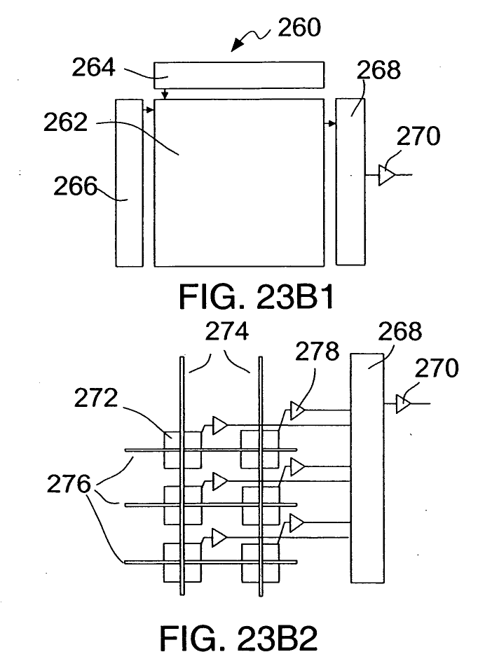

FIG. 18 is a diagram illustrating an example of collection optics 200 in accordance with the invention. The collection optics 200 may comprise a high numerical aperture imaging lens 202 and an optional polarizer 204 as shown. The lens 202 is shown as 6-element inverted telephoto design, however, the lens could be a 5-element inverted telephoto, a 6 element non-symmetric inverted double gauss, a 6 element symmetric inverted double gauss, a 6 element modified gauss, a 4 element modified tessar or any other lens design that transmits wavelengths from 200 to greater than 550 nm, has a small blur spot, low distortion and high uniform numerical aperture (NA) across the image. The lens 202 relays an image of the substrate 27 onto the high dynamic range and high precision detector 203. The size of the relayed image is dependent on the size of the detector chip. For example, if the detector were the same size as the substrate, the image magnification would be 1:1. The collection optics gathers the scattered light from the substrate 27 and images the scattered light onto the detector 203 as shown. In accordance with the invention, the light path of the collection optics shown in FIG. 18 as well as the other examples of the collection optics (including those shown in FIGS. 5 and 5A) may be folded using, for example, a mirror. FIG. 19 is a diagram illustrating an alternative example of collection optics 201 in accordance with the invention. Collection optics 201 is a modified Schwarzschild lens. Schwarzschild lenses have very wide spectral transmission, very low chromatic aberration, but suffer from spherical aberration. The optics components 205 and 206 comprise the reflecting Schwarzschild lens portion as shown. The refractive lens 207 is a relatively simple lens that corrects spherical aberrations as shown. Because lens 207 is a simple lens it can be inexpensive and have very good optical transmission from 200 to at least 700 nm. Together the modified Schwarzschild collection optics reflect and transmit wavelengths from DUV through visible, have a small blur spot, low distortion and high uniform NA across the image. The collection optics gathers the scattered light from the substrate 27 and images the scattered light onto the detector 203 as shown. FIG. 20 is a diagram illustrating another embodiment of the imaging system 208 in accordance with the invention that uses micro lenses for each detector pixel. In particular, the imaging optics 209 may comprise micro lenses. Micro lens arrays can provide single pixel to multi pixel imaging at the detector 203. Micro lenses can be used with no magnification, with magnification or with de-magnification. Micro lens arrays will collect more light, with better resolution and shorter working distance than a separate single imaging lens assembly. The Micro lens arrays can be fabricated as part of the detector array or mounted separately. The sensor can be either a mosaic or monolithic detector. Mosaic detectors are discussed further with regard to FIG. 23 below. A larger sensor size allows the working distance from the detector to the substrate surface to be reduced enabling a more compact detection system for the integrated system configuration. The collection optics gathers the scattered light from the substrate 27 and images the scattered light onto the detector 203 as shown.

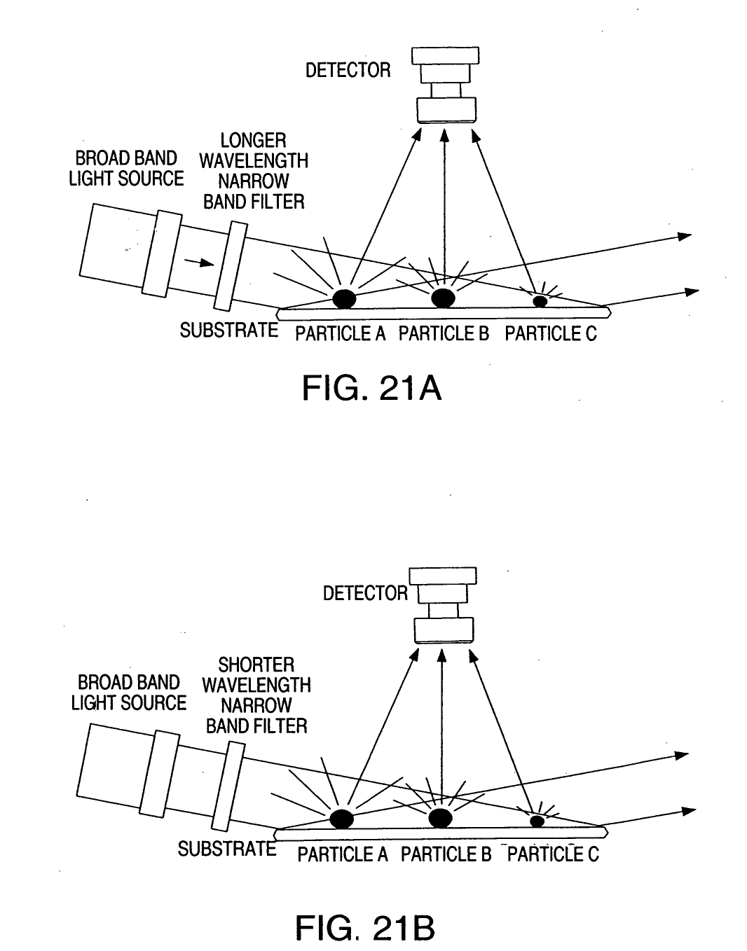

FIG. 21A is a diagram illustrating light scattering that occurs using longer wavelength light and FIG. 21B is a diagram illustrating light scattering that occurs using shorter wavelength light in accordance with the invention. In accordance with the invention, the wavelength of the light that illuminates the surface of the substrate may be altered using wavelength band pass optical filters during the illumination of the substrate surface. In other words, as the surface is being measured and inspected, the transmitted wavelengths of the light source through the wavelength band pass filters is changed from a first wavelength range to a second different wavelength range. More wavelength ranges are also possible. As shown in FIGS. 21A and 21B, scattering feature scatter is a function of scattering feature size, scattering feature material properties and wavelength. For example, Particle A is larger and once the illuminating wavelength is roughly the same as the particle's radius as in 21A, shorter wavelengths have less effect on the scatter intensity than a smaller particle. Particle C is the same material as Particle A, but is smaller and in particular smaller than both longer and shorter illumination wavelengths, so when the wavelength is shortened in 21B, the smaller particle C scatter increases much more proportionately to the larger particle A. Therefore, by scanning the wavelength of the light source from a longer wavelength to a shorter wavelength, smaller and smaller particles will be enhanced and relative particle sizes can be determined independently of particle material properties. Particle B is the same size as Particle A, but is of material with different optical properties. When the wavelength is longer, the scatter for Particle B is less than Particle A because of its optical properties. When the wavelength is shorter, Particle A scatter increases more than particle B and so differences in material properties can be determined. As the wavelength is reduced, it will appear that some particles are getting brighter faster and some particles will scatter in proportions higher or lower depending on material properties. Therefore, in a preferred embodiment, the light source may include wavelength band pass selectable filters that are controllable so that the wavelength of light can be adjusted during the illumination of the substrate. The wavelengths offer additional information about the scattering particle and will aid in classification of particle sizes and material properties of the particle. Now, the detector of the optical inspection system scatter sensor in accordance with the invention will be described in more detail.

In a preferred embodiment, as described above, a charge injection device (CID) sensor is utilized and provides a number of advantages. In particular, the CID sensor pixels are randomly addressable and consist of two MOS capacitors whose gates are separately connected to rows and columns. The pixels are addressed by changing voltages on individual row and column lines such that the voltage profile at the single pixel that the selected row and column intersect cause the charge in the pixel to be read out. In comparison, CCD detectors have column capacitors used to integrate charge and row capacitors to shift the charge from a pixel to its neighbor and then to its neighbor's neighbor and so on until the charge is shifted to the end of a row where it is sensed. This “bucket brigade” is inherently lossy and reduces the collection efficiency and signal to noise. Also, to read a single CCD pixel, a whole row, column or array must be read and the read process clears the charge in the pixel, hence the read is called “destructive”.

The readout process for a CID sensor is non-destructive. In particular, readout is accomplished by sensing the charge when transferring the charge from the column photon collection MOS capacitor to the row MOS capacitor. The charge has not been destructively read, instead it is held in the row capacitor. After this nondestructive signal readout, the charge can be moved back to the column capacitor for further integration or can be selectively cleared by injecting the charge into the silicon substrate. By suspending substrate charge injection, the user can selectively integrate pixels for independent time intervals and can thus view the image with optimum pixel per pixel exposure. Exposure can range from milliseconds to tens of minutes. By reading bright pixels quickly enough that they do not saturate and letting less bright pixels continue to integrate, an image can be acquired with a very high dynamic range orders of magnitude greater than CCD's. Continually reading, summing and clearing the brighter pixel values as necessary to avoid pixel saturation increase the dynamic range of the sensor. The sum of many pixel reads near saturation will be much greater than the maximum value of a pixel from a single read. The summing must be done in accumulating buffers with greater bit depth than the analog to digital (A/D) converter (typically 14 bits) used in the CID high dynamic range and high precision detector. Preferably the accumulating buffers are 32 bits. The digital resolution of the A/D converter determines the resolution of the sum of conversions. Thus if 16 near saturation samples are taken and added together, the total is close to 16 times the saturation value, or about 4 bits of additional magnitude. Because the lower order bits are not truncated, the precision in this example is also increased by 16 times.

CID sensors also have individual capacitors on each sensing pixel so charge is well isolated and charge in saturated pixels cannot leak into neighboring pixels. Charge leakage from saturated pixels into neighboring pixels is called blooming. CCD arrays require special technology to suppress blooming (called anti-blooming), but are not used in high sensitivity low noise applications because blooming suppression reduces detector sensitivity. Since CID's have no blooming, they can have higher dynamic range than detectors having blooming. FIG. 22 shows the advantage of anti-blooming capability in accordance with the invention. The top row of images was taken with a CID anti-blooming detector. Saturated pixels are white. The bottom row of images was taken with a CCD detector that exhibits blooming. Blooming can cause neighboring pixels to have excess charge leading to those pixels saturating, and can also cause vertical streaking both above and below saturated pixels. This vertical streaking is evident starting in the bottom row of images with 1 sec exposure. The streaking gets progressively worse as exposures increase to 10 and 60 seconds. The 60 sec exposure CCD image has lost significant image data due to blooming. In the 60 sec exposure CID image, pixels are saturated, but neighboring pixels are unaffected. The CID used for this data did not have pixel summing capability and so does not show the dynamic range of the invention. CCD detector blooming can be reduced either through extra circuitry on the detector or by elaborate clocking of the CCD chip both of which reduce sensitivity. Now, the dithering process in accordance with the invention will be described in more detail.

In accordance with the invention, the system may dither the images generated during the inspection process so that a higher pixel resolution and therefore defect detection sensitivity is achieved. Increasing the pixel resolution reduces the area on the substrate that each pixel detects thereby decreasing the background scatter relative to the defect scatter and increasing signal to background scatter noise, which can further improve the defect detection sensitivity of the invention. Dithering in accordance with the invention may be implemented in a number of different ways including sub-pixel dithering and multi-pixel dithering. Both of these techniques will be described below in more detail. Sub-pixel dithering and multi-pixel dithering can be achieved using X/Y mechanical devices to reposition various elements of the imaging path including the substrate, imaging optics, array detector or the imaging optics plus array detector assembly. The X/Y mechanical devices can include mechanisms driven by servomotors, stepper motors, electromagnetic actuators and piezoelectric actuators. Because mechanical motion should be as fast as possible to maximize image acquisition throughput, X/Y motion of the least massive element of the imaging path is preferred. Typically this is the array detector, but could also be the imaging lens.

Sub-pixel dithering is a pixel sub stepping technique used to improve an image detector's spatial resolution. In operation, multiple images are acquired in X/Y steps smaller than the pixel size and then processed to achieve resolution comparable to the X/Y step size. During an image acquisition, the image is repeatedly physically shifted along each pixel axis by sub pixel amounts, then these images are combined to obtain a single higher spatial resolution image having a smaller pixel size equal to the dithering step size using a reconstruction or de-convolution method. Dithering enhances the spatial resolution of the Point Spread Function (PSF) at the detector from a point source at the object plane. The multi-pixel dithering can be used to reduce the effect of flat-field errors. In particular, large dithers (of tens of pixels) can be used for this purpose. Furthermore, dithers greater than one or two pixels can be used effectively to eliminate detector chip defects such as hot-pixels and bad columns, thus allowing for a higher signal-to-noise by combining data taken with integer pixel offsets.

The defect detection sensitivity of the invention can be further improved by increasing the CID quantum efficiency (QE). Increased QE increases photoelectrons without increased read noise. This improves overall signal to noise. FIG. 22A is a chart illustrating the QE of a typical CID detector in accordance with the invention. FIG. 22B is a chart illustrating typical increased QE for back-thinned CCD's. Back thinning is a process where the detector chip is thinned to the point where photons are detected through the backside of the detector as opposed to more common frontside detection. Back thinning exposes the entire photo collection area and improves photon detection. The QE for a back-thinned detector can be increased from a peak of roughly 35% to over 85%. A thin film coating can be added to the backside to further enhance DUV performance of back-thinned devices. As described above, CID sensors can be back thinned like CCD's to significantly improve quantum efficiency (QE), making CID QE comparable to CCD's and potentially exceeding CCD's in the DUV. In accordance with the invention, it is also possible to use sensors, which are not back thinned. Optimizing films on the front of the detector chip and using micro-lenses above each pixel can also improve QE.

The defect detection sensitivity of the invention can be further improved by increasing the number of detector pixels, which also reduces the area on the substrate that each pixel detects thereby decreasing the background scatter relative to the defect scatter, and increasing signal to noise. The number of pixels can be increased by reducing pixel geometry, hence squeezing more pixels onto the same size chip. Currently CID chips have relatively large pixel area compared to CCD's and can readily be reduced. The number of pixels can also be increased by stitching mask patterns to get bigger chip sizes, hence more pixels. Pixel count can also be further improved using butt-able Mosaic sensors.

FIG. 23 is a diagram illustrating an example of a detector in accordance with the invention that includes one or more CID chips in a Mosaic configuration. In particular, a CID sensor chip 220 is shown which has pixel read circuits 222 and an array of pixels 224. Butt-able chips are typically designed so pixel support circuits on the chip are at one end of the chip. A mosaic of two sensor chips 226, a mosaic of four sensor chips 227 and a mosaic of six sensor chips 228 are shown. The detector used by the optical inspection system in accordance with the invention may use a mosaic of sensor chips wherein the number of sensor chips that are part of the mosaic depends on the particular application. For example, a larger substrate size may dictate a larger mosaic of sensor chips. A mosaic image sensor configuration increases the number of pixels cost effectively (which enhances the spatial resolution, thus increasing signal to noise ratio), by connecting smaller, less expensive single photodetector chips in a coordinated manner equivalent to a large (more expensive) array sensor. Components that would have been in separate chips can be integrated on the same focal plane by using butt-able image sensors.

FIGS. 23A1 and 23A2 are diagrams illustrating a typical CID array sensor 230. The typical sensor may comprise a pixel array 232, column select circuits 234 to select a column of pixels to be read, row select circuits 236 that select a row of pixels to be read, column pre-amplifiers 238 that amplify the signal read out from an addressed pixel, a multiplexer 240 that selects and routes the outputs from the pre-amplifiers to a single output amplifier 242 that amplifies and buffers the output from the multiplexer. FIG. 23A2 shows more detail of the sensor including one or more column lines 244, one or more row lines 246, a pixel 248 and one or more column pre-amplifiers 250. In operation, light is absorbed by the pixel, which stores the photon induced charge in a capacitor. To read the charge for a particular pixel, the particular row and column line are driven high (since the combination of one row line and one column line will uniquely address only one pixel) so that the charge is read out from the pixel. The charge read out from the pixel is amplified by the column pre-amplifier and then further amplified by the output amplifier 242. Now, a sensor in accordance with the invention will be described.

FIGS. 23B1 and 23B2 are diagrams illustrating a CID sensor 260 having integrated pixel pre-amplifiers in accordance with the invention. The sensor may comprise a pixel array 262, a column select circuit 264, a row select circuit 266, a multiplexer 268 and an output amplifier 270. These elements operate as described above for the conventional CID sensor. FIG. 23B2 illustrates more details of the sensor 260 wherein the sensor may further comprise a pixel 272, one or more column select lines 274, one or more row select lines 276. These also are similar to the conventional CID sensor described above. The sensor in accordance with the invention however, has a pixel pre-amplifier 278 associated with each pixel of the detector array so that each pixel's signal is individually amplified. The CID read noise and read rates are significantly improved by adding individual pre-amplifier circuits at each pixel in the array. Currently CID pre-amplifiers are shared by columns as shown in FIG. 23A2 above. As a pixel is read in a typical CID sensor, the column pre-amplifier is connected to the output amplifier. The length of the signal line from the pixel to the column pre-amplifier limits the read rate due to capacitive loading and also allows noise to be coupled into the signal line ahead of the pre-amplifier. In the sensor in accordance with the invention, a pre-amplifier is placed at each pixel to boost the signal significantly relative to pixel read noise, making this improved CID comparable to CCD noise levels. The pixel pre-amplifier also drives the signal line capacitance better allowing much faster read rates while maintaining low noise. The result is the sensor in accordance with the invention has very low read noise, hence more sensitive to smaller charge on the pixel, which in turn results in a wider dynamic range for each pixel. CID's with these improvements are comparable to existing detector technology noise, read rates, QE, pixel density and anti-blooming performance, however, no single detector is capable of this concurrent combination of capabilities

In addition, CID's have non-destructive and random access pixel reading capability. These aspects of CID's enable a significant increase in dynamic range. CID dynamic range can be enhanced over CCD's by varying the light collection time from pixel to pixel based upon the real time observation of local image intensity. This approach optimizes the signal/noise ratio for each pixel. Intensely illuminated pixels can be digitized, the digital data accumulated in a buffer and then the pixel reset for multiple short exposure periods while weakly illuminated pixels are allowed to integrate for longer exposure periods. This technique, called “Random Access Integration”, allows for unprecedented linear dynamic range and precision approaching ten orders of magnitude (30 bits) using an exposure period equal to the exposure required for the weakest pixel intensity. This process will now be described in more detail with reference to FIG. 24.

FIG. 24 is a flowchart illustrating a random access integration method 281 in accordance with the invention. This method may be carried out by software that may reside on the CID controller or the computer system that controls the CID controller. In step 282, a maximum exposure time for the detector is determined. The maximum exposure time is based on user input for the smallest particle size, surface roughness of the substrate or a user selected time and is typically 1 second or more. In step 283, all detector pixels are reset and the entire deep pixel data buffer is reset to zero. The deep pixel data buffer is an array of 32 bit long computer memory locations with the number of 32 bit memory locations equal to the number of detector pixels. The memory locations need to have long bit length to accommodate the high precision of the detector's summed digitized results. The resulting accumulated data is high dynamic range and high precision. In step 284, the light source shutter is opened and an image is acquired in step 285 for a pre-determined minimum (Min) period of time. The Min time is the exposure time before the brightest pixels in the image saturate. This time could be milliseconds or less, but may be much longer for low reflectivity substrates with small particle defects. In step 286, after a Min Time exposure, the shutter is closed. In step 288 all pixels are read and digitized. In step 290, the pixel saturation rates are calculated for each pixel based on the pixel values acquired in step 288 for the Min exposure time in a well-known manner. The saturation rate indicates the time interval before which a pixel must to be read to avoid pixel saturation. In step 292, the light source shutter is reopened and the maximum (Max) exposure time is set in step 293 to a time period determined in step 282. In step 294, the pixels saturation rates are evaluated for any pixels that are near saturation. If no pixels are near saturation, the method loops. When pixels are near saturation, those pixels are read, digitized and reset in step 295. In step 296, the digitized pixel values are added to the respective accumulated values in the deep pixel data buffer. As pixels near saturation, they are read and summed as often as necessary to avoid saturation. In step 298, the method determines if the Max timer has completed. If the Max timer has not completed, the method loops to step 294. If the Max timer has completed, then the shutter is closed in step 300. In step 302, all pixels are read, digitized and reset. In step 303, all of the digitized pixel values are added to the deep pixel data buffer. In step 304, the high dynamic range and high precision pixel data buffer is transferred to the control computer 29 so the data may be analyzed further. The total exposure time for all pixels is roughly the Max time, but the bit depth of pixels that nearly saturated is extended beyond the A/D digitizer resolution (typically 14 to 16 bits). If pixels are read and summed often, the extended bit depth could approach 30 bits. The dynamic range and precision method described in FIG. 24 is designed to provide accurate particle size measurement even under extreme conditions. An approach that reduces the number of pixel reads is to first establish pixel saturation rates as above. The pixels that would saturate quickly have their final values calculated. These pixels would have large dynamic range, but not high precision. The pixels with calculated final values would not be read again, thus allowing intermediate brightness pixels to be serviced and accumulated. The resulting data in the deep pixel data buffer would contain large dynamic range pixels, but the brightest pixels would have precision limited by the digitizer. Intermediate pixels would have extended precision. Other methods are possible. With a high dynamic range imager, one can observe a very weak scatter signal next to very high reflecting surface. This is analogous to observing a star next to the Sun in the daytime sky.

The dynamic range capabilities of the CID sensor in accordance with the invention are desirable for the optical inspection system. In particular, the system will be analyzing particle defects on bare, film and pattern substrates. Current commercial particle detection technologies are limited in particle size detection range per substrate read because of limited sensor dynamic range. The dynamic range of current defect inspection system sensors (<10e+4) requires users to choose the particle size range of interest and particles outside the range (larger or smaller) are “invisible”. By re-setting ranges and re-reading the substrate other sizes can be re-measured, but at the expense of a significant increase in measurement time. Bare substrates have moderate reflectivity (approximately 0.3). Film substrate reflectivity can range from very low (0.1) to very high (0.99) depending on the film. Particle scatter is modified by the surface reflectivity and so film reflectivity variation adds to the dynamic range required. Pattern substrates are particularly challenging as pattern scatter can be orders of magnitude greater than particle scatter, again adding to the dynamic range required as well as causing blooming artifacts in the image. The significantly larger dynamic range of the CID sensor (>10e+8) in accordance with the invention allows the user to operate the system without size range limits so a very wide range of particle sizes are detectable using the optical inspection system in accordance with the invention.

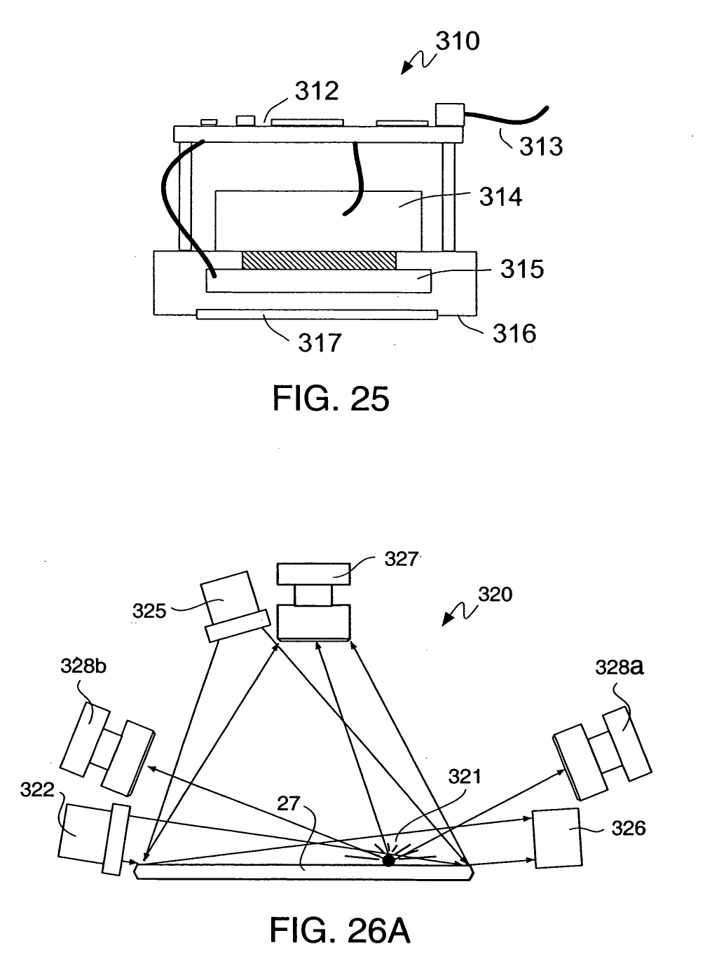

FIG. 25 is a diagram illustrating an example of a CID high dynamic range and high precision photodetector head 310 in accordance with the invention. In particular, the CID photodetector head 310 may comprise microprocessor and control electronics 312 including an interface to a cable 313 (such as Ethernet, Firewire or USB 2.0), a thermal electric cooler 314, the CID detector chip 315, a hermetically sealed enclosure 316 and a DUV transparent window 317. Thus, all the pixel read and control hardware is integrated at the CID photodetector head. In a preferred embodiment, the pixel row, column, reset circuits are controlled by a microprocessor (not shown) with firmware and local memory to support photodetector chip operations including the “Random Access Integration” method described above. The controller communicates with an external computer system via a high-speed communications link such as Ethernet, Firewire or USB 2.0. The image processing may be done at the head with the desired data passed to the external computer system 29. The photo detector head 310 is a “smart sensor”. The calculation capability in this smart sensor can be used to pre-process the images. Examples of pre-processing are frame averaging, median filtering, dilation, erosion and Laplacian filtering.

In a preferred embodiment, the CID photodetector has one or more of the following desirable characteristics: fast pixel read rates (at least 1 MHz); high pixel count (at least 2048×2048), high Quantum Efficiency (QE), especially in the DUV (>20% at 200 nm); low pixel read noise (<12 e⁻); full well capacity >250,000 e⁻; detector chip cooled to at least −30 deg. C. by an air cooled thermal-electric cooler to reduce dark current; good chip temperature regulation for repeatable electrical response; non-destructive pixel read to allow selective pixel photon integration; random pixel access to allow selective pixel photon integration; no pixel blooming which allows pixels to saturate while neighboring pixels are photon counting; and a small package. There are no commercial CCD, CMOS or photodiode detector arrays that meet these requirements. The ability to read, save and then clear high light level pixels while allowing weaker light level pixels to continue to integrate gives the CID array a desired >10⁸ dynamic range. The lack of blooming and very high dynamic range increases the range of particle sizes measured in a single substrate measurement pass, particularly on pattern substrates. Continuously reading and summing bright pixel values, without letting the pixels saturate, provides very high precision. Very high precision and very high dynamic range allows differential measurements on samples with large background scatter such as pattern substrates. The high QE, DUV sensitivity and low noise allow smaller particles to be detected.

As described above, a preferred embodiment may use a CID detector. A somewhat less capable detector could use a CMOS detector. CMOS detectors are inherently anti-blooming, high pixel count (>2k×2k); high pixel read rates >1 MHz and can have well regulated TEC cooling. CMOS detectors can also be constructed in an active pixel sensor (APS) configuration enabling random pixel access and lower noise than typical CMOS detectors, but noise that is still almost 10× higher than CCD capability. CMOS APS have pre-amplifiers per pixel (PPP) that can also be logarithmic resulting in a very high dynamic range, but not high precision. CMOS chips can also theoretically be back thinned to provide high QE but commercial back-thinned CMOS detector chips are not available. The CID random access integration method discussed above, with reference to FIG. 24, could be used with a randomly addressable APS CMOS detector, but the higher noise level of the CMOS sensor would limit small particle scatter capability. Commercial CMOS sensors today do not have low enough noise or high enough QE to be competitive with CID sensors and APS sensors is not yet commercially available with pixel density >1024×1024.

Another somewhat less capable detector could also use a CCD detector. Low noise CCD detectors are capable of pixel read rates of >1 MHz; high pixel counts (>2K×2K); high quantum efficiency; low pixel read noise; TEC cooling to <−50 deg. C.; temperature regulation for repeatable electrical response and have anti-blooming capability (at a reduction in sensitivity). However, no commercial CCD detector is yet available with all these characteristics simultaneously. Also, CCD's cannot randomly access pixels and so the random access integration method described with reference to FIG. 24 above, will not work. However, by modifying the random access method and using low noise anti-blooming CCD's, it is possible to increase the dynamic range of the CCD, but not the resolution. The approach is to first, read, digitize and save the entire CCD array data after a short (for example 10 ms) exposure. Next integrate for the maximum exposure time (for example 10 sec) and save the entire CCD array data again. Determine saturated pixels in the long read. Remove the data in those pixels. Take the pixel data for the 10 ms exposure and multiply by the ratio of the long 10 sec exposure time divided by 10 ms. The result is a calculated 10 sec pixel value. Particle scatter on a substrate can cover many orders of magnitude and small errors in big numbers do not contribute significantly to calculated particle size, but this approach will not allow differential measurements to separate small particles from large scatter background.

The detector could also be a High Dynamic Range Camera (HDRC) sensor. An HDRC sensor is a two dimensional matrix of photodiodes each with its own amplifier and switching electronics. The photoelectron to voltage conversion is logarithmic and each pixel is read independently. The pixels do not integrate in an electron well, as CCD, CMOS or CID sensors do, so it can take a long time to collect a long integration time image because each pixel must be individually integrated. HDRC technology is capable of dynamic ranges up to 170 db (>3×10⁸), but the precision of the output is still limited to the A/D conversion resolution, typically less than 16 bits. The resolution of small signals is acceptable but large signals have limited resolution.

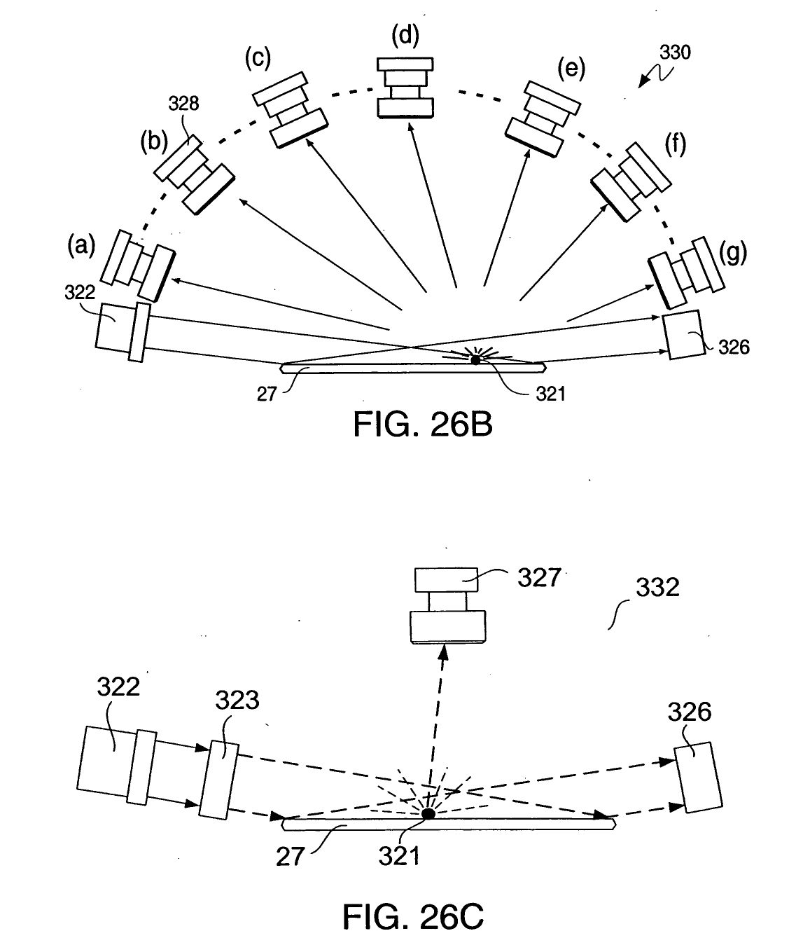

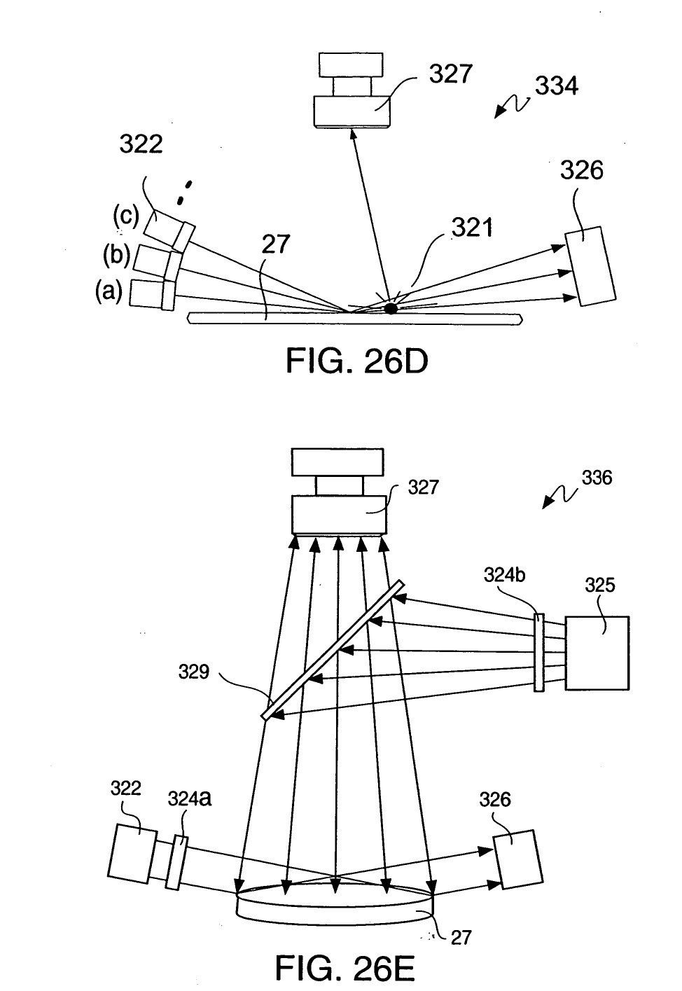

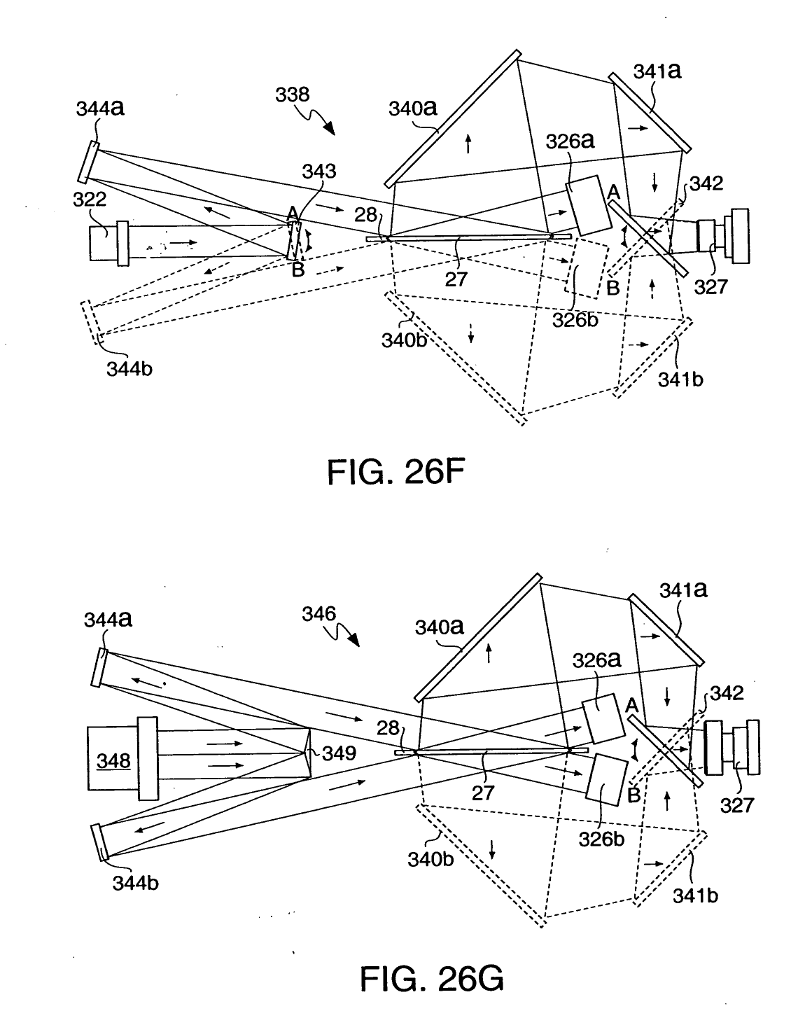

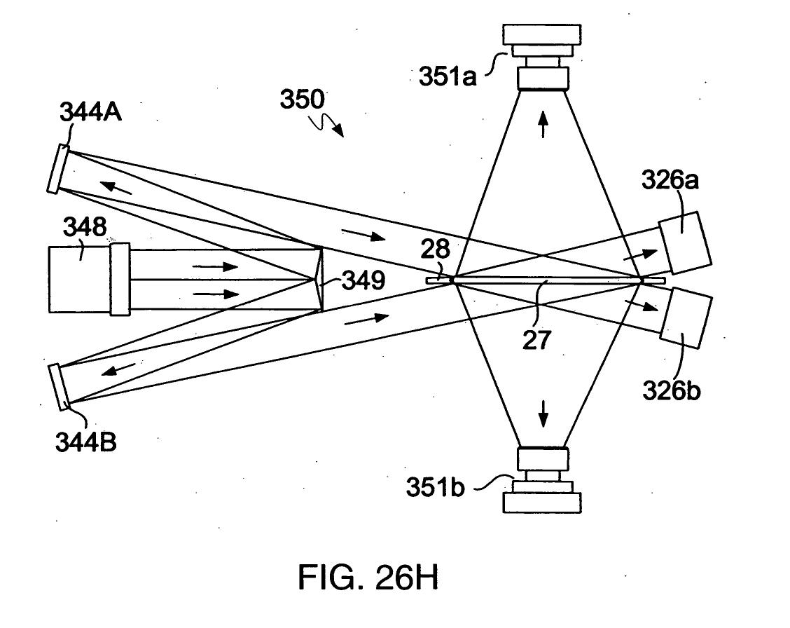

FIG. 26A illustrates an optical system 320 in accordance with the invention that includes a second photodetector and a second broadband light source. In particular, a broadband light source 322 is located so that it generates light at an angle other than normal to a substrate 27. A beam dump 326 and high dynamic range and high precision imaging detector 328A are located on an opposite side of the substrate 27 as shown so that a particle 321 scatter may be detected and measured in accordance with the invention. The second source 325 and second high dynamic range and high precision imaging detector 327 may be used to verify that a substrate is loaded, to align the substrate before and during the inspection process and to provide a high dynamic range and high precision brightfield inspection image. The second detector 327 also may provide darkfield scatter information from source 322 as in the front and back side photodetectors (5A-7A, 5B-7B) in FIG. 5. The scatter may be also more intense when the detector is closer to either the forward or backward scattered light paths or orthogonal to the illumination path. FIG. 26A also illustrates a nearly on-axis (forward scatter) configuration of a high dynamic range and high precision imaging detector 328A in accordance with the invention. FIG. 26A also illustrates a nearly on-axis (backward scatter) configuration of a high dynamic range and high precision imaging detector 328B in accordance with the invention. A detector may also be positioned at an azimuthal angle away from the illumination plane. In commercial laser scanning scatter detection systems, when the detector is positioned out of the illumination plane, at an azimuthal angle greater than zero, it is called “double dark field”.

FIG. 26B illustrates an optical system in accordance with the invention 330 that includes a moveable high dynamic range and high precision imaging detector 328. In particular, a broadband source 322 is located so that it generates light at an angle other than normal to a substrate 27. A beam dump 326 is located on an opposite side of the substrate 27 with a moveable photodetector 328 as shown so that particle 321 scatter may be detected and measured in accordance with the invention. As shown, detector 328 may be moved between one or more different positions (such as positions a through g as shown in FIG. 26B) to optimize the scatter collection. Although the photodetector shown in FIG. 26B is moved in the illumination plane, the photodetector in accordance with the invention may also be moved in an azimuthal angle direction relative to the substrate so that the photodetector may be moved in the X, Y, Z, theta and phi directions while the photodetector imaging is centered on the substrate center.

FIG. 26C illustrates an optical system in accordance with the invention 332 that includes a modulated light source in accordance with the invention wherein a modulator 323 modulates the light from the light source which improves the signal to noise ratio for the system. In particular, a broadband source 322 is located so that it generates light at an angle other than normal to a substrate 27 and that light passes through modulator 323. Modulator 323 chops the light so that the beam is off and on periodically. A beam dump 326 is located on an opposite side of the substrate 27 with a high dynamic range and high precision imaging detector 327 as shown so that modulated scatter from particle 321 may be detected and measured in accordance with the invention. By synchronously detecting the modulated scattered light, stray light that is not modulated is rejected. Also, by detecting an AC. (modulated) signal, DC noise sources in the detector electronics can also be rejected. Synchronous detection is a well-known technique for measuring weak signals in a noisy environment. This modulation technique can be used with any combinations of detectors and sources. Multiple sources could be modulated at different rates to isolate them.

FIG. 26D illustrates an optical system in accordance with the invention 334 that includes a movable source wherein the broadband source 322 is moved to different positions (such as positions (a) through (c) as shown in FIG. 26D) to enhance the particle scatter while minimizing scatter from the substrate. In particular, a broadband light source 322 is located so that it generates light at an angle other than normal to a substrate 27. A beam dump 326 is located on an opposite side of the substrate 27 with a high dynamic range and high precision imaging detector 327 as shown so that particle 321 scatter may be detected and measured in accordance with the invention.

FIG. 26E illustrates an optical system in accordance with the invention 336 that includes a combined bright field and dark field illumination (wherein the illumination, bright field and dark field, can be simultaneous or independent by shuttering the light sources to separate Bright Field and Dark Field measurements, or may be pulsed or alternated in sequence) shown as well as a single high dynamic range and high precision imaging detector 327. The illumination system further comprises broadband light source 322 with shutter 324A (which permits light source 322 to be cut off as needed) that directs the light towards substrate 27. Specular light from source 322 is reflected to beam dump 325 and detector 327 collects scattered light. The illumination system further comprises a broadband light source 325, a shutter 324B as shown that directs light towards the beam splitter 329, which then directs the light essentially normal to the substrate 27. The beam splitter 329 then permits the reflected light to be directed to detector 327 as shown. This light source path generates bright field illumination. As shown, the bright field light is collected essentially normal to the surface. This combination can detect and measure both bright field and dark field scattering features. This can further be done with front and backside of the substrate simultaneously for bright and dark field mode on each side of the substrate.

In accordance with the invention, instead of the two light sources and two detectors shown in FIGS. 5 and 5A, a single detector or single light source or a combination of these may be used since the invention is not limited to the particular number of detectors or light sources being used. Now, several configurations of the optical inspection system that utilize single or multiple detectors in combination with single/multiple light sources will be described.

FIG. 26F illustrates an optical system in accordance with the invention 338 that illuminates and images both sides of the substrate 27 alternately using a single broadband source 322 as shown as well as a single high dynamic range and high precision imaging detector 327. The illumination system further comprises a two position (A and B) illumination flip mirror 343, which alternately directs the illumination beam to a frontside mirror 344A and a backside mirror 344B. The frontside mirror 344A and backside mirror 344B direct darkfield illumination to the wafer front and backside respectively. The specular light from the front and backsides of the wafer are collected by frontside beam dump 326A and backside beam dump 326A respectively. The imaging system further comprises a two position (A and B) imaging flip mirror 342, which alternately collects light from the front and backsides of the substrate as reflected from frontside imaging mirrors 340A, 341A and backside imaging mirrors 340B, 341B. The frontside mirror 344A and backside mirror 344B direct darkfield illumination to the wafer front and backside respectively. The illumination and imaging flip mirrors 342, 343 are flipped synchronously. System 338 allows a single source and single high dynamic range and high precision imaging detector to be used to reduce cost. System throughput, however, will be cut in half because it takes two measurement cycles to view the entire substrate front and backside.

FIG. 26G illustrates an optical system in accordance with the invention 346 that illuminates and images both sides of the substrate 27 simultaneously using a single broadband source 348, which has twice the power of the source 322 in FIGS. 26A-26F, as shown as well as alternately imaging both sides of the substrate with a single high dynamic range and high precision imaging detector 327. The illumination system further comprises a beam splitter 349, which simultaneously directs half the illumination beam to frontside mirror 344A and backside mirror 344B. The frontside mirror 344A and backside mirror 344B direct darkfield illumination simultaneously to the wafer front and backside respectively. The specular light from the front and backsides of the wafer are collected by frontside beam dump 326A and backside beam dump 326A respectively. The imaging system further comprises a two position (A and B) imaging flip mirror 342, which alternately collects light from the front and backsides of the substrate as reflected from frontside imaging mirrors 340A, 341A and backside imaging mirrors 340B, 341B. The frontside mirror 344A and backside mirror 344B direct darkfield illumination to the wafer front and backside respectively. System 346 allows a single source and single high dynamic range and high precision imaging detector to be used to reduce cost. System throughput, however, will be cut in half because it takes two measurement cycles to view the entire substrate front and backside.

FIG. 26H illustrates an optical system in accordance with the invention 350 that illuminates and images both sides of the substrate 27 simultaneously using a single broadband source 348, which has twice the power of the source 322 in FIGS. 26A-26F, as shown as well as simultaneously imaging both sides of the substrate with a frontside high dynamic range and high precision imaging detector 351a and a backside high dynamic range and high precision imaging detector 351b. The illumination system further comprises a beam splitter 349, which simultaneously directs half the illumination beam to frontside mirror 344A and backside mirror 344B. The frontside mirror 344A and backside mirror 344B direct darkfield illumination simultaneously to the wafer front and backside respectively. The specular light from the front and backsides of the wafer are collected by frontside beam dump 326A and backside beam dump 326A respectively. System 350 allows a single source to be used to reduce cost, but system throughput would not be reduced. Now, more details of the substrate handler in accordance with the invention will be described.

The substrate handler should hold the substrate only by the edge so that light from the frontside and backside darkfield light sources can simultaneously illuminate the front and backside of the substrate without obstruction and frontside and backside detectors can receive the scattered light from the substrate without obstruction. Optional substrate pre-alignment functionality may be incorporated in the substrate handler.

FIG. 27A is a top view of a first embodiment of a substrate handler 28 in accordance with the invention and FIG. 27B is a side view of a first embodiment of a substrate handler 28 in accordance with the invention. As shown, the substrate handler may handle the substrate 27 (which is also shown in FIGS. 5, 5A and may typically be a semiconductor wafer). The substrate handler 28 may further comprise a thin rotating edge gripper assembly 360 that grips the edges of the substrate to permit the frontside and backside of the substrate to be simultaneously inspected as shown in FIGS. 5, 5A. The rotating edge gripper assembly may comprise one or more very low contamination edge gripper mechanisms 362 (four are shown in this example, but the invention is not limited to any particular number of edge gripper mechanisms). The edge gripper mechanism may be, as shown in FIG. 27B, a ledge portion 363 which extend underneath the substrate and hold the substrate during the inspection process since the substrate may rest on the ledges. In another embodiment, the edge gripper mechanism does not include the ledge portion 363 and the substrate is held by friction. In another embodiment, one or more of the edge gripper mechanisms are spring loaded so as to push the substrate against other edge grippers to firmly grip the substrate. The substrate handler 28 may further comprise one or more belt driven drive wheels 364 (two are shown in this example, but the invention is not limited to any particular number of drive wheels) that are driven by a motor and rotate the rotating edge gripper assembly (and hence the substrate 27). The substrate handler 28 may further comprise one or more non-belt driven wheels 366 that contact and guide the rotating edge gripper assembly 360 as shown. The combination of the belt driven wheels 364 and non-belt driven wheels 366 rotate and guide the rotating edge gripper assembly 360 as the substrate 27 is rotated as part of the inspection process in accordance with the invention.

The drive wheels 364 are driven, in this embodiment, by a combination of drive belt 368 and a motor driven belt drive wheel 370 as shown. In operation, the motor driven belt drive wheel turns the belt 368, which in turn rotates the drive wheels 364 which rotate the thin rotating edge gripper assembly 360. The substrate handler 28 further comprises a motor controller 25 that controls the operation and rotation of the motor driven belt drive wheel 370. The controller 25 may in turn be electrically connected to the control computer 29 that controls the operation of the controller. The substrate 27 may be placed onto, and picked up from, the substrate handler 28 by an edge gripping robot end effector 374 that is used to transport the substrate into and out from the rotating edge gripper assembly. The edge gripping robot end effector 374 may further comprise one or more robot end effector edge grippers 376 that grip the edge of the substrate while the substrate is being moved by the end effector 374. In other embodiments, an operator or any other manipulator may place the substrate into the substrate handler 28 manually. As shown in FIGS. 27A and 27B, the substrate handler 28 will permit simultaneous frontside illumination 378 and backside illumination 380 of the substrate so that the simultaneous frontside and backside inspection and testing of the substrate may be completed in accordance with the invention. FIG. 27A shows the frontside and backside illumination coming in from opposite sides of the substrate 27, but frontside and backside illumination could also both come from the same side of the substrate. One purpose of the rotating substrate handler in accordance with the invention is to place a physical alignment mark 382 (typically a small notch in the edge of the substrate, but could be a flat edge section) in the substrate 27 in a particular position during the inspection process. The substrate handler may also permit the substrate to be rotated between different steps in the inspection process so that images of the surface of the substrate are obtained at various different substrate orientations. In this embodiment of the invention, a drive wheel assembly 384 may comprise a thin platform that supports and includes the belt driven wheels 364, the non-belt driven wheels 366, the belt 368 and the motor driven belt drive wheel 370.

In operation, the substrate's front and back surface are completely exposed so that both surfaces may be simultaneously illuminated. The edge gripping rotator 360 allows the substrate to be positioned consistently with respect to the substrate notch or primary flat while only contacting the edges of the substrate in a few points. The edge gripper mechanisms 362 are positioned to allow the robot end effector access to load/unload the substrate and minimize obstruction of the illumination beams. The driven and drive wheels 364, 366 are also positioned to minimize obstruction of the top and bottom illumination beams. The edge gripping rotator 360 is initially positioned so that the opening in the edge gripping rotator 360 is directed toward the direction that the robot end effector will load the substrate. Once the substrate is loaded, the rotator will rotate the substrate notch/flat 382 to a consistent pre-determined orientation that facilitates pre and post measurements of the substrate since the orientation of the substrate is controlled and reproducible.

As shown in FIG. 27B, the substrate handler 28 is shown in combination with a frontside light source 386 and a backside light source 388 (wherein the frontside light source further comprises elements 10A-22AA as shown in FIGS. 5,5A and the backside light source further comprises elements 10B-22BB as shown in FIGS. 5,5A) and a frontside high dynamic range and high precision detector 390 and a backside high dynamic range and high precision detector 392 (wherein the frontside detector further comprises elements 5A-7A as shown in FIGS. 5,5A and the backside detector further comprises elements 5B-7B as shown in FIGS. 5,5A). As shown, the substrate 27 is held such that the light from the frontside and backside light source may be directed towards the substrate at an angle other than normal to the substrate without obstructions and the frontside and backside detectors 390, 392 may receive the scattered light from the substrate without obstructions. Now, another embodiment of the substrate handler in accordance with the invention will be described in more detail.

FIG. 28A is a top view of a second embodiment of a substrate handler 28 in accordance with the invention. FIG. 28B is a side view of a second embodiment of a substrate handler 28 in accordance with the invention wherein the substrate handler is shown in relation to the frontside and backside light source 386, 388 and the frontside and backside detector 390, 392. This embodiment of the substrate handler 28 may comprise one or more edge gripper mechanisms 400 (four are shown in this embodiment, but the invention is not limited to any particular number of edge grippers), a rotating edge gripper assembly 402 that includes the edge gripper mechanisms 400 and is connected to the edge gripper mechanisms 400 and a lift pin assembly 404. As with the previous embodiment of the substrate handler, the substrate's top and bottom sides are exposed and may therefore be simultaneously illuminated by the frontside and backside light sources 386, 388. The edge gripping rotator assembly 402 allows the substrate 27 to be positioned consistently with respect to an alignment notch or flat in the substrate while only contacting the edges of the substrate. The edge gripper mechanisms 400 are positioned to allow a robot end effector (not shown in this figure) access to load/unload the substrate and minimize obstruction of the illumination beams. Once the substrate is loaded into the substrate handler, the rotator will rotate the substrate notch/flat to a consistent pre-determined orientation that facilitates pre and post measurements.

In this embodiment, the substrate 27 is supported by edge gripper mechanisms 400 that are attached to pins 406 that are in turn mounted to rotating assembly 402 which maybe a ring bearing. The substrate is thus elevated from the assembly 402 sufficiently (as shown in FIG. 28B) to allow oblique light to strike the back surface without casting shadows on the substrate. With this embodiment, the backside lighting passes between the rotating assembly and the substrate bottom surface. The backside detector looks through the large opening in the middle of the ring bearing at the backside surface. The raised substrate edge gripper mechanisms 400 allow a robot end effector (not shown) to move between the pins 406 and set the substrate onto the pin edge grippers, then retract. Next the orientation of the substrate notch 408 is found and the amount of re-orientation to a pre-determined position is determined. To accomplish substrate re-orientation, the substrate lifter 404, which is normally rotated to the side out of the way of the photodetector as shown in FIG. 28A, rotates under the center of the substrate (as shown by the arrow in FIG. 28A) and raises the substrate slightly up and off the edge gripper mechanisms 400. The substrate lifter 404 may employ a small vacuum chuck tip to grip the substrate. Minimal contact is desired to minimize contamination. The edge gripper rotator 402 then rotates a calculated amount and the substrate is lowered back onto the edge grippers. The edge grippers, with the substrate, rotate again so the notch is at a specific orientation while also ensuring pins 406 are at a specific orientation that does not occlude the backside oblique illumination. Currently, semiconductor fabs have Pre-Aligners incorporated as part of production tools to orient the substrate consistently. The rotating lifter could replace external substrate pre-aligners, thus saving the cost of an external pre-aligner. While the substrate is lifted, annular edge illumination (shown by FIGS. 11,12) can be used to illuminate the edge of the substrate directly from all sides so the edge can be measured by the top and bottom photodetectors simultaneously.

FIG. 28C is an illustration of an edge gripper mechanism of a substrate handler 28 in accordance with the invention. FIG. 28C shows moving edge gripper structures 412, moving edge support structures 414 and a section of a substrate 27. There are 6 positions of the edge gripper and support structures shown numbered 1-6. FIG. 28D is provided for clarity and shows top views of four sets of edge gripper 412 and support 414 structures surrounding the substrate 27 as shown. FIG. 28D shows 4 positions of the edge gripper and support structures numbered 1-4 which correspond to positions 1-4 in FIG. 28C. In FIG. 28C (1), the edge gripper 412 and support 414 structures are in fully retracted positions with respect to the substrate 27. The substrate is shown as a dotted line since it is not loaded yet. In FIG. 28C (2), the support structure is moved to the substrate load position. Now the substrate can be loaded and unloaded by a substrate-handling robot (not shown) onto the support structures. The substrate-handling robot can position the substrate with precision (on the order of tens of microns) in X, Y and Z onto the support structures. The substrate-handling robot next releases the substrate to rest on the support structures and then withdraws. The substrate is now fully supported by the support structures. The support structures 414 are beveled such that just the edge of the substrate rests on the bevels. This is shown more clearly in FIG. 28E bottom drawings. In FIG. 28C (3), the edge gripper structure 412 is inserted and presses against the edge of the substrate while substrate is held by the support structure 414. The tips of the edge grippers 412 are tapered so as to not block illumination light to the substrate. The taper is shown more clearly in FIG. 28E top drawings. In FIG. 28C, the edge gripper structure holds the substrate firmly by the edge of the substrate only. In FIG. 28C (4), the support structure is retracted and the substrate is held only by the edge gripper. This is the measurement position. In FIG. 28C (5), after the measurement is finished, the support structure is again inserted to support the substrate simultaneously with the edge gripper. In FIG. 28C (6), the edge gripper is retracted and the substrate is held solely by the support structure. In position (6), a substrate-handling robot can unload the substrate.

FIG. 28E illustrates details of the shape of the support 414 and edge gripper 412 structures. The support structure 414 has a beveled surface 416 and a flat pad 415. The substrate is ideally supported by the beveled edge 416, but in case of a robot mis-handling error, the flat pad area 415 offers additional fail-safe support. The edge gripper structure 412 is tapered to a tip having a beveled indentation 417. The indentation 417 is just wide enough to capture the substrate but not extend above or below the substrate edge. FIG. 28F shows details of another implementation of the support and edge gripper structures which are integrated together. FIG. 28F shows a sliding support structure 414, a sliding edge gripper structure 412 that slides independently within a groove in support structure 414, a beveled support structure edge 416, a support structure flat pad area 415, an edge gripper beveled indentation 417 and the edge of a substrate 27. The sequencing of the support and edge gripper structures is the same as in FIG. 28C. The implementation in FIG. 28F may be used where space constraints dictate a narrow edge gripper mechanism, for example in FIGS. 27A and 28A. The edge gripper and support structures in FIGS. 28E and 28F may also be used where substrate rotation is not needed. Now, substrate scattering feature measurement in accordance with the invention will be described in more detail.

Differential measurement is a powerful method for determining the scattering feature contribution caused by a process tool. The substrate can be measured before and after the process and the measurement results compared to determine changes in the substrate due to unintentional process tool problems. Repeatable substrate orientation with respect to the substrate notch or flat is needed for differential measurements and to minimize periodic pattern scatter to the frontside and backside detectors. Periodic patterns are typically semiconductor device patterns, but can also be due to substrate backside etch treatment. Substrate etching may preferentially etch along silicon crystalline boundaries, which have components that are rectangular in shape, similar to rectangular shaped semiconductor device patterns. Periodic patterns scatter light similarly to gratings and this scatter can be very intense. Periodic pattern light scatter from device patterns and backside etching can often be reduced by orienting the pattern axes 45 degrees to the illumination path in order to direct most of the pattern scatter away from the photodetector. Orienting the notch or flat 45 degrees orients the rectangular pattern symmetries to 45 degrees. Optionally, the substrates are typically oriented at 45 degrees to the illumination path. Optionally, if substrates are normally oriented at 45 degrees to the illumination path, the detector may be oriented at 45 degrees to align detector pixels with substrate patterns to enhance pattern imaging. The scatter from rectangular patterns oriented at 45 degrees to the illumination path is predominantly in lobes that align with the substrate pattern, which are at 45 degrees to the illumination path. To collect this dominant scatter, optional beam dumps may be incorporated at 45 degree angles from the illumination path. An alternative method of reducing pattern scatter is to incorporate optical spatial filters in front of the photodetectors that block periodic pattern noise. Differential measurement is facilitated if the substrate images are carefully oriented in X, Y and theta so the “before” image can be easily subtracted from the “after” image. The substrate can be mechanically oriented using the substrate handling rotator methods described above in FIGS. 27A, 27B, 28A and 28B which in turn orients the images. The image can also be mathematically oriented using image processing software. The preferred approach is to do both, first mechanically orient the substrates, then mathematically fine tune the image orientation.

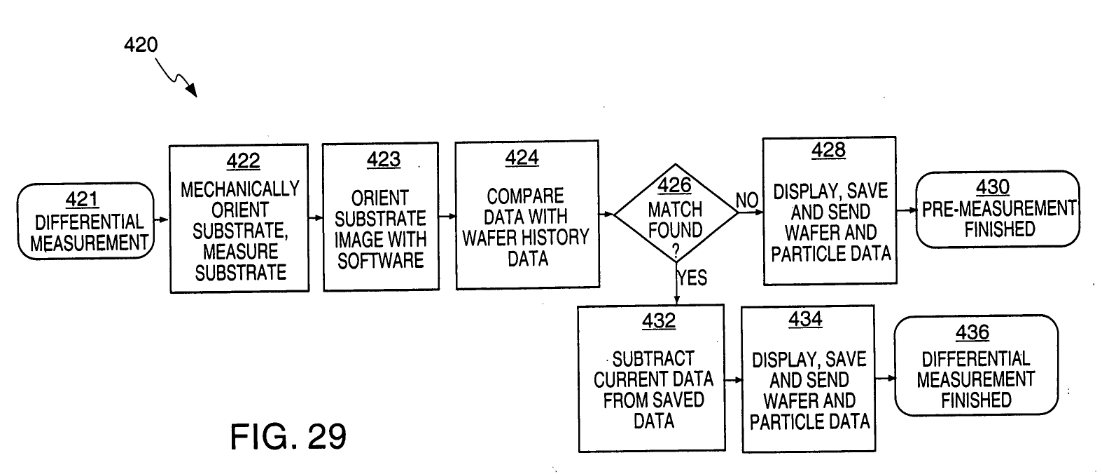

FIG. 29 is a flowchart illustrating a differential substrate scattering feature measurement method 420 in accordance with the invention. In a preferred embodiment, this method may be implemented as a series of instructions in one or more software modules which are being executed by the control computer shown in FIGS. 5, 5A or system computers in FIGS. 13B, 13C, 13D and 13E. In particular, the differential measurement is initiated in step 421. In step 422a substrate is measured to detect scattering feature. Step 422 includes substrate orientation by the mechanical substrate handler 28. It is also possible for the substrate to be mechanically pre-aligned external to substrate loading in which case step 422 is simply substrate measurement. In step 423, the image is mathematically oriented using image processing software to sub-pixel resolution. In step 424, the precision oriented imaged data is compared to substrate history data. This may be a comparison of detected scattering feature (which requires scattering feature detection to be performed before a comparison can be made) or image features (which requires image processing pattern matching). In step 426, the system determines if a match (the scattering feature data or image for the current substrate matches the scattering feature data or image for a previously measured substrate) has been found. If a match has not been found, then the scattering feature and image data from the current substrate is displayed to the user and saved in a database in step 428, which completes the pre-measurement in step 430. Returning to step 426, if a match is found, then the measurement image data for the substrate is subtracted from the saved data in step 432. In step 434, the differential substrate and scattering feature data is displayed to the user and saved into a database and the differential measurement is completed in step 436. In this manner, the system permits differential substrate data to be generated in accordance with the invention. Differential measurements are especially suited for integrated process tool inspection, FIG. 13D and integrated EFEM inspection, FIG. 13E. The output of a differential measurement may be the number and size of scattering feature added only by the process tool on which the inspection system is integrated or may be a process dependent image. Process dependent images are patterns that occur due to process problems. Process problem images may be referred to as process problem signatures.

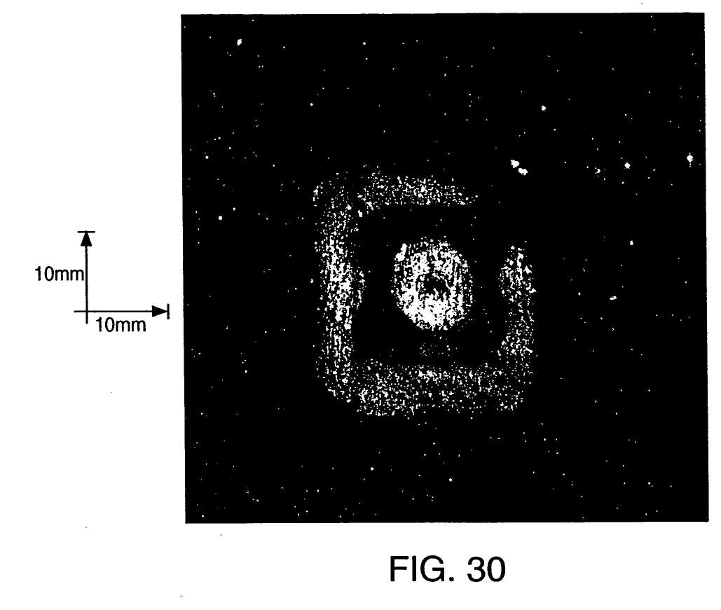

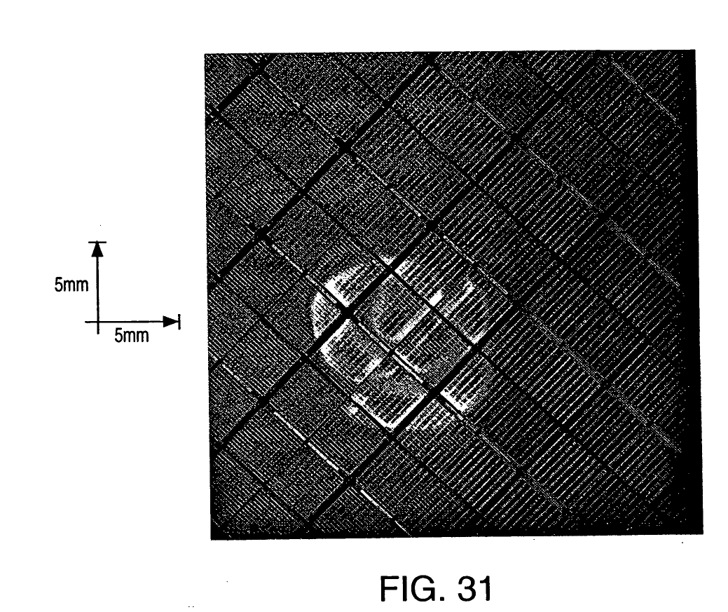

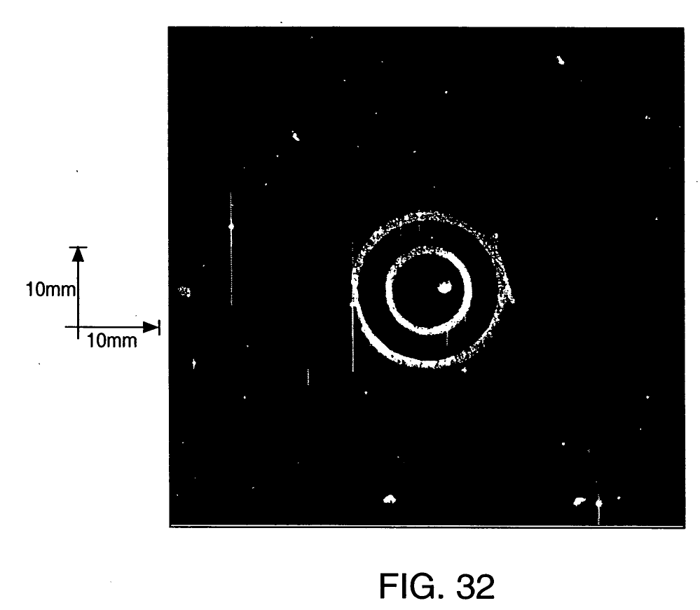

Examples of process problem signatures are shown in FIGS. 30-32. In FIG. 30 a CVD tool's gas chemistry has become unstable and an optical inspection system using the broadband large area darkfield technique described in the invention has detected a square with a circle pattern embedded in a CVD film from the unstable CVD tool. The pattern is roughly the shape of the CVD gas flow nozzle. FIG. 30 is a composite of 9 separate images taken with the optical inspection system. In FIG. 31, a white irregular shaped scattering feature is seen on a device pattern in this composite image taken with the optical inspection system. The scattering feature is due to a lithography tool hot spot that overheated the photoresist in the area of the scattering feature causing this region to have increased scatter. In FIG. 32, the concentric circles in this composite image taken with the optical inspection system are due to particulate contamination from a substrate handling robot end effector. These are typical defects that can be processed by known image processing and pattern matching techniques. When patterns (or portions of the patterns), such as shown in FIGS. 30-32 appear, a semiconductor fab operator can be alerted and action taken to correct the process problem. It is also possible to create a complete process problem signature by collecting data from substrates over time and combining their images to form a process problem signature. These patterns are virtually impossible for laser scanning systems to see. Defects introduced on the substrate prior to process tool operation are subtracted out by the differential measurement method. Differential measurements are also very powerful because complex patterns can be measured without any prior knowledge of the patterns. Differential measurements require high throughput to be used effectively because the substrate is measured twice—pre and post measurement. The invention is ideally suited for differential measurement.

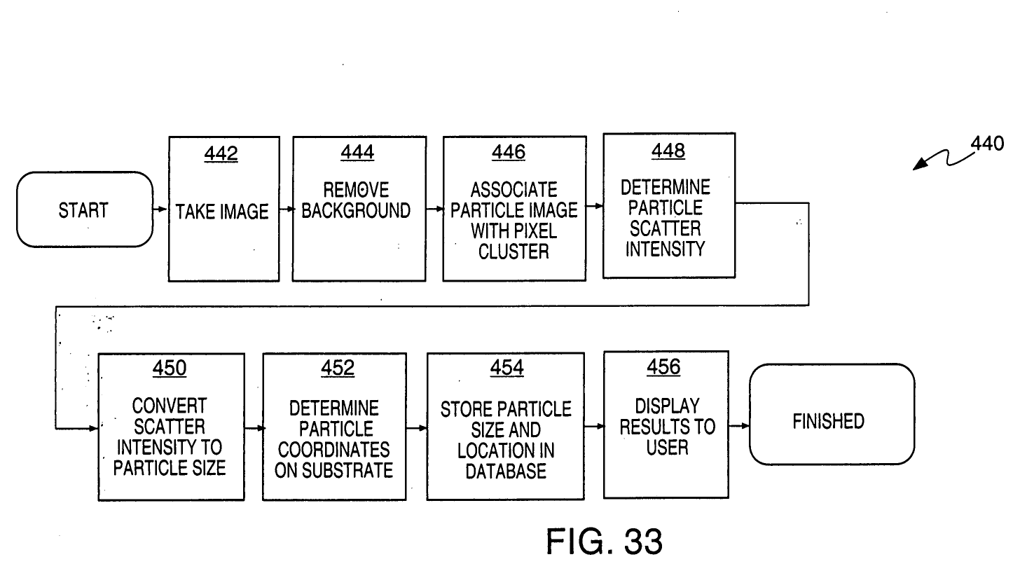

FIG. 33 is a flowchart illustrating an image processing method 440 to identify and measure scattering feature defects, such as particle defects, in accordance with the invention. For this processing method, it is assumed the substrate does not have device patterns. In step 442, an image is taken as described with reference to FIG. 7 above. In step 444, the background signals are removed from the detected image. In particular, the intensity contributed by stray light, thermal noise, electrical noise, read-out noise, and any other sources, including patterned (structured) devices on a substrate (except the light scattered from particles on the substrate) should be removed. The resultant image from step 444 has background pixel values near zero (where the substrate has minimal scatter). In step 446, each particle pixel is associated with a pixel cluster. At the end of step 446, each pixel with an intensity above the background is associated with a specific particle. In step 448, the total particle scatter intensity is determined, which is the sum of the pixel values associated with a particle cluster. In step 450, the cluster intensity is then converted into particle size. In particular, the cluster intensity determined above depends on illumination intensity, angle, and exposure time, as well as particle and substrate material properties. In step 450, we first normalize the particle cluster intensity by the illumination intensity and exposure time for a given acquired image. At this point, the calibrated intensity is only a function of particle size on a given substrate. To provide calibrated particle sizes, the intensity of particles on well-known substrates with various well-known calibrated particle sizes is measured, for example, 0.1 um, 0.15 um, 0.3 um, 0.5 um, and 1 um PolyStyrene Latex (PSL) spheres. This calibration information is used to generate a particle size vs. particle intensity table (called particle size calibration table) for given particle and substrate materials. Thus for a measured particle, one can determine the particle size from the measured particle cluster intensity using the particle size calibration table. In step 452, the center of the cluster in pixels, which is the particle location, is found and the pixel center coordinates are converted to substrate coordinates. At this point in the process, the particle position is the pixel location (row and column) in an image, not the actual physical location on a substrate. In order to get the particle location on a substrate from an image, the image should include at least portion of the substrate edge. By processing the image, for example, using a well-known Sobel filter, one can detect the substrate edge from an image. From the edge locations one can determine the substrate center and radius in terms of pixels. By knowing the substrate size (200 mm, 300 mm), one can then convert pixel position into the physical location on a substrate. Once all pixel clusters are converted in this manner, a particle map (with size and location) for a substrate is obtained. In step 454, calibrated particle size and position are stored in a file in the system database, displayed for the system operator and possibly transmitted via computer networks to external computers. In a preferred embodiment, the above method is implemented as one or more pieces of software being executed on one or more computer systems. In addition, if the scattered light for a particular particle size is known, then one can calculate the number of particles within a pixel based on the intensity of the scattered light at that pixel. Now, the test results from the optical inspection system in accordance with the invention as compared to a conventional system will be described to illustrate the advantages of the optical inspection system in accordance with the invention.

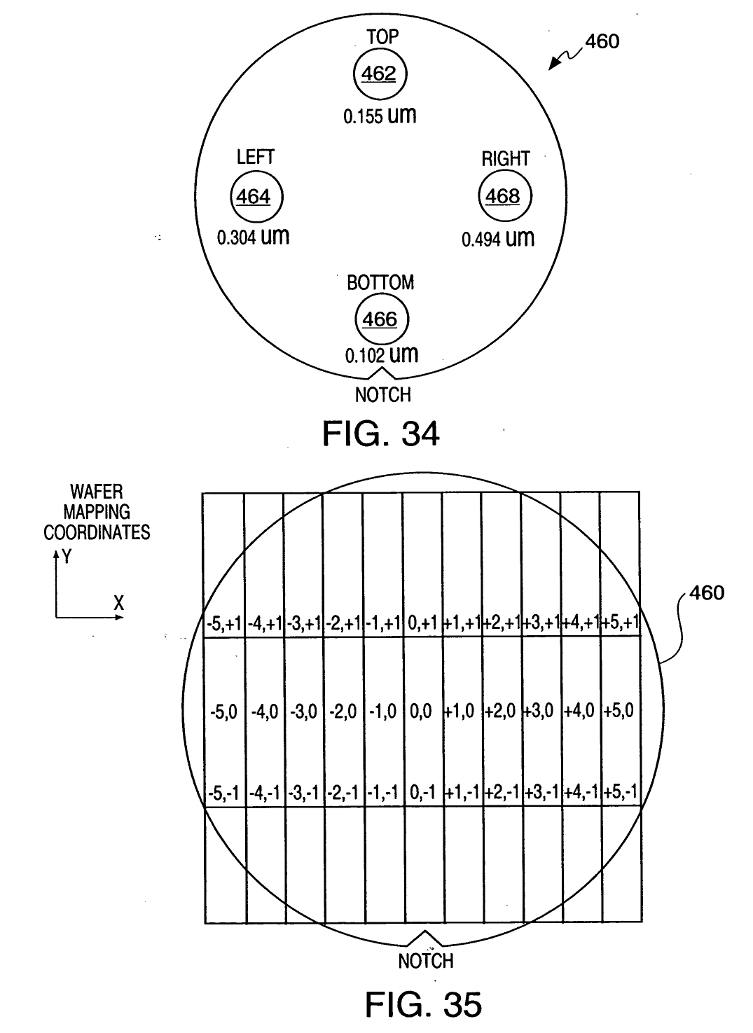

FIG. 34 is a diagram, illustrating a calibration wafer that was used to validate the optical inspection system in accordance with the invention. In particular, a calibration wafer 460 may have one or more particles adhered thereto so that the wafer may be placed into the optical inspection system in accordance with the invention and a conventional optical inspection system to test each system. In more detail, the calibration wafer 460 may include one or more PSL spheres deposited on the surface from a particle deposition system. The spheres are charged with identical charges and so repel each other to avoid clumping. The sphere diameters are in micrometer units. As shown in FIG. 33, there may be a circle of 0.155 μm spheres 462, a circle of 0.304 μm spheres 464, a circle of 0.102 μm spheres 466 and a circle of 0.494 μm spheres 468.

FIG. 35 is a diagram, illustrating wafer-mapping coordinates for the calibration wafer 460 in accordance with the invention. In particular, due to the limited illuminated wafer area of the breadboard implementation of the optical inspection system that used a rectangular aperture to define the illumination area, acquired defect images need to be tiled together. FIG. 35 shows the corresponding coordinate system as used to measure the calibration wafer. As will be shown in the diagrams below, the breadboard implementation of the optical inspection system in accordance with the invention has the capability to image and detect particle sizes much greater in diameter in a single measurement pass than corresponding data from a laser scanning system, such as a KLA-Tencor SP1 TBI.

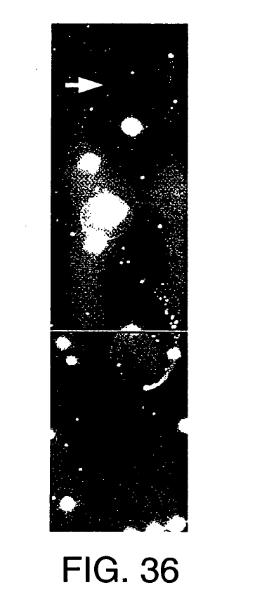

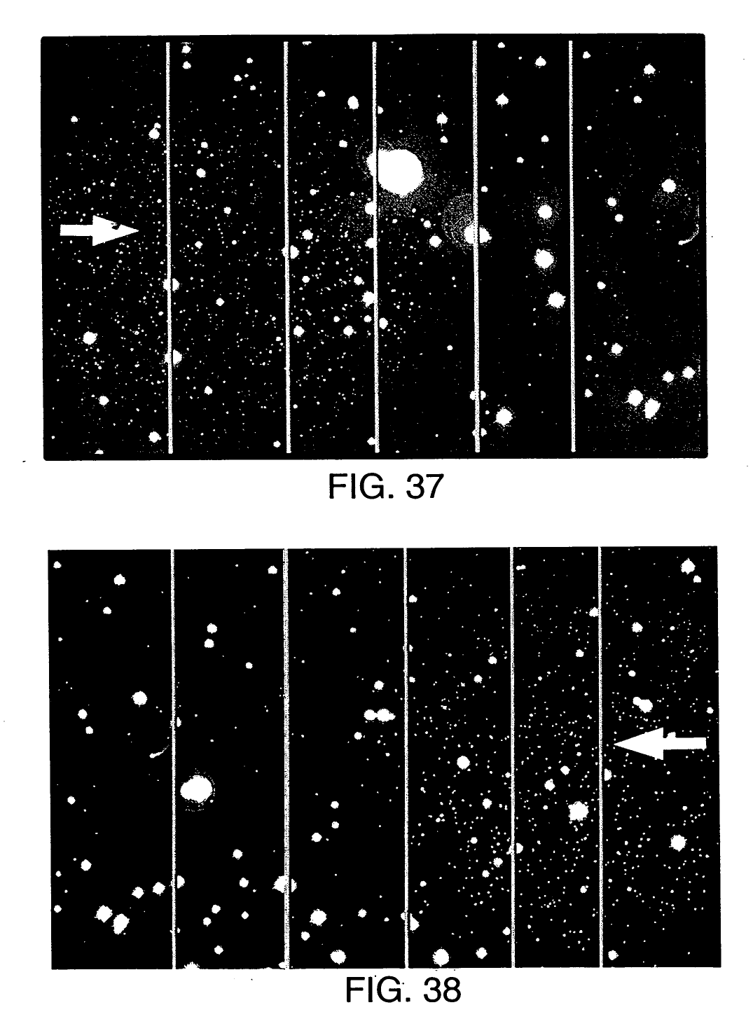

FIG. 36 is a diagram illustrating the results of the optical inspection system for 0.155 μm particles identified along coordinates 0, +1 to 0, 0 in accordance with the invention. As shown, the 0.155 μm spheres on the calibration wafer are identified as well as other larger particles. FIG. 37 is a diagram illustrating the results of the optical inspection system for 0.304 μm particles from coordinates −5,0 to 0,0 in accordance with the invention. As shown, the optical inspection system is able to identify the 0.304 μm diameter particles at the same time that it is able to identify larger particles. FIG. 38 is a diagram illustrating the results of the optical inspection system for 0.494 μm particles wherein the coordinates are from 0.0 to 0.5 in accordance with the invention. As above, the optical inspection system is able to detect these particles as well as the larger particles during a single inspection process. In a conventional system, the detection of both large and small particle sizes would typically require multiple measurement passes over the wafer.

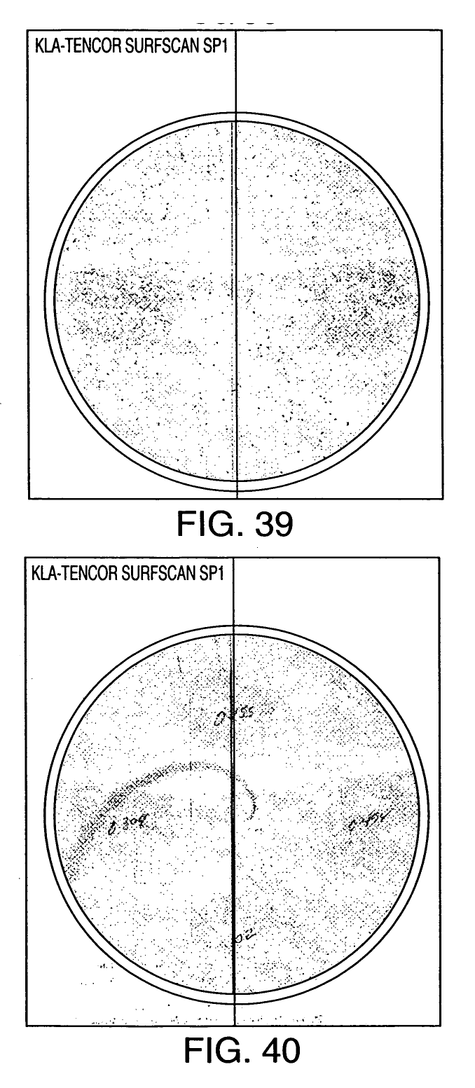

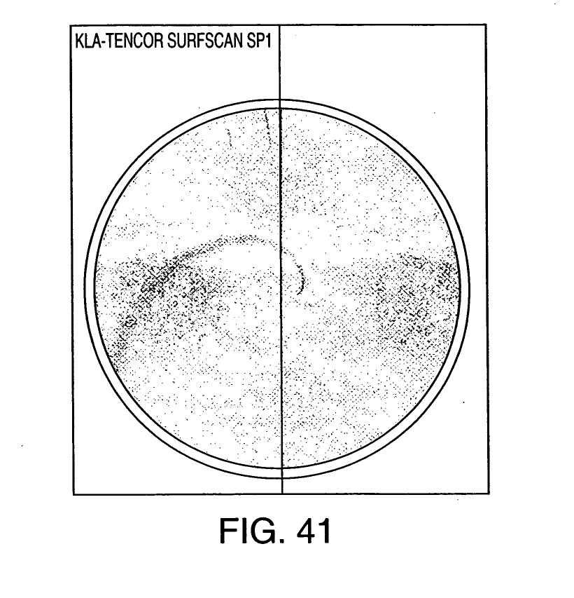

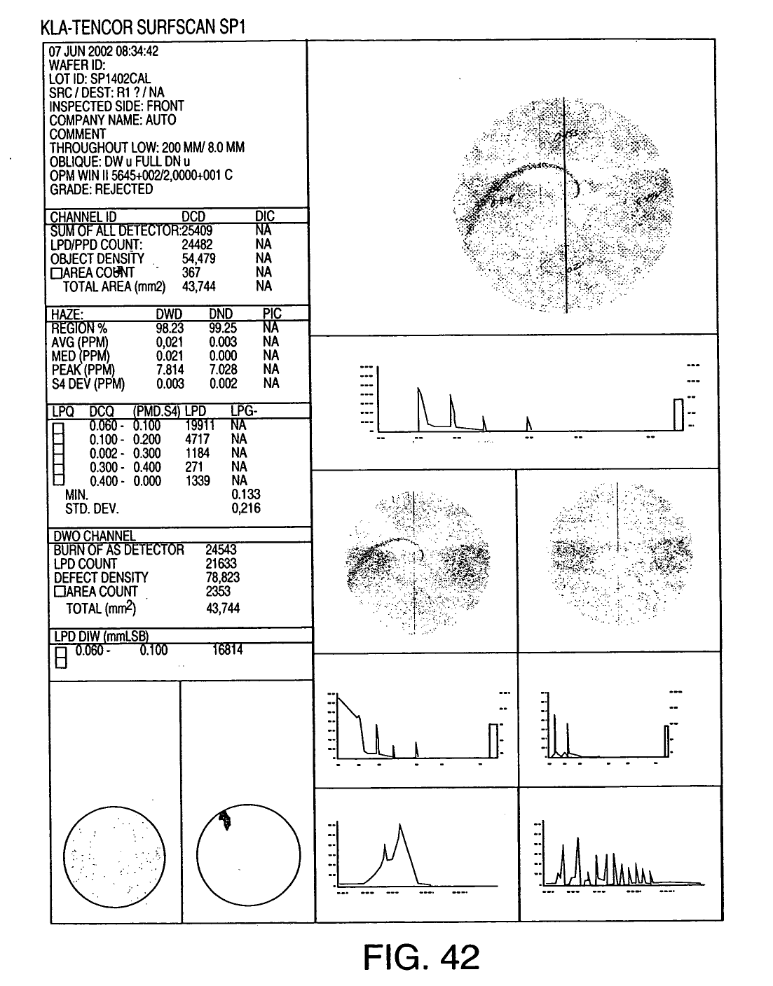

FIGS. 39-41 illustrate the inspection results for the same calibration wafer using a conventional system. FIG. 39 shows a conventional system map of defects with sensitivity limited to smaller defects. FIG. 40 show another conventional system map of defects with sensitivity limited to larger defects. FIG. 41 shows another conventional system map with the results combined from the measurement in FIGS. 39 and 40. In FIG. 39 the PSL particle sphere circles are more evident but the central spiral pattern is not visible. In FIG. 40 the PSL particle sphere circles are less evident but the central spiral pattern is very visible. FIG. 42 illustrates inspection summary results for the same calibration wafer using a conventional system. As shown in FIG. 42, the conventional system does not accurately simultaneously detect the small PSL spheres and the spiral shape defect or the larger particles on the calibration wafer. Now, disk drive substrate inspection systems in accordance with the invention will be described in more detail.

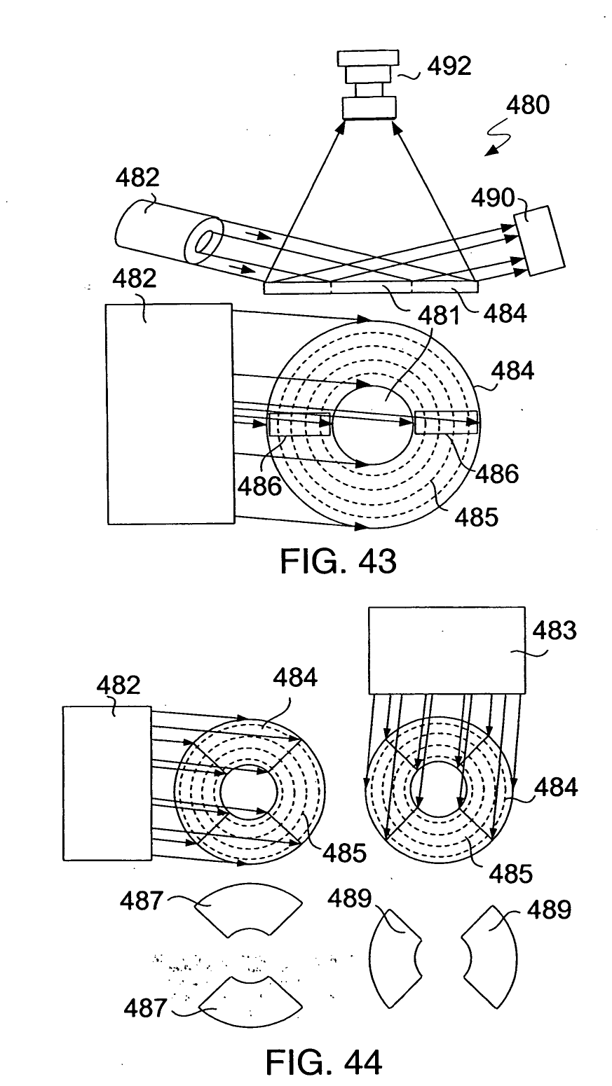

FIG. 43 is a diagram illustrating a disk drive substrate inspection system 480 in accordance with the invention. In particular, a broadband darkfield light source 482, a disk drive substrate 484, a beam dump 490 and a high dynamic range high precision photodetector 492. The disk drive substrate inspection system 480 has similar components to the semiconductor wafer substrate inspection system in FIGS. 5, 5A many of the details of which are not depicted in FIG. 43. For example, the disk drive substrate inspection system incorporates a substrate holder, bright field source, control computer, optical band pass filters, shutters, polarizers, etc. The disk drive inspection system 480 is also capable of simultaneous inspection of the disk substrate frontside and backside as in FIGS. 5, 5A. The disk drive inspection system 480 is also capable of stand-alone, bench top and process tool integration configurations as in FIGS. 13B-13E. Existing commercial disk drive substrate inspection systems use laser scanning. Commercial production disk drive substrate inspection systems need very high throughput (several hundred disk drive substrates per hour) to meet the demands of the disk drive industry. Today's disk drive substrate inspection systems use multiple laser scanning heads operating on multiple substrates in parallel to provide sufficient throughput, are expensive and mechanically very complex. A single disk drive inspection system 480, in accordance with the invention, is capable of hundreds of dual sided disk drive substrate inspections per hour, is mechanically simple (more reliable) and much less costly. The darkfield broadband source 482, beam dump 490 and photodetector 492 can be similar to 10A-22AA, 4A and 5A-7A respectively as in FIGS. 5, 5A. For the disk drive optical inspection system, the disk drive substrate may preferably have a marking, such as a laser inscribed stripe, that permits the light scattering features on the disk drive substrate to be mapped to the physical disk drive substrate.

A disk drive substrate 484 typically has a washer shape, i.e. a disk 484 with a hole 481 in the center. Disk drive substrate 484 thickness range from less than 1 mm to 1 mm or more. The disk outside diameter can range from 10 mm to over 95 mm. The hole in the center is for mounting the disk substrate in the disk drive assembly. The disk drive industry uses substrate surfaces within 1 mm of the outside edge to within 1 mm of the inside edge. Typical edge exclusion areas are 1 mm or less. The disk substrates can be metal, such as aluminum, or glass. The glass substrates are especially challenging to laser scanning disk substrate inspection systems because they are largely transparent to the scanning laser beam and scatter from the backside can be detected at the frontside. Disk drive substrates are typically coated with various thin film layers such as opaque magnetic material during the fabrication process. The disk drive substrates need to be inspected at various process steps in the manufacturing process. Defect inspection tools look for particles, bumps, scratches, droplets, etc. Darkfield illumination should preferably illuminate the disk drive substrates within 1 mm of the edges, but not at the very edges, and also should not illuminate the center hole 481 or its edges. The illumination beam may be an elliptical washer shape. This illumination shape illuminates an entire side of a disk substrate, but not the center hole. Although FIG. 43 shows only the frontside scattering feature detection, both frontside and backside illumination and detection simultaneously occur. Disk substrates are typically textured during the disk manufacturing process. The texture is in the form of closely spaced concentric rings 485, approximately 10 angstroms deep, centered on the disk substrate. FIG. 43 does not represent actual texture ring spacing, as the rings are actually spaced microns apart, but shows the concentric nature of the texture. Illumination perpendicular 486 to the texture is heavily scattered by the texture. The texture scatter intensity is orders of magnitude higher than particle scatter in the 0.1 um to 1.0 um size range. In order to suppress texture scatter intensity to allow detection of scattering features over the entire disk surface it may be desirable to illuminate the disk substrate as in FIG. 44. In FIG. 44 the illumination pattern 487 is not a simple washer shape, but is a portion of a washer shape as shown. The illumination pattern 487 covers 50% of the disk surface, but does not illuminate texture perpendicular to the illumination nor the center hole. By illuminating the disk substrate and measuring, then rotating the disk substrate 90 degrees and re-measuring one can inspect the entire disk substrate surface. Another approach is to include a second source 483 as shown in FIG. 44 that is rotated 90 degrees from the first source 482. The illumination pattern 489 projected onto the disk substrate by source 483 also covers 50% of the disk substrate surface, but this is the 50% not covered by pattern 487 as shown. The two sources can be operated simultaneously or sequentially. The entire disk is illuminated when both the first 482 and second 483 sources are on simultaneously. The same dual source arrangement could be duplicated for simultaneous backside measurement.

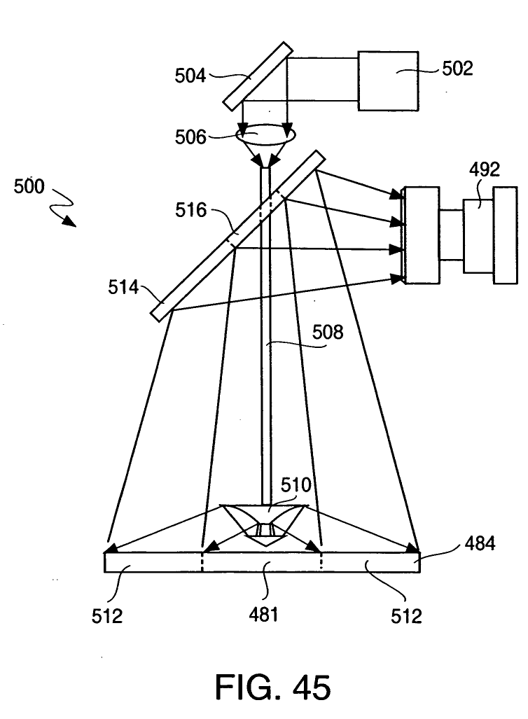

The disk texture is also of interest and FIG. 45 shows a method 500 for illuminating the disk substrate texture with illumination that is everywhere perpendicular to the texture. In particular, a broadband light source 502, a dichroic mirror 504, beam focusing optics 506, a homogenizer light coupling rod 508; illumination elements 510, illuminated disk area 512, disk drive substrate 484, disk drive substrate center hole 481, image turning mirror 514, hole in image turning mirror 516 and a high dynamic range high precision photodetector 492. The light from broadband source 502 is directed onto dichroic mirror 504. Dichroic mirror 504 passes IR wavelengths and reflects visible through DUV wavelengths. The beam reflected from the dichroic mirror 504 is collected and focused by beam focusing optics 506 into a homogenizing rod 508. The homogenizing rod 508 passes through a hole 516 in the imaging turning mirror 514. The homogenizing rod 508 transfers the light to illumination elements 510. The illumination elements direct light to the disk surfaces 512 uniformly around the circumference of the disk. The illumination is everywhere perpendicular to the disk texture. The scatter from the disk texture is collected and reflected by imaging turning mirror 514. The mirror has good reflectivity from visible through DUV wavelengths. The disk substrate scatter is then directed to the imaging photodetector 492. The center of the disk substrate image is not transferred to the camera due to the hole 516 in the turning mirror 514. The hole 516 is of a size to coincide with the center hole 481 in the disk substrate. Components 492, 502, 504, 506, 508, 510, and 516 may be duplicated on the backside of the disk substrate 484 to provide simultaneous frontside and backside disk substrate texture inspection.

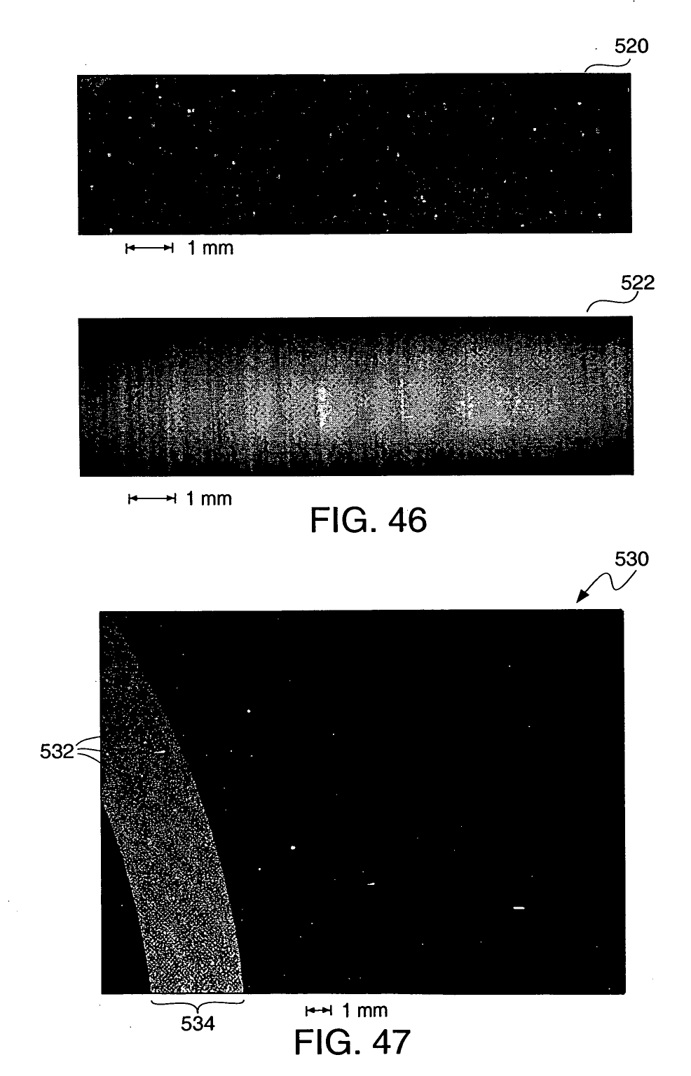

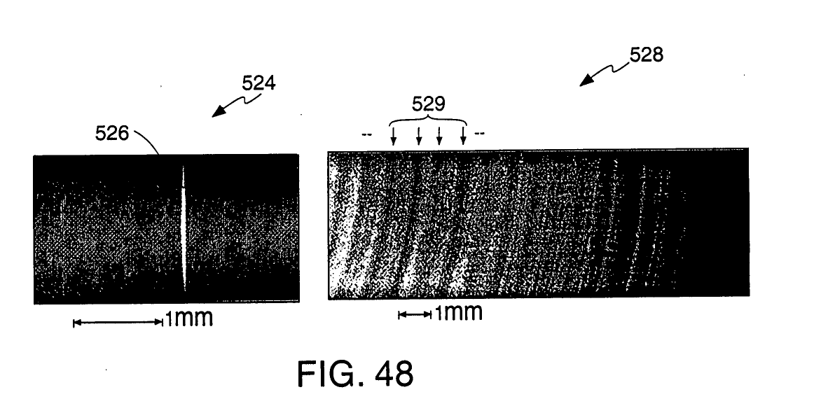

Disk substrate data, taken with the optical inspection system in accordance with the invention, is presented in FIGS. 46, 47 and 48. FIG. 46 is a diagram illustrating the results of the optical inspection system for two transparent glass disk substrates, one with no texture 520 and the other with texture 522 in accordance with the invention. It is obvious which disk has concentric texture and which does not. The texture shown in image 522 in FIG. 46 is not visible to laser scanning systems. Also in FIG. 46, image 520, without texture, shows particulate contamination ranging from approximately 0.1 um to over 10 um. Image 520 is typical of images of disk substrate regions that are not illuminated by light perpendicular to the texture. In FIG. 47, image 530, the concentric texture is still evident in areas not illuminated by perpendicular light, but the texture scatter is much lower amplitude and sub micron size particles can be easily measured. FIG. 47 is a diagram illustrating the results of the optical inspection system for a metal disk substrate 530 showing a laser scribe region 534 with various defects 532 in accordance with the invention. Disk substrates may have a laser scribe region 534 near the center of the disk produced by repeated focused laser heating. The laser heating causes bumps with reflow material around the bumps. The bumps are approximately 100 angstroms high, 5 to 10 um wide and spaced 20 to 50 um apart. The result is a textured area of localized bumps that the disk drive read/write head can rest on during periods of inactivity. The height of these laser scribe bumps is too small for laser scanning to see. The invention is capable of not only detecting the laser scribe region but also detecting particulates 532 on the laser scribe. FIG. 48 is a diagram illustrating the results of the optical inspection system for two metalized glass disk substrates, one with a micro scratch 524 and the other with non-uniform texture 528 in accordance with the invention. The micro scratch (approximately 75 angstrom deep) was intentionally made in the disk substrate texture to test the sensitivity of the breadboard system. The scratch 526 is very visible in the image as a very bright vertical line. The non-uniform texture in image 528 is also evident as numerous broad dark bands 529. The scratch and variation in the texture are also not visible to laser scanning systems.

In accordance with the invention, the optical inspection system described above may be used to inspect a single side of a substrate which will have significant advantages over existing single sided inspection systems, especially laser scanning systems. In accordance with the invention, the optical inspection system for single side detection may utilize the elements shown in FIGS. 5, 5A without the components for inspection of the second side. The optical inspection system for single side detection may also be configured as shown in FIGS. 26F-26H wherein the flip mirrors become fixed mirrors set to a single side detection position (for example the frontside) so that the detector only detects frontside scattering feature scatter from the substrate. The single sided inspection system in accordance with the invention may include a high dynamic range and high precision CID photodetector with characteristics described above, such as anti-blooming, high QE especially in the DUV, spectral detection range from 200 nm to 1110 nm, fast readout, large number of pixels (at least 2048×2048) and low noise. The single sided inspection system in accordance with the invention may also include an optical illumination path as described above with reference to FIGS. 16-17A for double sided systems including a broad spectrum source with significant DUV content, a dichroic mirror, an IR beam dump, a shutter, an optional wavelength band pass filters, an optional polarizer, a homogenizer, apertures, shadow casting or image relay optics that limit the darkfield illumination so the edges of the substrate are not illuminated, darkfield illumination angles of incidence from 50 to 75 degrees, beam collimation constrained within +/−2 degrees, >0.25 watts/in² intensity on the substrate, reasonable spectral uniformity (95%) and reasonable spatial uniformity (50%) on the substrate. A single sided inspection system in accordance with the invention may also include a brightfield source as in FIGS. 5, 5A. A single sided inspection system in accordance with the invention may also include beam dumps as in FIGS. 5 and 5A to collect the specularly reflected light from the substrate. A single sided inspection system in accordance with the invention may also include photodetector collection optics including an optional polarizer, refractive imaging lens designs as in FIG. 18 and a combination of Schwarzchild plus refractive lens design as in FIG. 19. The substrate holder may be simpler for a single sided inspection system than for a dual sided inspection system if backside substrate contact is allowed. If backside contact is allowed, a simple vacuum chuck in the center of the substrate can support the backside of the substrate, leaving the substrate edges completely unobstructed without the need for edge grippers, thus reducing system complexity and cost. Also, a single sided inspection system may also use the external substrate handling system to support the substrate while it is in the measurement chamber further reducing complexity and cost. A single sided inspection system may also use edge gripping wafer holders as described with reference to FIGS. 28A-28F.

These single sided inspection system aspects greatly increase the range of particle sizes measured in a single substrate measurement pass, enable differential measurements on substrates with large background scatter such as pattern substrates, enable simultaneous macro and micro inspection, provides much higher measurement throughput than a laser scanning system, have no moving parts during inspection for higher reliability and will not suffer from calibration and matching issues as for laser scanning systems. Differential measurements enable tracking process problem signatures. A single sided inspection system will also cost less and be smaller than a dual sided inspection system. A single sided inspection system can also be configured as described in reference to FIGS. 13B-13E. A single sided inspection system may inspect substrate frontside, backside or both, but not simultaneously. Single sided inspection system advantages include smaller size, about half the cost, addresses users who do not want dual sided inspection and/or users that only want backside inspection.

While the foregoing has been with reference to a particular embodiment of the invention, it will be appreciated by those skilled in the art that changes in this embodiment may be made without departing from the principles and spirit of the invention as set forth in the subsequent claims.

1. In optical inspection system, comprising:
an illumination source that generates electromagnetic radiation that illuminates a first side and a second side of a substrate inserted into an optical inspection system; and
a detector that detects a light scattering feature on the first side of the substrate from the illumination scattered from the light scattering feature on the first side of the substrate and that detects a light scattering feature on the second side of the substrate from the illumination scattered from the light scattering feature on the second side of the substrate wherein light scattering features on both sides of the substrate are simultaneously detected.

2. The system of claim 1, wherein the light scattering features further comprise one of a defect in the substrate, a scratch on a surface of the substrate, a pit on a surface of the substrate, a particle on a surface of the substrate, device patterns and pattern anomalies on a surface of the substrate, etched regions on a surface of the substrate, polish roughness on a surface of the substrate, texture on a surface of the substrate, embedded particles in films on a surface of the substrate and any aspect of a surface of the substrate that scatters light.

3. The system of claim 1, wherein the illumination source, substrate handler and the detector are incorporated into a stand-alone optical inspection system.

4. The system of claim 1, wherein the illumination source, substrate handler and the detector are incorporated into a benchtop optical inspection system.

5. The system of claim 1, wherein the optical inspection system is incorporated into a process tool system.

6. The system of claim 1, wherein the optical inspection system is incorporated into an equipment front end module system.

7. The system of claim 1, wherein the illumination source further comprises a polarizer to generate uniformly polarized electromagnetic radiation that is directed towards the substrate.

8. The system of claim 1, wherein the illumination source further comprises a shadow casting assembly that limits the electromagnetic radiation to the edges of the substrate.

9. The system of claim 1, wherein the illumination source further comprises an image relay assembly that limits the electromagnetic radiation to the edges of the substrate.

10. The system of claim 9, wherein the image relay assembly further comprises an aperture that limits the electromagnetic radiation generated by the illumination source to the edges of the substrate.

11. The system of claim 1, wherein the illumination source further comprises a first illumination source unit and a second illumination source unit, wherein the first illumination source unit provides electromagnetic radiation to the first side of the substrate and the second illumination source unit provides electromagnetic radiation to the second side of the substrate.

12. The system of claim 11, wherein the detector further comprises a first detector unit and a second detector unit wherein the first detector unit detects light scattering features on the first side of the substrate and the second detector unit detects light scattering features on the second side of the substrate.

13. The system of claim 1, wherein the detector further comprises a first detector unit and a second detector unit wherein the first detector unit detects light scattering features on the first side of the substrate and the second detector unit detects light scattering features on the second side of the substrate.

14. The system of claim 1, wherein the detector further comprises a movable detector unit that is movable between two or more positions so that the angle of the movable detector unit with respect to the substrate and the angle that the scattered illumination enters the movable detector unit is adjustable.

15. The system of claim 14, wherein the illumination source further comprises a movable illumination source unit that is movable between two or more positions so that the angle of the illumination illuminating the substrate is adjustable.

16. The system of claim 1, wherein the illumination source further comprises a movable illumination source unit that is movable between two or more positions so that the angle of the illumination illuminating the substrate is adjustable.

17. The system of claim 1, wherein the illumination source generates bright field illumination and dark field illumination.

18. The system of claim 1 further comprising a substrate handler that holds a substrate inserted into the optical inspection system so that light scattering features on the first and second sides of the substrate are detected simultaneously.

19. The system of claim 1, wherein the substrate further comprises a semiconductor wafer.

20. The system of claim 19, wherein the wafer is unpatterned.

21. The system of claim 19, wherein the wafer is patterned.

22. The system of claim 1, wherein the substrate further comprises a disk drive substrate.

23. The system of claim 1, wherein the illumination source further comprises a ring illumination source adjacent the periphery of the substrate that directs light towards the edges of the substrate so that a light scattering feature on one of an edge and a bevel of the substrate is detected.

24. The system of claim 1, wherein the illumination source further comprises a plurality of illumination source units that each illuminate a different parallel strip of the substrate to provide illumination uniformity.

25. The system of claim 1, wherein the illumination source further comprises a plurality of illumination source units located around the periphery of the substrate.

26. The system of claim 1, wherein the illumination source further comprises a set of light path optics that directs the illumination energy from the illumination source to the substrate.

27. The system of claim 1, wherein the illumination source further comprises an electromagnetic radiation source that generates at least deep ultraviolet electromagnetic energy.

28. The system of claim 1, wherein the detector further comprises a high dynamic range, high precision detector array that is capable of detecting small light scattering features close to large scattering features, differential measurements where small scattering features have been added to high scatter regions and process signatures.

29. The system of claim 1, wherein the detector further comprises a high dynamic range, high precision detector array that is capable of detecting brightfield substrate features.

30. The system of claim 1, wherein the detector further comprises a high dynamic range, high precision detector array that is capable of detecting bar code and alphanumeric substrate identification substrate features.

31. The system of claim 1, wherein the detector further comprises an anti-blooming detector.

32. The system of claim 31, wherein the detector provides random access read-out of each pixel associated with the detector and the read-out of each pixel of the detector is non-destructive.

33. The system of claim 1, wherein the detector further comprises a detector head that comprises a detector chip and a microprocessor that controls the operation of the detector chip.

34. The system of claim 1, wherein the detector further comprises a back thinned detector chip so that electromagnetic radiation is detected through a backside of the detector chip.

35. The system of claim 1, wherein the detector further comprises one or more detector chips each having an array of detector pixels wherein each detector chip is butted against another detector chip to form an larger array of detector pixels.

36. The system of claim 1, wherein an angle of incidence of scattering feature illumination light on the detector is between 50 degrees and 0.75 degrees.

37. The system of claim 1, wherein the scattering feature light impinging on the detector is collimated to less than or equal to +/−2 degrees from the nominal angle of incidence.

38. The system of claim 1, wherein the scattering feature light impinging on the substrate is spatially uniform in intensity across the substrate with uniformity equal to or greater than 50%.

39. The system of claim 1, wherein the scattering feature light impinging on the substrate is spectrally uniform across the beam collimated equal to or greater than 95%

40. The system of claim 1, wherein the detector further comprises collection optics that images the scattered illumination from the light scattering features of the substrate onto the detector.

41. The system of claim 1, wherein the detector further comprises collection optics having a device that scans through a plurality of wavelengths during the inspection of the substrate.

42. The system of claim 1, wherein the illumination source further comprises a device that scans through a plurality of wavelengths during the inspection of the substrate.

43. The system of claim 42, wherein the wavelength scanning device further comprises a wavelength selectable filter that adjust the wavelength of the electromagnetic radiation during the inspection of a substrate to classify the light scattering feature on the surface of the substrate.

44. The system of claim 1, wherein the illumination source delivers at least 0.25 watts per square inch to the substrate.

45. The system of claim 44, wherein the illumination source delivers more than 0.25 watts per square inch to the substrate.

46. The system of claim 1, wherein the illumination source further comprises an arc lamp source that produces deep ultraviolet electromagnetic radiation.

47. The system of claim 1, wherein the illumination source further comprises one of a laser source, a light emitting diode source, a combination of sources such as deuterium and tungsten, and arc lamps with mercury or other gas mixtures all that produce deep ultraviolet electromagnetic radiation.

48. The system of claim 1, wherein the illumination source further comprises a focused arc source which reduces the optics needed to focus the electromagnetic radiation onto the substrate.

49. The system of claim 1, wherein the illumination source further comprises a broadband electromagnetic radiation source that generates electromagnetic radiation at a plurality of wavelengths.

50. The system of claim 49, wherein the plurality of wavelengths further comprises 200 nm to 1100 nm.

51. The system of claim 1, wherein the illumination source is modulated which improves the signal to noise ratio of the system.

52. The system of claim 1, wherein the detector further comprises a collection light path from the substrate to the detector, the light path further comprising refractive elements wherein the scattered illumination from the light scattering features on the substrate is imaged onto the detector.

53. The system of claim 1, wherein the detector further comprises a collection light path from the substrate to the detector, the light path further comprising a refractive lens and a reflective Schwarzchild lens.

54. The system of claim 1, wherein the detector further comprises a plurality of pixels and a microlens associated with each pixel of the detector wherein the each microlens focuses the scattering feature illumination onto the pixel associated with the microlens.

55. The system of claim 1, wherein the detector further comprises a sensor device having a plurality of pixels, each pixel of the digital sensor having an integrated pixel pre-amplifier.

56. The system of claim 55, wherein the sensor further comprises a charge injection device.

57. The system of claim 1, wherein the detector further comprises a CMOS sensor.

58. The system of claim 1, wherein the detector further comprises a CCD sensor.

59. The system of claim 1, wherein the detector further comprises a photodiode array sensor.

60. The system of claim 1, wherein the detector further comprises a plurality of sensor elements wherein the sensor elements are adjacent each other to form the detector.

61. The system of claim 1, wherein the detector further comprises a computer that processes digital data corresponding to the scattered illumination from the light scattering feature on the substrate.

62. The system of claim 61, wherein the detector further comprises a dithering process.

63. The system of claim 61, wherein the detector further comprises a random integration process.

64. The system of claim 18, wherein the substrate handler further comprises a substrate holder further comprising one or more edge gripper mechanisms that support the substrate at its edges so that both sides of the substrate are optically inspected.

65. The system of claim 64, wherein the substrate handler further comprises one or more wheels that rotate the substrate holder to position the substrate.

66. The system of claim 64, wherein the substrate handler further comprises one or more ring bearings that permit rotation of the substrate holder to position the substrate.

67. The system of claim 64, wherein the edge gripper mechanism further comprise an edge gripper structure and a support structure wherein the edge gripper structure grips the substrate and the support structure supports the substrate when the edge gripper structure is retracted.

68. The system of claim 67, wherein the support structure has a beveled portion and a flat pad end portion wherein the substrate rests on the beveled portion.

69. The system of claim 68, wherein the edge gripper structure further comprises a tapered region and a beveled indentation end of the tapered region, the beveled indentation end gripping an edge of the substrate without extending beyond the edge of the substrate.

70. The system of claim 64, wherein the edge gripper mechanism further comprises a support structure and an edge gripper structure integrated into the support structure to grip the substrate wherein the edge gripper structure extends out from the support structure when the substrate is being gripped.

71. The system of claim 70, wherein the support structure has a beveled portion and a flat pad end portion wherein the substrate rests on the beveled portion.

72. The system of claim 71, wherein the edge gripper structure further comprises a tapered region and a beveled indentation end of the tapered region, the beveled indentation end gripping an edge of the substrate without extending beyond the edge of the substrate.

73. The system of claim 18, wherein the substrate handler further comprises an edge gripper mechanism and a lifting mechanism wherein the lifting mechanism moves the substrate into a position and retracts away from the substrate.

74. The system of claim 73, wherein the edge gripper mechanism further comprise an edge gripper structure and a support structure wherein the edge gripper structure grips the substrate and the support structure supports the substrate when the edge gripper structure is retracted.

75. The system of claim 74, wherein the support structure has a beveled portion and a flat pad end portion wherein the substrate rests on the beveled portion.

76. The system of claim 75, wherein the edge gripper structure further comprises a tapered region and a beveled indentation end of the tapered region, the beveled indentation end gripping an edge of the substrate without extending beyond the edge of the substrate.

77. The system of claim 73, wherein the edge gripper mechanism further comprises a support structure and an edge gripper structure integrated into the support structure to support the substrate and grip the substrate wherein the edge gripper structure extends out from the support structure when the substrate is being gripped.

78. The system of claim 77, wherein the support structure has a beveled portion and a flat pad end portion wherein the substrate rests on the beveled portion.

79. The system of claim 78, wherein the edge gripper structure further comprises a tapered region and a beveled indentation end of the tapered region, the beveled indentation end gripping an edge of the substrate without extending beyond the edge of the substrate.

80. The system of claim 1 further comprising a computer system that controls the operation of the illumination source and the detector, wherein the computer system further comprises a differential measurement process wherein an initial light scattering feature measurement is subtracted from a subsequent light scattering feature measurement.

81. The system of claim 1 further comprising a sealed enclosure to reduce contaminants within the optical inspection system.

82. The system of claim 81, wherein the sealed enclosure is one or more of vacuum tight, gas tight and light tight.

83. The system of claim 1, wherein the illumination source further comprises an edge illumination source that directs electromagnetic radiation towards an edge and bevel of the substrate so that the detector receives the illumination scattered from a light scattering feature on the bevel and edge of the substrate and detects light scattering features on the bevel and edge of the substrate.

84. The system of claim 41, wherein the wavelength scanning device further comprises a wavelength band pass filter that selectively permits scattering feature illumination for a particular wavelength to impinge of the detector.

85. The system of claim 1, wherein the illumination source further comprises a shutter that blocks the electromagnetic radiation before the electromagnetic radiation illuminates the substrate.

86. The system of claim 1, wherein the illumination source further comprises an intensity sensor that measures the intensity of the electromagnetic radiation emitted by the illumination source.

87. The system of claim 1, wherein the detector further comprises a polarizer that filters the scattering feature light according to the polarization of the scattering feature scattered light.

88. The system of claim 87, wherein the illumination source further comprises a polarizer that is aligned so that the illumination is cross polarized with respect to the polarizer at the detector.

89. The system of Clam 1, wherein the illumination source further comprises a homogenizer.

90. The system of claim 1, wherein the illumination source further comprises a device that filters infrared electromagnetic radiation out of the illumination directed towards the substrate.

91. The system of claim 1, wherein the illumination source generates infrared electromagnetic radiation that is directed towards the substrate to measure characteristics of the substrate including one of film thickness, substrate structure, thickness and uniformity.

92. The system of claim 1 further comprising a computer system that controls the illumination source and the detector, the computer system further comprising a module for determining a process problem signature based on the light scattering features detected on the substrate.

93. The system of claim 18, wherein the substrate handler orients a notch of the substrate at approximately 45 degrees with respect to the electromagnetic radiation from the illumination source.

94. The system of claim 1, wherein the illumination source further comprises a dual ring illumination source that illuminates an edge and a bevel of the substrate to detect light scattering features on the edge and bevel of the substrate.

95. The system of claim 1 further comprising a flip mirror that directs the electromagnetic radiation from the illumination source to both surfaces of the substrate at different time periods.

96. The system of claim 95 further comprising a second flip mirror that directs the illumination from the light scattering features on the first side to the detector at a predetermined time and that directs the illumination from the light scattering features on the second side to the detector at a second predetermined time.

97. The system of claim 1 further comprising a beam dump that absorbs the illumination that is not scattered by the light scattering features on the first and second sides of the substrate, the beam dump further comprising one or more light absorbing plates wherein the light is reflected between the one or more light absorbing plates.

98. The system of claim 97, wherein the one or more light absorbing plates further comprises a first light absorbing plate positioned so that the light strikes the first light absorbing plate at an angle of 30 to 60 degrees.

99. The system of claim 22, wherein the disk drive substrate further comprises a disk region that surrounds a central hole and wherein the illumination source generates a washer shaped, illumination pattern that illuminates the disk region but not the central hole.

100. The system of claim 99, wherein the illumination source further comprises a first illumination source that generates an illumination pattern that illuminates a first portion of the disk region wherein the disk region is entirely illuminated when the disk drive substrate is rotated.

101. The system of claim 99, wherein the illumination source further comprises a second illumination source that generates an illumination pattern that illuminates a second portion of the disk region different from the first portion, wherein the first and second illumination sources are rotated 90 degrees with respect to each other and the first and second portions of the disk region comprise the entire disk region and the illumination is parallel to the texture thereby enhancing particle and pit defects while suppressing texture scatter.

102. The system of claim 99, wherein the illumination source generates electromagnetic radiation that is perpendicular to a texture of the disk drive substrate to measure the texture of the disk drive substrate.

103. An optical inspection method, comprising:
generating illumination that illuminates a first side and a second side of a substrate inserted into the optical inspection system; and
receiving, at a detector, illumination scattered from a light scattering feature on the first side of the substrate and illumination scattered from a light scattering feature on the second side of the substrate; and
detecting the light scattering features on the first side of the substrate corresponding to the illumination scattered from the light scattering feature on the first side of the substrate and detecting light scattering features on the second side of the substrate corresponding to the illumination scattered from the light scattering feature on the second side of the substrate wherein light scattering features on both sides of the substrate are simultaneously detected.

104. The method of claim 103, wherein the light scattering features further comprise one of a defect in the substrate, a scratch on a surface of the substrate, a pit on a surface of the substrate, a particle on a surface of the substrate, device patterns and pattern anomalies on a surface of the substrate, etched regions on a surface of the substrate, polish roughness on a surface of the substrate, texture on a surface of the substrate, embedded particles in films on a surface of the substrate and any aspect of a surface of the substrate that scatters light.

105. The method of claim 103, wherein generating the illumination further comprises generating uniformly polarized electromagnetic radiation that is directed towards the substrate.

106. The method of claim 103, wherein generating the illumination further comprises using a shadow casting assembly that limits the electromagnetic radiation to the edges of the substrate.

107. The method of claim 103, wherein generating the illumination further comprises using an image relay assembly that limits the electromagnetic radiation to the edges of the substrate.

109. The method of claim 103, wherein generating the illumination further comprises providing electromagnetic radiation to the first side of the substrate using a first illumination source unit and providing electromagnetic radiation to the second side of the substrate using a second illumination source unit.

110. The method of claim 109, wherein detection further comprises detecting light scattering features on the first side of the substrate using a first detector unit and detecting light scattering features on the second side of the substrate using a second detector unit.

111. The method of claim 103, wherein detection further comprises detecting light scattering features on the first side of the substrate using a first detector unit and detecting light scattering features on the second side of the substrate using a second detector unit.

112. The method of claim 103, wherein detection further comprises moving a detector unit between two or more positions so that the angle of the movable detector unit with respect to the substrate and the angle that the scattered illumination enters the movable detector unit is adjustable.

113. The method of claim 112, wherein illumination further moving an illumination source unit between two or more positions so that the angle of the illumination illuminating the substrate is adjustable.

114. The method of claim 103, wherein illumination further comprises moving the illumination source unit between two or more positions so that the angle of the illumination illuminating the substrate is adjustable.

115. The method of claim 103, wherein the illumination further comprises generating bright field illumination and dark field illumination.

116. The method of claim 103 further comprising holding a substrate with a substrate handler so that light scattering features on the first and second sides of the substrate are detected simultaneously.

117. The method of claim 103, wherein the substrate further comprises a semiconductor wafer.

118. The method of claim 117, wherein the wafer is unpatterned.

119. The method of claim 117, wherein the wafer is patterned.

120. The method of claim 103, wherein the substrate further comprises a disk drive substrate.

121. The method of claim 103, wherein the illumination further comprises using a ring illumination source adjacent the periphery of the substrate that directs light towards the edges of the substrate so that a light scattering feature on one of an edge and a bevel of the substrate is detected.

122. The method of claim 103, wherein the illumination further comprises illuminating a different parallel strip of the substrate using a plurality of illumination source units to provide illumination uniformity.

123. The method of claim 103, wherein the illumination further comprises using a plurality of illumination source units located around the periphery of the substrate.

124. The method of claim 103, wherein the illumination further comprises directing the illumination energy from the illumination source to the substrate using a set of light path optics.

125. The method of claim 103, wherein the illumination further comprises generating at least deep ultraviolet electromagnetic energy.

126. The method of claim 103, wherein the detection further comprises detecting light scattering features close to large scattering features, differential measurements where small scattering features have been added to high scatter regions and process signatures using a high dynamic range, high precision detector array.

127. The method of claim 103, wherein the detection further comprises detecting brightfield substrate features using a high dynamic range, high precision detector array.

128. The method of claim 103, wherein the detection further comprises detecting bar code and alphanumeric substrate identification substrate features using a high dynamic range, high precision detector array.

129. The method of claim 103, wherein the detection further comprises using an anti-blooming detector.

130. The method of claim 129, wherein the detection further comprises providing random access read-out of each pixel associated with the detector and the read-out of each pixel of the detector is non-destructive.

131. The method of claim 103, wherein the detection further comprises using a detector head that comprises a detector chip and a microprocessor that controls the operation of the detector chip.

132. The method of claim 103, wherein the detection further comprises detecting electromagnetic radiation through a backside of a detector chip using a back thinned detector chip.

133. The method of claim 103, wherein the detection further comprises butting one or more detector chips each having an array of detector pixels against each other to form an larger array of detector pixels.

134. The method of claim 103, wherein an angle of incidence of scattering feature illumination light on the detector is between 50 degrees and 75 degrees.

135. The method of claim 103, wherein the scattering feature light impinging on the detector is collimated to less than or equal to +/−2 degrees from the nominal angle of incidence.

136. The method of claim 103, wherein the scattering feature light impinging on the substrate is spatially uniform in intensity across the substrate with uniformity equal to or greater than 50%.

137. The method of claim 103, wherein the scattering feature light impinging on the substrate is spectrally uniform across the beam collimated equal to or greater than 95%

138. The method of claim 103, wherein the detection further comprises imaging the scattered illumination from the light scattering features of the substrate onto the detector.

139. The method of claim 103, wherein the detection further comprises scanning through a plurality of wavelengths during the inspection of the substrate.

140. The method of claim 103, wherein the illumination further comprises scanning through a plurality of wavelengths during the inspection of the substrate.

141. The method of claim 140, wherein the wavelength scanning further comprises using a wavelength selectable filter that adjust the wavelength of the electromagnetic radiation during the inspection of a substrate to classify the light scattering feature on the surface of the substrate.

142. The method of claim 103, wherein the illumination further comprising delivering at least 0.25 watts per square inch to the substrate.

143. The method of claim 142, wherein the illumination further comprising delivering more than 0.25 watts per square inch to the substrate.

144. The method of claim 103, wherein the illumination further comprises using an arc lamp source that produces deep ultraviolet electromagnetic radiation.

145. The method of claim 103, wherein the illumination further comprises using one of a laser source, a light emitting diode source, a combination of sources such as deuterium and tungsten, and arc lamps with mercury or other gas mixtures.

146. The method of claim 103, wherein the illumination further comprises using a focused arc source which reduces the optics needed to focus the electromagnetic radiation onto the substrate.

147. The method of claim 103, wherein the illumination further comprises using a broadband electromagnetic radiation source that generates electromagnetic radiation at a plurality of wavelengths.

148. The method of claim 147, wherein the plurality of wavelengths further comprises 200 nm to 1100 nm.

149. The method of claim 103, wherein the illumination further comprising modulating the illumination to improve the signal to noise ratio.

150. The method of claim 103, wherein the detection further comprises using refractive elements to collect the scattered illumination wherein the scattered illumination from the light scattering features on the substrate is imaged onto the detector.

151. The method of claim 103, wherein the detection further comprises using a collection light path from the substrate to the detector, the light path further comprising a refractive lens and a reflective Schwarzchild lens.

152. The method of claim 103, wherein the detection further comprises using a plurality of pixels and a microlens associated with each pixel of the detector wherein the each microlens focuses the scattering feature illumination onto the pixel associated with the microlens.

153. The method of claim 103, wherein the detection further comprises using a digital sensor device having a plurality of pixels, each pixel of the digital sensor having an integrated pixel pre-amplifier.

154. The method of claim 153, wherein using the digital sensor further comprises using a charge injection device.

155. The method of claim 103, wherein the detection further comprises using a CMOS sensor.

156. The method of claim 103, wherein the detection further comprises using a CCD sensor.

157. The method of claim 103, wherein the detection further comprises using a photodiode array sensor.

158. The method of claim 103, wherein the detection further comprises using a plurality of sensor elements wherein the sensor elements are adjacent each other to form the detector.

159. The method of claim 103, wherein the detection further comprises using a computer that processes digital data corresponding to the scattered illumination from the light scattering feature on the substrate.

160. The method of claim 159, wherein the detection further comprises a dithering process.

161. The method of claim 159, wherein the detection further comprises a random integration process.

162. The method of claim 116, wherein the substrate handling further comprises using a substrate holder further comprising one or more edge gripper mechanisms that support the substrate at its edges so that both sides of the substrate are optically inspected.

163. The method of claim 162, wherein the substrate handling further comprises using one or more wheels that rotate the substrate holder to position the substrate.

164. The method of claim 162, wherein the substrate handling further comprises using one or more ring bearings that permit rotation of the substrate holder to position the substrate.

165. The method of claim 162, wherein using the edge gripper mechanism further comprise using an edge gripper structure and a support structure wherein the edge gripper structure grips the substrate and the support structure supports the substrate when the edge gripper structure is retracted.

166. The method of claim 165, wherein the support structure has a beveled portion and a flat pad end portion wherein the substrate rests on the beveled portion.

167. The method of claim 166, wherein the edge gripper structure further comprises a tapered region and a beveled indentation end of the tapered region, the beveled indentation end gripping an edge of the substrate without extending beyond the edge of the substrate.

168. The method of claim 162, wherein using the edge gripper mechanism further comprises using a support structure and an edge gripper structure integrated into the support structure to grip the substrate wherein the edge gripper structure extends out from the support structure when the substrate is being gripped.

169. The method of claim 168, wherein the support structure has a beveled portion and a flat pad end portion wherein the substrate rests on the beveled portion.

170. The method of claim 169, wherein the edge gripper structure further comprises a tapered region and a beveled indentation end of the tapered region, the beveled indentation end gripping an edge of the substrate without extending beyond the edge of the substrate.

171. The method of claim 116, wherein the substrate handling further comprises using an edge gripper mechanism and a lifting mechanism wherein the lifting mechanism moves the substrate into a position and retracts away from the substrate.

172. The method of claim 171, wherein using the edge gripper mechanism further comprise using an edge gripper structure and a support structure wherein the edge gripper structure grips the substrate and the support structure supports the substrate when the edge gripper structure is retracted.

173. The method of claim 172, wherein the support structure has a beveled portion and a flat pad end portion wherein the substrate rests on the beveled portion.

174. The method of claim 173, wherein the edge gripper structure further comprises a tapered region and a beveled indentation end of the tapered region, the beveled indentation end gripping an edge of the substrate without extending beyond the edge of the substrate.

175. The method of claim 171, wherein using the edge gripper mechanism further comprises using a support structure and an edge gripper structure integrated into the support structure to support the substrate and grip the substrate wherein the edge gripper structure extends out from the support structure when the substrate is being gripped.

176. The method of claim 175, wherein the support structure has a beveled portion and a flat pad end portion wherein the substrate rests on the beveled portion.

177. The method of claim 176, wherein the edge gripper structure further comprises a tapered region and a beveled indentation end of the tapered region, the beveled indentation end gripping an edge of the substrate without extending beyond the edge of the substrate.

178. The method of claim 103 further comprising controlling the operation of the illumination source and the detector using a computer system, wherein the computer system further comprises a differential measurement process wherein an initial light scattering feature measurement is subtracted from a subsequent light scattering feature measurement.

179. The method of claim 103 further comprising using a sealed enclosure to reduce contaminants within the optical inspection method.

180. The method of claim 179, wherein the sealed enclosure is one or more of vacuum tight, gas tight and light tight.

181. The method of claim 103, wherein the illumination further comprises using an edge illumination source that directs electromagnetic radiation towards a bevel of the substrate so that the detector receives the illumination scattered from a light scattering feature on the bevel of the substrate and detects light scattering features on the bevel of the substrate.

182. The method of claim 134, wherein the wavelength scanning further comprises using a wavelength band pass filter that selectively permits scattering feature illumination for a particular wavelength to impinge of the detector.

183. The method of claim 103, wherein the illumination further comprises using a shutter that blocks the electromagnetic radiation before the electromagnetic radiation illuminates the substrate.

184. The method of claim 103, wherein the illumination further comprises measuring the intensity of the electromagnetic radiation emitted by the illumination source using an intensity sensor.

185. The method of claim 103, wherein the detection further comprises filtering the scattering feature light according to the polarization of the scattering feature scattered light.

186. The method of claim 185, wherein the illumination further comprises using a polarizer that is aligned so that the scattering feature scattered light is cross polarized with respect to the polarizer at the detector.

187. The method of Clam 103, wherein the illumination further comprises using a homogenizer.

188. The method of claim 103, wherein the illumination further comprises filtering infrared electromagnetic radiation out of the illumination directed towards the substrate.

189. The method of claim 103, wherein the illumination further comprising generating infrared electromagnetic radiation that is directed towards the substrate to measure characteristics of the substrate including one of film thickness, substrate structure, thickness and uniformity.

190. The method of claim 103 further comprising controlling the illumination source and the detector using a computer system, the computer system further comprising a module for determining a process problem signature based on the light scattering features detected on the substrate.

191. The method of claim 116, wherein the substrate handling further comprising orienting a notch of the substrate at approximately 45 degrees with respect to the electromagnetic radiation from the illumination source.

192. The method of claim 103, wherein the illumination further comprises using a dual ring illumination source that illuminates an edge and a bevel of the substrate to detect light scattering features on the edge and bevel of the substrate.

193. The method of claim 103 further comprising a directs the electromagnetic radiation from the illumination source to both surfaces of the substrate at different time periods.

194. The method of claim 193 further comprising directing the illumination from the light scattering features on the first side to the detector at a predetermined time and directing the illumination from the light scattering features on the second side to the detector at a second predetermined time.

195. The method of claim 103 further comprising absorbing the illumination that is not scattered by the light scattering features on the first and second sides of the substrate, the absorbing further comprising reflecting the illumination between the one or more light absorbing plates.

196. The method of claim 195, wherein the absorbing further comprising positioning a first light absorbing plate so that the light strikes the first light absorbing plate at an angle of 30 to 60 degrees.

197. The method of claim 120, wherein the disk drive substrate further comprises a disk region that surrounds a central hole and wherein the illumination source generates a washer shaped illumination pattern that illuminates the disk region but not the central hole.

198. The method of claim 197, wherein the illumination further comprises generating an illumination pattern using a first illumination unit that illuminates a first portion of the disk region wherein the disk region is entirely illuminated when the disk drive substrate is rotated.

199. The method of claim 197, wherein the illumination further comprises generating an illumination pattern that illuminates a second portion of the disk region different from the first portion using a second illumination source, wherein the first and second illumination sources are rotated 90 degrees with respect to each other and the first and second portions of the disk region comprise the entire disk region.

200. The method of claim 197, wherein the illumination further comprises generating electromagnetic radiation that is perpendicular to a texture of the disk drive substrate to measure the texture of the disk drive substrate.

201. A light collection system, comprising:
a detector; and
light collection optics that direct collimated electromagnetic radiation towards the detector, the light collection optics providing deep ultraviolet electromagnetic transmission, small blur and low distorting images to the detector.

202. The system of claim 201, wherein the light collection optics has a device that scan through a plurality of wavelengths during the inspection of the substrate.

203. The illumination source of claim 202, wherein the wavelength scanning device further comprises a wavelength selectable filter that adjust the wavelength of the electromagnetic radiation during the inspection of a substrate to classify the light scattering feature on the surface of the substrate.

204. The system of claim 201, wherein the light collection optics further comprise a refractive lens and a reflective Schwarzchild lens.

205. The system of claim 201, wherein the light collection optics further comprise a microlens associated with each pixel of the detector, each microlens focusing the electromagnetic radiation onto a particular pixel of the detector.

206. A digital image detector, comprising:
a plurality of pixels arranged in an array wherein each pixel detects electromagnetic radiation that impinges on that pixel; and
each pixel having a pre-amplifier that amplifies the signal from that pixel.

207. The detector of claim 206 further comprising a microlens associated with each pixel of the detector, each microlens focusing electromagnetic radiation onto the pixel associated with the microlens.

208. The detector of claim 206, wherein the detector further comprises a charge injection device.

209. The detector of claim 206, wherein the detector further comprises a plurality of sensor elements wherein the sensor elements are adjacent each other to form the detector.

210. The detector of claim 206, wherein the detector-further comprises a computer that processes the digital data corresponding to the scattered illumination from the substrate.

211. The detector of claim 210, wherein the computer further comprises a dithering module.

212. A substrate handler, comprising:
a substrate holder that is capable of holding a substrate so that a first side and a second side of a substrate are capable of being illuminated simultaneously; and
wherein the substrate is held by its edges.

213. The substrate handler of claim 212 further comprising a moving mechanism wherein the moving mechanism further comprises one or more wheels that rotate the substrate holder to position the substrate, the substrate holder further comprising one or more edge gripper mechanisms that support the substrate at its edges.

214. The substrate handler of claim 212 further comprising a moving mechanism wherein the moving mechanism further comprises one or more ring bearings that permit rotation of the holder to position the substrate, the substrate holder further comprising one or more edge gripper mechanisms that support the substrate at its edges.

215. The substrate handler of claim 213, wherein the edge gripper mechanism further comprise an edge gripper structure and a support structure wherein the edge gripper structure grips the substrate and the support structure supports the substrate when the edge gripper structure is retracted.

216. The substrate handler of claim 215, wherein the support structure has a beveled portion and a flat pad end portion wherein the substrate rests on the beveled portion.

217. The substrate handler of claim 216, wherein the edge gripper structure further comprises a tapered region and a beveled indentation end of the tapered region, the beveled indentation end gripping an edge of the substrate without extending beyond the edge of the substrate.

218. The substrate handler of claim 213, wherein the edge gripper mechanism further comprises a support structure and an edge gripper structure integrated into the support structure to grip the substrate wherein the edge gripper structure extends out from the support structure when the substrate is being gripped.

219. The substrate handler of claim 218, wherein the support structure has a beveled portion and a flat pad end portion wherein the substrate rests on the beveled portion.

220. The substrate handler of claim 219, wherein the edge gripper structure further comprises a tapered region and a beveled indentation end of the tapered region, the beveled indentation end gripping an edge of the substrate without extending beyond the edge of the substrate.

221. The substrate handler of claim 212, wherein the substrate holder further comprises an edge gripper mechanism and a lifting mechanism wherein the lifting mechanism moves the substrate into a position and retracts away from the substrate.

222. The substrate handler of claim 221, wherein the edge gripper mechanism further comprise an edge gripper structure and a support structure wherein the edge gripper structure grips the substrate and the support structure supports the substrate when the edge gripper structure is retracted.

223. The substrate handler of claim 222, wherein the support structure has a beveled portion and a flat pad end portion wherein the substrate rests on the beveled portion.

224. The substrate handler of claim 223, wherein the edge gripper structure further comprises a tapered region and a beveled indentation end of the tapered region, the beveled indentation end gripping an edge of the substrate without extending beyond the edge of the substrate.

225. The substrate handler of claim 221, wherein the edge gripper mechanism further comprises a support structure and an edge gripper structure integrated into the support structure to grip the substrate wherein the edge gripper structure extends out from the support structure when the substrate is being gripped.

226. The substrate handler of claim 225, wherein the support structure has a beveled portion and a flat pad end portion wherein the substrate rests on the beveled portion.

227. The substrate handler of claim 226, wherein the edge gripper structure further comprises a tapered region and a beveled indentation end of the tapered region, the beveled indentation end gripping an edge of the substrate without extending beyond the edge of the substrate.

228. An optical inspection system, comprising:
an illumination source that generates electromagnetic radiation that illuminates a first side of a substrate inserted into an optical inspection system; and
a detector that detects a light scattering feature on the first side of the substrate from the illumination scattered from the light scattering feature on the first side of the substrate wherein the light scattering feature from below 0.1 microns to 100 microns is detected.

229. The system of claim 228, wherein the light scattering features further comprise one of a defect in the substrate, a scratch on a surface of the substrate, a pit on a surface of the substrate, a particle on a surface of the substrate, device patterns and pattern anomalies on a surface of the substrate, etched regions on a surface of the substrate, polish roughness on a surface of the substrate, texture on a surface of the substrate, embedded particles in films on a surface of the substrate and any aspect of a surface of the substrate that scatters light.

230. The system of claim 228, wherein the illumination source, substrate handler and the detector are incorporated into a stand-alone optical inspection system.

231. The system of claim 228, wherein the illumination source, substrate handler and the detector are incorporated into a benchtop optical inspection system.

232. The system of claim 228, wherein the optical inspection system is incorporated into a process tool system.

233. The system of claim 228, wherein the optical inspection system is incorporated into an equipment front end module system.

234. The system of claim 228, wherein the illumination source further comprises a polarizer to generate uniformly polarized electromagnetic radiation that is directed towards the substrate.

235. The system of claim 228, wherein the illumination source further comprises a shadow casting assembly that limits the electromagnetic radiation to the edges of the substrate.

236. The system of claim 228, wherein the illumination source further comprises an image relay assembly that limits the electromagnetic radiation to the edges of the substrate.

237. The system of claim 236, wherein the image relay assembly further comprises an aperture that limits the electromagnetic radiation generated by the illumination source to the edges of the substrate.

238. The system of claim 228, wherein the detector further comprises a movable detector unit that is movable between two or more positions so that the angle of the movable detector unit with respect to the substrate and the angle that the scattered illumination enters the movable detector unit is adjustable.

239. The system of claim 238, wherein the illumination source further comprises a movable illumination source unit that is movable between two or more positions so that the angle of the illumination illuminating the substrate is adjustable.

240. The system of claim 228, wherein the illumination source further comprises a movable illumination source unit that is movable between two or more positions so that the angle of the illumination illuminating the substrate is adjustable.

241. The system of claim 228, wherein the illumination source generates bright field illumination and dark field illumination.

242. The system of claim 228 further comprising a substrate handler that holds a substrate inserted into the optical inspection system.

243. The system of claim 228, wherein the substrate further comprises a semiconductor wafer.

244. The system of claim 243, wherein the wafer is unpatterned.

245. The system of claim 243, wherein the wafer is patterned.

246. The system of claim 228, wherein the substrate further comprises a disk drive substrate.

247. The system of claim 228, wherein the illumination source further comprises a ring illumination source adjacent the periphery of the substrate that directs light towards the edges of the substrate so that a light scattering feature on one of an edge and a bevel of the substrate is detected.

248. The system of claim 228, wherein the illumination source further comprises a plurality of illumination source units that each illuminate a different parallel strip of the substrate to provide illumination uniformity.

249. The system of claim 228, wherein the illumination source further comprises a plurality of illumination source units located around the periphery of the substrate.

250. The system of claim 228, wherein the illumination source further comprises a set of light path optics that directs the illumination energy from the illumination source to the substrate.

251. The system of claim 228, wherein the illumination source further comprises an electromagnetic radiation source that generates at least deep ultraviolet electromagnetic energy.

252. The system of claim 228, wherein the detector further comprises a high dynamic range, high precision detector array that is capable of detecting light scattering features close to large scattering features, differential measurements where small scattering features have been added to high scatter regions and process signatures.

253. The system of claim 228, wherein the detector further comprises a high dynamic range, high precision detector array that is capable of detecting brightfield substrate features.

254. The system of claim 228, wherein the detector further comprises a high dynamic range, high precision detector array that is capable of detecting bar code and alphanumeric substrate identification substrate features.

255. The system of claim 228, wherein the detector further comprises an anti-blooming detector.

256. The system of claim 255, wherein the detector provides random access read-out of each pixel associated with the detector and the read-out of each pixel of the detector is non-destructive.

257. The system of claim 228, wherein the detector further comprises a detector head that comprises a detector chip and a microprocessor that controls the operation of the detector chip.

258. The system of claim 228, wherein the detector further comprises a back thinned detector chip so that electromagnetic radiation is detected through a backside of the detector chip.

259. The system of claim 228, wherein the detector further comprises one or more detector chips each having an array of detector pixels wherein each detector chip is butted against another detector chip to form an larger array of detector pixels.

260. The system of claim 228, wherein an angle of incidence of scattering feature illumination light on the detector is between 50 degrees and 75 degrees.

261. The system of claim 228, wherein the scattering feature light impinging on the detector is collimated to less than or equal to +/−2 degrees from the nominal angle of incidence.

262. The system of claim 228, wherein the scattering feature light impinging on the substrate is spatially uniform in intensity across the substrate with uniformity equal to or greater than 50%.

263. The system of claim 228, wherein the scattering feature light impinging on the substrate is spectrally uniform across the beam collimated equal to or greater than 95%

264. The system of claim 228, wherein the detector further comprises collection optics that images the scattered illumination from the light scattering features of the substrate onto the detector.

265. The system of claim 228, wherein the detector further comprises collection optics having a device that scans through a plurality of wavelengths during the inspection of the substrate.

266. The system of claim 228, wherein the illumination source further comprises a device that scans through a plurality of wavelengths during the inspection of the substrate.

267. The system of claim 266, wherein the wavelength scanning device further comprises a wavelength selectable filter that adjust the wavelength of the electromagnetic radiation during the inspection of a substrate to classify the light scattering feature on the surface of the substrate.

268. The system of claim 228, wherein the illumination source delivers at least 0.25 watts per square inch to the substrate.

269. The system of claim 268, wherein the illumination source delivers more than 0.25 watts per square inch to the substrate.

270. The system of claim 228, wherein the illumination source further comprises an arc lamp source that productes deep ultraviolet electromagnetic radiation.

271. The system of claim 228, wherein the illumination source further comprises one of a laser source, a light emitting diode source, a combination of sources such as deuterium and tungsten, and arc lamps with mercury or other gas mixtures.

272. The system of claim 228, wherein the illumination source further comprises a focused arc source which reduces the optics needed to focus the electromagnetic radiation onto the substrate.

273. The system of claim 228, wherein the illumination source further comprises a broadband electromagnetic radiation source that generates electromagnetic radiation at a plurality of wavelengths.

274. The system of claim 273, wherein the plurality of wavelengths further comprises 200 nm to 1100 nm.

275. The system of claim 228, wherein the illumination source is modulated which improves the signal to noise ratio of the system.

276. The system of claim 228, wherein the detector further comprises a collection light path from the substrate to the detector, the light path further comprising refractive elements wherein the scattered illumination from the light scattering features on the substrate is imaged onto the detector.

277. The system of claim 228, wherein the detector further comprises a collection light path from the substrate to the detector, the light path further comprising a refractive lens and a reflective Schwarzchild lens.

278. The system of claim 228, wherein the detector further comprises a plurality of pixels and a microlens associated with each pixel of the detector wherein the each microlens focuses the scattering feature illumination onto the pixel associated with the microlens.

279. The system of claim 228, wherein the detector further comprises a digital sensor device having a plurality of pixels, each pixel of the digital sensor having an integrated pixel pre-amplifier.

280. The system of claim 279, wherein the digital sensor further comprises a charge injection device.

281. The system of claim 228, wherein the detector further comprises a CMOS sensor.

282. The system of claim 228, wherein the detector further comprises a CCD sensor.

283. The system of claim 228, wherein the detector further comprises a photodiode array sensor.

284. The system of claim 228, wherein the detector further comprises a plurality of sensor elements wherein the sensor elements are adjacent each other to form the detector.

285. The system of claim 228, wherein the detector further comprises a computer that processes digital data corresponding to the scattered illumination from the light scattering feature on the substrate.

286. The system of claim 285, wherein the detector further comprises a dithering process.

287. The system of claim 285, wherein the detector further comprises a random integration process.

288. The system of claim 242, wherein the substrate handler further comprises a substrate holder further comprising one or more edge gripper mechanisms that support the substrate at its edges so that both sides of the substrate are optically inspected.

289. The system of claim 288, wherein the substrate handler further comprises one or more wheels that rotate the substrate holder to position the substrate.

290. The system of claim 288, wherein the substrate handler further comprises one or more ring bearings that permit rotation of the substrate holder to position the substrate.

291. The system of claim 288, wherein the edge gripper mechanism further comprise an edge gripper structure and a support structure wherein the edge gripper structure grips the substrate and the support structure supports the substrate when the edge gripper structure is retracted.

292. The system of claim 291, wherein the support structure has a beveled portion and a flat pad end portion wherein the substrate rests on the beveled portion.

293. The system of claim 292, wherein the edge gripper structure further comprises a tapered region and a beveled indentation end of the tapered region, the beveled indentation end gripping an edge of the substrate without extending beyond the edge of the substrate.

294. The system of claim 288, wherein the edge gripper mechanism further comprises a support structure and an edge gripper structure integrated into the support structure to grip the substrate wherein the edge gripper structure extends out from the support structure when the substrate is being gripped.

295. The system of claim 294, wherein the support structure has a beveled portion and a flat pad end portion wherein the substrate rests on the beveled portion.

296. The system of claim 295, wherein the edge gripper structure further comprises a tapered region and a beveled indentation end of the tapered region, the beveled indentation end gripping an edge of the substrate without extending beyond the edge of the substrate.

297. The system of claim 242, wherein the substrate handler further comprises an edge gripper mechanism and a lifting mechanism wherein the lifting mechanism moves the substrate into a position and retracts away from the substrate.

298. The system of claim 297, wherein the edge gripper mechanism further comprise an edge gripper structure and a support structure wherein the edge gripper structure grips the substrate and the support structure supports the substrate when the edge gripper structure is retracted.

299. The system of claim 298, wherein the support structure has a beveled portion and a flat pad end portion wherein the substrate rests on the beveled portion.

300. The system of claim 299, wherein the edge gripper structure further comprises a tapered region and a beveled indentation end of the tapered region, the beveled indentation end gripping an edge of the substrate without extending beyond the edge of the substrate.

301. The system of claim 297, wherein the edge gripper mechanism further comprises a support structure and an edge gripper structure integrated into the support structure to support the substrate and grip the substrate wherein the edge gripper structure extends out from the support structure when the substrate is being gripped.

302. The system of claim 301, wherein the support structure has a beveled portion and a flat pad end portion wherein the substrate rests on the beveled portion.

303. The system of claim 302, wherein the edge gripper structure further comprises a tapered region and a beveled indentation end of the tapered region, the beveled indentation end gripping an edge of the substrate without extending beyond the edge of the substrate.

304. The system of claim 228 further comprising a computer system that controls the operation of the illumination source and the detector, wherein the computer system further comprises a differential measurement process wherein an initial light scattering feature measurement is subtracted from a subsequent light scattering feature measurement.

305. The system of claim 228 further comprising a sealed enclosure to reduce contaminants within the optical inspection system.

306. The system of claim 205, wherein the sealed enclosure is one or more of vacuum tight, gas tight and light tight.

307. The system of claim 228, wherein the illumination source further comprises an edge illumination source that directs electromagnetic radiation towards a bevel of the substrate so that the detector receives the illumination scattered from a light scattering feature on the bevel of the substrate and detects light scattering features on the bevel of the substrate.

308. The system of claim 265, wherein the wavelength scanning device further comprises a wavelength band pass filter that selectively permits scattering feature illumination for a particular wavelength to impinge of the detector.

309. The system of claim 228, wherein the illumination source further comprises a shutter that blocks the electromagnetic radiation before the electromagnetic radiation illuminates the substrate.

310. The system of claim 228, wherein the illumination source further comprises an intensity sensor that measures the intensity of the electromagnetic radiation emitted by the illumination source.

311. The system of claim 228, wherein the detector further comprises a polarizer that filters the scattering feature light according to the polarization of the scattering feature scattered light.

312. The system of claim 311, wherein the illumination source further comprises a polarizer that is aligned so that the scattering feature scattered light is cross polarized with respect to the polarizer at the detector.

313. The system of claim 228, wherein the illumination source further comprises a homogenizer.

314. The system of claim 228, wherein the illumination source further comprises a device that filters infrared electromagnetic radiation out of the illumination directed towards the substrate.

315. The system of claim 228, wherein the illumination source generates infrared electromagnetic radiation that is directed towards the substrate to measure characteristics of the substrate including one of film thickness, substrate structure, thickness and uniformity.

316. The system of claim 228 further comprising a computer system that controls the illumination source and the detector, the computer system further comprising a module for determining a process problem signature based on the light scattering features detected on the substrate.

317. The system of claim 242, wherein the substrate handler orients a notch of the substrate at approximately 45 degrees with respect to the electromagnetic radiation from the illumination source.

318. The system of claim 228, wherein the illumination source further comprises a dual ring illumination source that illuminates an edge and a bevel of the substrate to detect light scattering features on the edge and bevel of the substrate.

319. The system of claim 228 further comprising a flip mirror that directs the electromagnetic radiation from the illumination source to both surfaces of the substrate at different time periods.

320. The system of claim 319 further comprising a second flip mirror that directs the illumination from the light scattering features on the first side to the detector at a predetermined time and that directs the illumination from the light scattering features on the second side to the detector at a second predetermined time.

321. The system of claim 228 further comprising a beam dump that absorbs the illumination that is not scattered by the light scattering features on the first and second sides of the substrate, the beam dump further comprising one or more light absorbing plates wherein the light is reflected between the one or more light absorbing plates.

322. The system of claim 321, wherein the one or more light absorbing plates further comprises a first light absorbing plate positioned so that the light strikes the first light absorbing plate at an angle of 30 to 60 degrees.

323. The system of claim 246, wherein the disk drive substrate further comprises a disk region that surrounds a central hole and wherein the illumination source generates a washer shaped illumination pattern that illuminates the disk region but not the central hole.

324. The system of claim 323, wherein the illumination source further comprises a first illumination source that generates an illumination pattern that illuminates a first portion of the disk region wherein the disk region is entirely illuminated when the disk drive substrate is rotated.

325. The system of claim 323, wherein the illumination source further comprises a second illumination source that generates an illumination pattern that illuminates a second portion of the disk region different from the first portion, wherein the first and second illumination sources are rotated 90 degrees with respect to each other and the first and second portions of the disk region comprise the entire disk region.

326. The system of claim 323, wherein the illumination source generates electromagnetic radiation that is perpendicular to a texture of the disk drive substrate to measure the texture of the disk drive substrate.

327. An illumination Source, comprising:
an electromagnetic energy radiation source that produces broadband electromagnetic radiation including deep ultraviolet radiation;
a filter that removes the infrared electromagnetic radiation from the generated electromagnetic radiation;
a parabolic light collection reflector that collects the electromagnetic radiation from the electromagnetic energy radiation source and focuses the electromagnetic energy in a particular direction;
a homogenizer; and
an assembly that limits the electromagnetic radiation to a predetermined area wherein the electromagnetic radiation is collimated to less than or equal to +/−2 degrees from the nominal angle of incidence, is spatially uniform in intensity across the substrate with uniformity equal to or greater than 50% and delivers at least 0.25 watts per square inch.

328. The illumination source of claim 327, wherein the filter further comprises a dichroic mirror.

329. The illumination source of claim 327, wherein the generated electromagnetic radiation is spectrally uniform across the beam collimated equal to or greater than 95%.

330. The illumination source of claim 327 further comprising a device that scans through a plurality of wavelengths.

331. The illumination source of claim 330, wherein the wavelength scanning device further comprises a wavelength selectable filter that adjust the wavelength of the electromagnetic radiation.

332. The illumination source of claim 327, wherein the illumination source delivers more than 0.25 watts per square inch to the substrate.

333. The illumination source of claim 327 further comprising a polarizer to generate uniformly polarized electromagnetic radiation.

334. The illumination source of claim 327, wherein the assembly further comprises a shadow casting assembly that limits the electromagnetic radiation to the edges of the substrate.

335. The illumination source of claim 327, wherein the assembly further comprises an image relay assembly that limits the electromagnetic radiation to the edges of the substrate.

336. The illumination source of claim 335, wherein the image relay assembly further comprises an aperture that limits the electromagnetic radiation generated by the illumination source to the edges of the substrate.

337. The illumination source of claim 327, wherein the illumination source generates bright field illumination and dark field illumination.

338. The illumination source of claim 327 further comprising an arc lamp source that produces deep ultraviolet electromagnetic radiation.

339. The illumination source of claim 327 further comprising one of a laser source, a light emitting diode source, a combination of sources such as deuterium and tungsten, and arc lamps with mercury or other gas mixtures.

340. The illumination source of claim 327 further comprising a focused arc source which reduces the optics needed to focus the electromagnetic radiation onto a substrate.

342. The illumination source of claim 327 further comprising a broadband electromagnetic radiation source that generates electromagnetic radiation at a plurality of wavelengths.

343. The illumination source of claim 342, wherein the plurality of wavelengths further comprises 200 nm to 1100 nm.

344. The illumination source of claim 327, wherein the illumination source is modulated which improves the signal to noise ratio of the system.

345. The illumination source of claim 327 further comprising a shutter that blocks the electromagnetic radiation before the electromagnetic radiation illuminates a substrate.

346. The illumination source of claim 327 further comprising an intensity sensor that measures the intensity of the electromagnetic radiation emitted by the illumination source.
